(19) United States
(12) Patent Application Publication
(10) Pub. No.: US 2008/0061969 A1
(43) Pub. Date: Mar. 13, 2008

(54) Invasion Detection Device

(75) Inventors: Takaaki Okude, Nara (JP); Hiroyuki Ogino, Nara (JP); Hirofumi Inui, Osaka (JP); Naofumi Nakatani, Osaka (JP); Makoto Imai, Nara (JP); Ryuta Kondou, Nara (JP); Noriyuki Yoneno, Kyoto (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/572,814

(22) PCT Filed: Aug. 4, 2005
(86) PCT No.: PCT/JP05/14335

§ 371 Date: Jan. 29, 2007

(30) Foreign Application Priority Data
Aug. 4, 2004 (JP) 2004-227920
Jan. 13, 2005 (JP) 2005-005911
Jan. 14, 2005 (JP) 2005-007375
Jan. 17, 2005 (JP) 2005-008780
Jun. 3, 2005 (JP) 2005-163929
Jun. 3, 2005 (JP) 2005-163930
Jun. 3, 2005 (JP) 2005-163931
Jun. 3, 2005 (JP) 2005-163932

(51) Int. Cl. G08B 13/00

(52) U.S. Cl. 340/541

(57) ABSTRACT

To provide an intrusion detection device that can be easily mounted, has less influence of rain or snow, has a weather resistance, and can cope with various shapes.

In the intrusion detection device of the present invention, pressure sensitive means (14) that is a flexible cable-like piezoelectric sensor is stored in a packet (13) in a sealed state, and mounted on a wall-like structure (11) such as a veranda, a balcony or a fence for the domicile. Since the packet is slidable, the pressure sensitive means is sufficiently deformed when the wall-like structure (11) is pressed, so that the sensor can make the detection reliably.

### TECHNICAL FIELD

The present invention relates to an intrusion detection device, or a monitoring device for crime prevention that is installed on a wall-like structure such as a veranda, a balcony, a fence or a wall.

### BACKGROUND ART

The conventional intrusion detection device of this type employed an infrared sensor or a pressure detection sensor (e.g., refer to patent document 1).

FIG. 52 is a constitutional view of the conventional intrusion detection device as described in patent document 1. In FIG. 52, the conventional intrusion detection device has an infrared ray projecting part 5 and the infrared ray receiving parts 6 and 7 on the top of the struts 2 to 4 provided on a fence 1 installed in the veranda or the like.

With the above constitution, when the intruder tries to intrude by getting over the fence 1 and a part of the body intercepts an infrared beam projected from the infrared ray projecting part 5, the intrusion is determined based on a decrease in the light receiving amount of the infrared ray receiving part 6 or 7, thereby conducting a crime prevention operation of raising an alarm from an alarm device or making a notification to the outside.

Also, FIG. 53 is a cross-sectional view of the conventional another intrusion detection device as described in patent document 1. FIG. 53 is a cross-sectional view of the fence 1, in which a pressure detection sensor 10 is disposed at a cutout portion 9 formed along a corner edge of an upper face part 8 of the fence 1 on the side of the house.

With the above constitution, when the intruder tries to intrude by getting over the fence 1 and a part of the body touches the pressure detection sensor 10 to exert a pressure, the intrusion is determined based on the pressure detected by the pressure detection sensor 10, thereby conducting a crime prevention operation of raising an alarm from the alarm device or making a notification to the outside.

Also, in the conventional monitoring device of this type, a sensitive cable is attached inside the fence to detect a vibration or impact applied to the fence when the intruder climbs up the fence or exerts the impact (e.g., refer to patent document 2).

FIG. 54 is a view showing the conventional monitoring device as described in patent document 2. As shown in FIG. 54, an intrusion guard fence with an intrusion sensor mounted employs a vibration detection sensor as the intrusion sensor, and has a sensitive cable disposed inside a pipe line forming member of an intrusion guard 31. Also, one end of the cable 22 is led through a connection pipe 41 buried in the ground to a control box 23 near the fence 31, and the other end is connected to a terminator 24 provided on a strut 32.

Conventionally, a fence as the alarm device comprising a base material attached to a top beam of the fence, a cover member attached on the upper face of the base material and freely movable vertically by pressure, the switch parts installed at regular intervals in the longitudinal direction of the base material, and urging means for urging the switch parts along with the vertical motion of the cover member (e.g., refer to patent document 3).

Patent document 1: JP-A-2002-15380

Patent document 2: JP-A-1-6478

Patent document 3: JP-A-2003-253917

### DISCLOSURE OF THE INVENTION

### Problems that the Invention is to Solve

However, with the above conventional constitution, there was a problem that the fence (wall-like structure) that can be installed is limited, and if a bird rests on the wall-like structure or a cat walks on the wall-like structure, the infrared beam is intercepted to cause a false detection.

Also, if a pressure detection sensor is installed on the surface of the wall-like structure, there was a problem with the weather resistance because the rain or snow directly hits to possibly cause a breakdown due to water, and the sunlight directly strikes thereon.

Also, in the case where the face of the wall-like structure is not flat, there was a problem that the stroke for causing the pressure detection sensor to react stably and reliably can not be kept.

Also, there was a problem with means for causing the pressure detection sensor to react to pressure reliably, and firmly fixing it to the wall-like structure.

Also, there was a problem that even if the intruder puts the hand or foot on a part of the wall-like structure to which the pressure detection sensor does not react and presses it, the pressure detection sensor does not react, and can not cope with the intruder, if any.

Also, there was a problem that the intruder detection level is varied for construction work at the installation site, so that the reliable and stable detection can not be made.

Also, there was a problem that the shape or size of the fence (wall-like structure) that can be installed is limited.

Also, there was a problem that when the bedding is hung on the fence 1, the infrared beam is intercepted, or the weight of the bedding is detected by the pressure detection sensor, causing a false detection.

Also, with the above conventional constitution, the infrared ray projecting part or infrared ray receiving part is exposed, and the intruder easily notices that the intrusion detection device is installed. And if the location of the infrared sensor is known, the intrusion is allowed from the dead zone, resulting in a problem of degrading the intrusion detection performance.

Also, if the monitoring device using the pressure detection sensor is to detect a pressure on a specific part such as a corner edge on the upper face of the fence on the dwelling side, there was a problem that the intruder can easily intrude by avoiding the contact with that part.

Also, to install the monitoring device in a handrail of the fence 1 to avoid the rain or snow, the construction of disassembling and assembling the fence 1 is required, resulting in a problem that the pressure detection sensor can not be easily mounted.

Also, with the above conventional constitution, the intrusion sensor is disposed inside the fence, but the control box is placed outside, whereby it is known from the outside that the device for impeding the intrusion is installed though the intrusion sensor itself is not seen, so that the control box might be destroyed by the intruder. Also, a large power supply unit is required in the installation, which takes a lot of time and trouble. Also, there was a problem that the appearance is impaired if the control box is placed near the fence in the general house.

Also, with the above conventional constitution, since the intrusion sensor is simply disposed inside the fence, the detection sensitivity is not mechanically improved, whereby it is required that the signal of the intrusion sensor is amplified by a control circuit normally. However, if the amplification of the intrusion sensor is increased by the control circuit, the noise other than the sensor signal in intruding on the fence is also amplified, resulting in a program of causing a false detection.

Also, with the above conventional problem, because the switch was a mechanical switch that could be operated by mechanical contact, it was required that the stroke for bringing the upper and lower contact points of the switch into contact was kept more than a certain value to reduce the false detection. Also, to monitor over a wide range, it was required that a plurality of switches were provided at regular intervals. Also, if the moving stroke of a member due to pressure of a cover member is large, the intruder easily notices it, whereby the large stroke was not preferable for detecting the intrusion.

The invention has been achieved to solve the above-mentioned problems with the prior art, and it is an object of the invention to provide an intrusion detection device with a high detection precision for the intruder, which can be installed on various wall-like structures and makes no false detection even when a bird or an animal rests. Also, it is another object of the invention to provide an intrusion detection device that can detect the intruder without depending on the rain, snow and sunlight. Also, it is another object of the invention to provide an intrusion detection device that can keep the stroke for enabling the pressure detection sensor to react stably and reliably even if the face of the wall-structure is not flat. Also, it is another object of the invention to provide an intrusion detection device that enables the pressure detection sensor to react to a pressure reliably and be firmly fixed on the wall-like structure.

Also, the invention has been achieved to solve the above-mentioned problems with the prior art, and it is an object of the invention to provide an intrusion detection device with a high detection precision for the intruder, which can be installed on various wall-like structures and makes no false detection even when a bird or an animal rests. Also, it is another object of the invention to provide an intrusion detection device that can make the detection on whatever part of the wall-like structure the intruder puts the hand or foot to cope with the intruder. Also, it is anther object of the invention to provide an intrusion detection device that can detect the intruder without depending on the rain, snow and sunlight. Also, it is another object of the invention to provide an intrusion detection device that can make the detection even if the intruder detection level is varied.

Also, the invention has been achieved to solve the above-mentioned problems with the prior art, and it is an object of the invention to provide an intrusion detection device with a high detection precision for the intruder, which makes no false detection even when a bird or an animal rests. Also, it is another object of the invention to provide an intrusion detection device that can detect the intruder without depending on the rain, snow and sunlight. Also, it is another object of the invention to provide an intrusion detection device that can be installed on various wall-like structures and make the detection even if the intruder detection level is varied. Also, in the case where the face of the wall-like structure is not flat, there was a further problem that the stroke for causing the pressure detection sensor to react stably and reliably can not be kept.

Also, the invention has been achieved to solve the above-mentioned problems with the prior art, and it is an object of the invention to provide an intrusion detection device which makes no false detection even for the animal or hanging the bedding.

Also, the invention has been achieved to solve the above-mentioned problems with the prior art, and it is an object of the invention to provide an intrusion detection device with a high detection performance in which an installed place of the intrusion detection device is not noticed by the intruder, and the dead zone is not provided to prevent the intrusion.

Also, the invention has been achieved to solve the above-mentioned problems with the prior art, and it is an object of the invention to provide an intrusion detection device which makes no false detection even when the animal rests and can be easily mounted, with less influence of rain or snow and a strong weather resistance.

Also, the invention has been achieved to solve the above-mentioned problems with the prior art, and it is an object of the invention to provide an intrusion detection device which can be easily mounted, and can easily detect in which even if the intrusion sensor is disposed inside the fence or veranda, it is not required that the control box is installed near the fence.

Also, the invention has been achieved to solve the above-mentioned problems with the prior art, and it is an object of the invention to provide a monitoring device which makes no false detection by installing the intrusion sensor inside the handrail of veranda to improve the detection sensitivity mechanically.

### Means for Solving the Problems

In order to accomplish the above objects, the present invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a movable structure mounted on a wall-like structure and slidable on a face of the wall-like structure.

Also, in order to accomplish the above objects, the present invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a movable structure slidable on a face of the wall-like structure, and comprises support means for elastically supporting the pressure sensitive means inside the packet. Thereby, the packet mounted on the wall-like structure is subjected to a pressure from the intruder to cause a deflection, cause a displacement in the pressure sensitive means via the support means and sufficiently output a detection voltage at the time of intrusion detection, whereby the sensitivity is not decreased.

Also, in order to accomplish the above objects, the present invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, characterized in that the packet has a movable structure mounted on a wall-like structure and slidable on a face of the wall-like structure, and the packet has a variable shape.

Thereby, since the packet mounted on the wall-like structure can vary the shape, the intrusion detection device composed of the same members can be mounted on the wall-like structure of various shapes.

Also, in order to accomplish the above objects, the invention provides an intrusion detection device comprising pressure sensitive means disposed on a wall-like structure such as a fence of veranda or a wall for the domicile, and detection means for detecting the intruder who intrudes by getting over the wall-like structure based on an output signal of the pressure sensitive means, wherein the pressure sensitive means is disposed along a lower position a certain length down from an upper end part of the wall-like structure on the domicile side. Since the pressure sensitive means is disposed along a lower position a certain length down from an upper end part of the wall-like structure on the domicile side, no unnecessary pressure is applied upon the motion of the animal or hanging the bedding, whereby there is no false detection.

Also, in order to accomplish the above objects, the invention provides an intrusion detection device comprising a top beam provided on an upper face of a wall-like structure such as a handrail of veranda, a fence or a wall for the domicile, an elastic body carried between the wall-like structure and the top beam, pressure sensitive means supported by the elastic body between the wall-like structure and the top beam, and detection means for detecting the intruder by getting over the top beam and the wall-like structure based on an output signal of the pressure sensitive means.

Thereby, since the pressure sensitive means is provided inside the top beam provided on the wall-like structure, the intruder does not notice that the intrusion detection device is installed, and the intrusion from a dead zone is prevented because there is no dead zone of the device.

Also, in order to accomplish the above objects, the invention provides an intrusion detection device comprising pressure sensitive means, a packet for storing the pressure sensitive means, and detection means for detecting that the pressure sensitive means functions based on an output signal of the pressure sensitive means, wherein the pressure sensitive means has a flexible cable-like piezoelectric sensor.

Also, in order to accomplish the above objects, the invention provides a monitoring device comprising pressure sensitive means for detecting the intruder who intrudes into a dwelling by getting over a handrail of veranda or a fence, detection means for detecting the intruder who intrudes into the dwelling based on a sensor signal detected by the pressure sensitive means, data communication means for sending the information concerning the intrusion detection to a central processing unit, based on a detection signal of the detection means, report means for making a report to the outside, based on the detection signal of the detection means, and a power supply unit for supplying electric power to the pressure sensitive means, the detection means, the data communication means and the report means from a built-in battery. Thereby, if an intrusion detecting terminal unit is disposed inside the handrail of veranda or the fence, it is possible to detect the intruder who intrudes into the dwelling by getting over the handrail of veranda or the fence without installing any installation such as a control unit outside. Also, if support means for elastically supporting the pressure sensitive means is provided, it is easier to detect the intruder who gets over the handrail of veranda or the fence. Further, if the pressure sensitive means is built in the support means, it is easier to install the intrusion detecting terminal unit inside the handrail of veranda or the fence.

Also, in order to accomplish the above objects, the invention provides a monitoring device comprising pressure sensitive means for detecting the intruder who intrudes into a dwelling by getting over a handrail of veranda, elastic support means for elastically supporting the pressure sensitive means, and detection means for detecting the intruder who intrudes into the dwelling based on a sensor signal detected by the pressure sensitive means, wherein the elastic support means provided with a convex portion is disposed inside the handrail of veranda. Therefore, when pressed from the upper part of the handrail of veranda, the elastic support means is more likely to bend, whereby the detection sensitivity is improved as compared with where the pressure sensitive means is simply disposed inside the handrail.

Also, if the pressing means are provided at regular intervals inside the handrail cover, the detection sensitivity is further improved.

Also, if the elastic support means bent like a wave is employed or the pressing means is provided in the elastic support means, the pressure sensitive means supported in the elastic support means is more likely to bend, whereby the detection sensitivity is improved.

### EFFECT OF THE INVENTION

In the intrusion detection device of the invention, since the packet can slide in a direction where the face of the wall-like structure is pressed, the pressure sensitive means is sufficiently deformed by its stroke to output a detection voltage according to the pressure, whereby the intrusion can be detected reliably without impairing the detection sensitivity.

Also, since the intrusion detection device of the invention comprises the support means for elastically supporting the pressure sensitive means inside the packet, a deflection of the pressure sensitive means is sufficiently produced, when the packet provided on the handrail is subjected to the pressure, whereby the intrusion can be detected reliably without impairing the sensitivity of the sensor.

Also, in the intrusion detection device of the invention, since the packet mounted on the wall-like structure is varied in the shape, the intrusion detection device composed of the same members can be mounted on the wall-like structure of various shapes. Hence, the production and workability are excellent.

Also, the intrusion detection device of the invention comprises pressure sensitive means disposed on a wall-like structure such as a fence of veranda or a wall for the domicile, and detection means for detecting the intruder who intrudes by getting over the wall-like structure based on an output signal of the pressure sensitive means, wherein the pressure sensitive means is disposed along a lower position a certain length down from an upper end part of the wall-like structure on the domicile side. Since the pressure sensitive means is disposed along a lower position a certain length down from an upper end part of the wall-like structure on the domicile side, no unnecessary pressure is applied upon the motion of the animal or hanging the bedding. Therefore, the intrusion can be detected reliably without false detection as conventionally occurs, because the intrusion is detected by detecting a pressure when the intruder puts the hand on the upper part of the wall-like structure in getting over the wall-like structure.

Also, since the pressure sensitive means is disposed on the wall-like structure on the domicile side, it is not conspicuous from the outside, and has a great-looking layout, and the intruder does not notice that the pressure sensitive means is installed, whereby the crime prevention effect is enhanced.

Also, since the intrusion detection device of the invention is provided with the pressure sensitive means elastically supported inside the top beam provided on the wall-like structure, it has a great-looking layout and the intruder does not notice that the intrusion detection device is installed, whereby the crime prevention effect is enhanced by preventing the intrusion from a dead zone of the device for the intruder who intrudes by getting over the wall-like structure because there is no dead zone portion, and the intrusion detection performance is improved so that intrusion can be detected reliably.

Also, an intrusion detection device of the invention comprises pressure sensitive means, a packet for storing the pressure sensitive means, and detection means for detecting that the pressure sensitive means functions based on an output signal of the pressure sensitive means, wherein the pressure sensitive means has a flexible cable-like piezoelectric sensor, and the piezoelectric sensor outputs a detection voltage according to an acceleration of deformation due to the piezoelectric effect, whereby the intrusion can be detected by detecting rapidly a deformation due to a pressure when the intruder puts the hand on the upper part of the wall-like structure. Further, since the piezoelectric sensor is like the flexible cable, it can be freely laid along the shape of various wall-like structures. Further, since the intrusion is detected by detecting a pressure when the intruder puts the hand on the upper part of the wall-like structure in getting over the wall-like structure, there is no false detection as conventionally occurs when the animal intercepts the infrared beam, whereby the intrusion can be detected reliably. Also, since the pressure sensitive means is stored within the packet, it has less influence of rain and wind, a strong weather resistance and excellent workability because it can be mounted directly on the surface of the fence. This intrusion detection device can be mounted on the upper face of the wall-like structure or fence of various shapes having the plane, curved surface and concavity and convexity.

Also, a monitoring device of the invention can detect the intruder who intrudes into the dwelling by getting over the handrail of veranda or the fence. Further, without installing the equipment such as a control unit outside, it is possible to raise the alarm to the intruder or send the detection information to the central processing unit to notify the indoor warning terminal, the external telephone, the security company or the police, rapidly reacting to the occurrence of the intrusion. Also, since it is not required that the equipment such as control unit is installed outside, the wiring work is dispensed with, and the appearance is not impaired by the control unit or the like. Therefore, the monitoring device has a great-looking layout, and the enhanced crime prevention effect because the intruder does not notice that the monitoring device is installed.

Also, a monitoring device of the invention can detect the intruder who intrudes into the dwelling by getting over the handrail of veranda or the fence, and is scarcely affected by the electrical noise by improving the detection sensitivity mechanically, whereby the intrusion can be detected reliably without false detection.

Also, since the pressure sensitive means is disposed on the handrail and has a cover, it is not conspicuous from the outside, and is not degraded in the appearance. Since the intruder does not notice that the pressure sensitive means is installed, the crime prevention effect is enhanced.

Also, since an intrusion detection device of the invention uses the flexible cable as the sensor, it can fully detect the stroke to an extent not recognizable by the person even if it is moved under pressure. Accordingly, the crime prevention effect is enhanced because the intruder does not notice it. Also, to detect a wide range, the sensor may be a long cable of required length laid within the range, in which it is not required that a plurality of switches are prepared. Also, the turning on or off of a mechanical switch is not detected but the weight can be measured in analog waveform, whereby various states can be detected and discriminated by analyzing the waveform, so that the precision of discriminating the intruder is improved.

### BRIEF DESCRIPTION OF THE DRAWINGS

FIG. 1A is a constitutional view of a wall-like structure having installed an intrusion detection device according to an embodiment of the invention and FIG. 1B is a cross-sectional view of the wall-like structure, taken along the A-A line in FIG. 1A.

FIG. 2A is a constitutional view of a piezoelectric sensor 14 and a control unit 15 according to the embodiment of the invention and FIG. 2B is a cross sectional view of the piezoelectric sensor, taken along the line B-B in FIG. 2A.

FIG. 3 is a block diagram of the intrusion detection device according to the embodiment of the invention.

FIG. 4 is a cross-sectional view of a packet of the intrusion detection device according to an embodiment 1 of the invention.

FIG. 5A is a longitudinal cross-sectional view of the packet of the intrusion detection device according to the embodiment 1 of the invention.

FIG. 5B is a view for explaining a state where the packet of FIG. 5A is subjected to a pressure.

FIG. 5C is a cross-sectional view of FIG. 5B.

FIG. 6 is a cross-sectional view of a packet of an intrusion detection device according to an embodiment 2 of the invention.

FIG. 7 is a cross-sectional view of a packet of an intrusion detection device according to an embodiment 3 of the invention.

FIG. 8 is a cross-sectional view of a packet of an intrusion detection device according to an embodiment 4 of the invention.

FIG. 9 is a cross-sectional view of a packet of an intrusion detection device according to an embodiment 5 of the invention.

FIG. 10 is a cross-sectional view of a packet of an intrusion detection device according to an embodiment 6 of the invention.

FIG. 11A is a view showing a state where the intruder puts a hand 21 on the upper part of a wall-like structure 11 to hold up the body when the intruder intrudes by getting over the wall-like structure 11 according to the embodiment of the invention.

FIG. 11B is a cross-sectional view of FIG. 11A.

FIG. 12 is a characteristic chart showing an output signal V of a filter part 154 and an output signal J of a comparator part 155, varying over time, when the intruder intrudes, in the intrusion detection device according to the embodiment 1 of the invention.

FIG. 13A is a constitutional view of a wall-like structure having installed an intrusion detection device according to an embodiment 7 of the invention and FIG. 13B is a cross-sectional view of the wall-like structure, taken along the A-A line in FIG. 13A.

FIG. 14A is a constitutional view of a piezoelectric sensor 1014 and a control unit 1015 according to the embodiment 7 of the invention, FIG. 14B is a cross-sectional view of the piezoelectric sensor, taken along the line B-B in FIG. 14A, and FIG. 14C is a cross-sectional view of support means with a hollow part according to this embodiment.

FIG. 15 is a block diagram of the intrusion detection device according to the embodiment 7 of the invention.

FIG. 16A is a view showing a state where the intruder puts a hand 1017 on the upper part of a wall-like structure 1011 to hold up the body when the intruder intrudes by getting over the wall-like structure 1011 in the intrusion detection device according to the embodiment 7 of the invention, and FIG. 16B is a view showing a state where a bedding 1018 is hung over the wall-like structure 1011 in hanging the bedding.

FIG. 17 is a characteristic chart showing an output signal V of a filter part 1154 and an output signal J of a comparator part 1155, varying over time, when the intruder intrudes, in the intrusion detection device according to the embodiment 7 of the invention.

FIG. 18A is a cross-sectional view of an intrusion detection device according to an embodiment 8 of the invention, FIG. 18B is a view showing a state where the intruder puts a hand 1017 on the upper part of the wall-like structure 1011 to hold up the body when the intruder intrudes by getting over the wall-like structure 1011, and FIG. 18C is a cross-sectional view of the wall-like structure 1011 of inverse L-character type mounting the intrusion detection device according to the embodiment 7 of the invention.

FIG. 19A is a cross-sectional view of an intrusion detection device according to an embodiment 9 of the invention, and FIG. 19B is a view showing a state where the intruder puts a hand 1017 on the upper part of the wall-like structure 1011 to hold up the body when the intruder intrudes by getting over the wall-like structure 1011.

FIG. 20 is a perspective view of an intrusion detection device according to an embodiment 10 of the invention.

FIG. 21 is a cross-sectional constitutional view of the intrusion detection device according to the embodiment 10 of the invention.

FIG. 22A is a constitutional view of a piezoelectric sensor for the intrusion detection device according to the embodiment 10 of the invention, and FIG. 22B is a cross-sectional view of the piezoelectric sensor, taken along the line B-B in FIG. 22A.

FIG. 23 is a block diagram of the intrusion detection device according to the embodiment 10 of the invention.

FIG. 24 is a characteristic chart showing an output signal of a filter part and an output signal of a comparator part, varying over time, when the intruder intrudes, in the intrusion detection device according to the embodiment 10 of the invention.

FIG. 25 is a cross-sectional constitutional view of an intrusion detection device according to an embodiment 11 of the invention.

FIG. 26 is a block diagram of the intrusion detection device according to the embodiment 11 of the invention.

FIG. 27 is a cross-sectional constitutional view of an intrusion detection device according to an embodiment 12 of the invention.

FIG. 28A is a constitutional view of a wall-like structure having installed an intrusion detection device according to an embodiment 13 of the invention, and FIG. 28B is a cross-sectional view of the wall-like structure, taken along the line A-A in FIG. 28A.

FIG. 29A is a constitutional view of a piezoelectric sensor 3014 and a control unit 3015 according to the embodiment 13 of the invention and FIG. 29B is a cross-sectional view of the piezoelectric sensor, taken along the line B-B in FIG. 29A.

FIG. 30 is a block diagram of the intrusion detection device according to the embodiment 13 of the invention.

FIG. 31A is an image view of a packet of the intrusion detection device according to the embodiment 13 of the invention, FIG. 31B is a cross-sectional view of FIG. 31A, and FIG. 31C is a cross-sectional view of FIG. 31A in another example.

FIG. 32A is a view showing a state where the intruder puts a hand 3017 on the upper part of a wall-like structure 3011 to hold up the body when the intruder intrudes by getting over the wall-like structure 3011 according to the embodiment 13 of the invention, and FIG. 32B is a cross-sectional view of FIG. 32A.

FIG. 33 is a characteristic chart showing an output signal V of a filter part 3154 and an output signal J of a comparator part 3155, varying over time, when the intruder intrudes, in the intrusion detection device according to the embodiment 13 of the invention.

FIG. 34A is a constitutional view of a wall-like structure having installed an intrusion detection device according to an embodiment 14 of the invention, and FIG. 34B is a cross-sectional view of FIG. 34A.

FIG. 35 is a system block diagram of a system according to an embodiment 15 of the invention.

FIG. 36 is an internal block diagram of a central processing unit according to the embodiment 15 of the invention.

FIG. 37A is an internal block diagram of an intrusion detecting terminal unit according to the embodiment 15 of the invention, and FIG. 37B is a constitutional view of pressure sensitive means (piezoelectric sensor).

FIG. 38 is a cross-sectional view of the piezoelectric sensor, taken along the line A-A in FIG. 37A.

FIG. 39A is a constitutional view of the wall-like structure having installed the intrusion detecting terminal unit, and FIG. 39B is a cross-sectional view of FIG. 39A, taken along the line B-B.

FIG. 40 is a characteristic chart showing an output signal of a filter part and an output signal of a comparator part, varying over time, when the intruder is detected in the intrusion detecting terminal unit according to the embodiment 15 of the invention.

FIG. 41A is a constitutional view of a wall-like structure having installed an intrusion detecting terminal unit according to an embodiment 16 of the invention, and FIG. 41B is a cross-sectional view of the wall-like structure, taken along the line C-C in FIG. 41A.

FIG. 42A is a constitutional view of a veranda (wall-like structure) having installed a monitoring device according to an embodiment 17 of the invention, and FIG. 42B is a cross-sectional view of the wall-like structure, taken along the line A-A in FIG. 42A.

FIG. 43 is an internal block diagram of detection means according to the embodiment 17 of the invention.

FIG. 44A is a cross-sectional view of pressure sensitive means (piezoelectric sensor), taken along the line A-A in FIG. 43 and FIG. 44B is a constitutional view of the pressure sensitive means (piezoelectric sensor).

FIG. 45A is a cross-sectional view of elastic support means in a flexed state, and FIG. 45B is a longitudinal cross-sectional view of a handrail.

FIG. 46 is a characteristic chart showing an output signal of a filter part and an output signal of a comparator part, varying over time, when the person is detected in the monitoring device according to the embodiment 17 of the invention.

FIG. 47A is a constitutional view of a veranda (wall-like structure) having installed a monitoring device according to an embodiment 18 of the invention, and FIG. 47B is a cross-sectional view of FIG. 47A, taken along the line A-A.

FIG. 48A is a constitutional view of a veranda (wall-like structure) having installed a monitoring device according to an embodiment 19 of the invention, and FIG. 48B is a cross-sectional view of FIG. 48A, taken along the line A-A.

FIG. 49A is a constitutional view of a veranda (wall-like structure) having installed a monitoring device according to an embodiment 20 of the invention, and FIG. 49B is a cross-sectional view of FIG. 49A, taken along the line A-A.

FIG. 50A is a constitutional view of a veranda (wall-like structure) having installed a monitoring device according to an embodiment 21 of the invention, and FIG. 50B is a cross-sectional view of FIG. 50A, taken along the line A-A.

FIG. 51A is a constitutional view where pressure sensitive means is installed with bend according to an embodiment 22 of the invention and FIG. 51B is a constitutional view where elastic support means is installed with bend according to the embodiment 22 of the invention.

FIG. 52 is a constitutional view of the conventional intrusion detection device.

FIG. 53 is a constitutional view of another conventional intrusion detection device.

FIG. 54 is a constitutional view of the conventional monitoring device.

### DESCRIPTION OF REFERENCE NUMERALS AND SIGNS

11 fence (wall-like structure)
12 handrail
13, 23, 33, 43, 53, 63 packets
14 piezoelectric sensor (pressure sensitive means)
15 control unit
16, 26, 36, 46, 56, 66 support means
16A, 26A, 36A, 46A, 56A, 66A non-linear flexure part
16B, 26B, 36B, 46B, 56B, 66B pressing portion
18, 19, 20a, 20b fixing means
151 detection means
152 threatening means
153 communication means
156 detection level adjustment means
1011 fence (wall-like structure)
1012 upper end part
1013 groove portion
1014 piezoelectric sensor (pressure sensitive means)
1016 support means
1019 step part
1021 non-linear flexure part
1151 detection means
1152 alarm generation means
1153 communication means
2011 wall-like structure
2013 top beam
2015 elastic body
2016 fixing part
2017 piezoelectric sensor (pressure sensitive means)
2181 detection means
2182 alarm generation means
2183 communication means
2019 elastic body
2020 top beam
2211 lock strengthening means
2022 non-linear flexure part
2023 elastic body
3011, 3031 fences (wall-like structures)
3013 packet (laminate film)
3014 piezoelectric sensor (pressure sensitive means)
3015 control unit
3016 support means
3016A non-linear flexure part
3018 plane part
3019, 3021 fixing means
3020 plane part
3033 handrail
3151 detection means
3152 threatening means
3153 communication means
3156 detection level adjustment means
4071 pressure sensitive means
4077 detection means
4082 data communication means
4083 report means
4084 power supply part
4085 terminal control part
4086 sensitivity switching means
4087 piezoelectric sensor
4089 support means
4090 buffer part (non-linear flexure part)
4101 wall-like structure
5111 center electrode
5112 ground electrode
5113 center side resistor
5114 circuit side resistor
5115 signal deriving resistor
5116 detection part
5117 amplifier
5118 filter part
5119 comparator part
5120 abnormality determination part
5121 report part
5122 power supply part
5123 control part
5124 shield part
5125 piezoelectric layer
5126 covering layer
5127 piezoelectric sensor

### BEST MODE FOR CARRYING OUT THE INVENTION

A first invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a movable structure mounted on a wall-like structure and slidable on a face of the wall-like structure. Thereby, since the packet can slide on the face of the wall-like structure in a pressed direction, the pressure sensitive means can be sufficiently deformed by its stroke to output a detection voltage according to a pressure, whereby the intrusion can be detected reliably without impairing the detection sensitivity. Further, the piezoelectric sensor is like the flexible cable and can be freely laid along the shape of various wall-like structures, and the packet can be attached securely on the surface of the wall-like structure directly or using fixing means, whereby the workability is excellent. That is, the piezoelectric sensor can be mounted on the wall-like structure of various shapes including the plane, curved surface and concavity and convexity, and various sizes. Since it is not required that the piezoelectric sensor is incorporated into the wall-like structure at the time of factory shipment, it is easy to make the piezoelectric sensor suitable for the construction site. Also, since the intrusion is detected by detecting a pressure when the intruder puts the hand or foot on the packet mounted on the wall-like structure in getting over the wall-like structure, there is no false detection caused by the animal intercepting the infrared beam as conventionally occurs, whereby the intrusion can be detected reliably. Also, since the piezoelectric sensor outputs a voltage signal according to an acceleration of deformation due to the piezoelectric effect, a pressure when the intruder puts the hand or foot on the packet attached to the wall-like structure is propagated via support means to the piezoelectric sensor to cause a deformation of the piezoelectric sensor, and the intruder can be detected by detecting the deformation rapidly, whereby the detection precision is high. Also, since the pressure sensitive means is stored within the packet, it has less influence of the rain and wind and a strong weather resistance.

A second invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet comprises a mount part mounted on a wall-like structure and a movable part slidable on a face of the mount part. Thereby, since the piezoelectric sensor outputs a voltage signal according to an acceleration of deformation due to the piezoelectric effect, when the intruder puts the hand on the upper part of the wall-like structure in getting over the wall-like structure, the piezoelectric sensor detects a pressure to output a voltage signal to detect the intrusion rapidly, whereby there is no false detection caused by the animal intercepting the infrared beam as conventionally occurs, and the intrusion can be detected reliably. Also, since the pressure sensitive means is a flexible cable-like piezoelectric sensor, the piezoelectric sensor can be freely laid along the shape of various wall-like structures. Also, since the piezoelectric sensor is stored within the packet, it has less influence of rain and wind and is superior in the weather resistance. Even with a structure in which the stroke of the packet for making the detection with the pressure sensitive means is smoothly performed because the face of the wall-like structure is not flat, the mount part is mounted on the wall-like structure and the movable part is made slidable along the face of the mount part, whereby a slidable part of the mount part can keep the stoke of the movable part to allow the pressure sensitive means to make the detection stably and reliably without influence of the wall-like structure on which the packet is mounted.

A third invention provides the intrusion detection device according to the first or second invention, characterized in that the packet has fixing means for fixing on the wall-like structure, in which the fixing means is fitted with a face of the wall-like structure. Thereby, the packet can be firmly fixed on the wall-like structure, whereby the intrusion detection device can make the detection reliably with the pressure sensitive means.

A fourth invention provides the intrusion detection device according to the second invention, characterized in that the movable part of the packet is slidably fitted with the mount part. Thereby, the mount part of the packet can be firmly fixed on the wall-like structure, whereby the intrusion detection device can make the detection reliably with the pressure sensitive means.

A fifth invention provides the intrusion detection device according to any one of the first to fourth inventions, characterized in that the packet has fixing means for fixing on the wall-like structure, in which the fixing means fastens the packet. Thereby, the packet can be firmly fixed on the wall-like structure, whereby the intrusion detection device can make the detection reliably with the pressure sensitive means.

A sixth invention provides the intrusion detection device according to any one of the second to fifth inventions, characterized in that the mount part of the packet is bonded on the wall-like structure. Thereby, the packet can be firmly fixed on the wall-like structure, whereby the intrusion detection device can make the detection reliably with the pressure sensitive means.

A seventh invention provides the intrusion detection device according to any one of the second to fifth inventions, characterized in that the mount part of the packet has fixing means for fixing on the wall-like structure, in which the fixing means has a screwing structure. Thereby, the packet can be firmly fixed on the wall-like structure, whereby the intrusion detection device can make the detection reliably with the pressure sensitive means.

An eighth invention provides the intrusion detection device according to any one of the first to seventh inventions, characterized in that the packet is bent inwards on the end face. Thereby, the packet can be firmly fixed on the wall-like structure, and the intrusion detection device is not separated from the wall-like structure.

A ninth invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a movable structure mounted on a wall-like structure and slidable on a face of the wall-like structure, and comprises support means for elastically supporting the pressure sensitive means inside the packet. Thereby, the piezoelectric sensor is like the flexible cable and can be freely laid along the shape of various wall-like structures, and the packet can be attached securely on the surface of the wall-like structure directly or using fixing means, whereby the workability is excellent. That is, the piezoelectric sensor can be mounted on the wall-like structure of various shapes having the plane, curved surface and concavity and convexity, and various sizes. Also, since it is not required to incorporate the piezoelectric sensor into the wall-like structure at the time of factory shipment, it is easy to make the piezoelectric sensor suitable for the construction site. Also, when the intruder puts the hand or foot on the packet mounted on the wall-like structure to get over the wall-like structure, there is a displacement in the piezoelectric sensor due to a pressure exerted by the packet sliding on the face of the wall-like structure, and the pressure sensitive means detects this displacement to detect the intrusion, whereby there is no false detection caused by the animal intercepting the infrared beam as conventionally occurs, and the intrusion can be detected reliably. Also, since the piezoelectric sensor outputs a voltage signal according to an acceleration of deformation due to the piezoelectric effect, a pressure when the intruder puts the hand or foot on the packet attached to the wall-like structure is propagated via the support means to the piezoelectric sensor to cause a deformation of the piezoelectric sensor, and the intruder can be detected by detecting the deformation rapidly at high detection precision. Therefore, at least the overall upper face of the wall-like structure is a detectable range of the pressure sensitive means, so that an undetectable range where the pressure detection sensor is insensitive even if the intruder touches the wall-like structure by foot or hand to apply a pressure on the wall-like structure can be minimized to exclude detection leakage. Also, since the pressure sensitive means is stored within the support means, it has less influence of rain and wind and a strong weather resistance.

A tenth invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a mount part mounted on a wall-like structure and a movable part slidable on a face of the mount part, and comprises support means for elastically supporting the pressure sensitive means within the packet. Thereby, since the support means elastically supports the pressure sensitive means, the pressure sensitive means is likely to deform due to a pressure when the intruder puts the hand or foot on the upper part of the wall-like structure in getting over the wall-like structure, making it possible to output rapidly an output signal according to a deformation from the pressure sensitive means, whereby the detection precision is improved and the possibility of false detection is reduced. Also, because of having the mount part and the movable part, the packet can slide smoothly, whereby the detection precision is improved. Also, the intrusion detection device can be installed on various wall-like structures, employing the flexible piezoelectric sensor. Also, since the piezoelectric sensor is stored within the support means, it has less influence of rain and wind and is excellent in the weather resistance.

An eleventh invention provides the intrusion detection device according to the ninth or tenth invention, characterized by further comprising a non-linear flexure part inside the support means, in which the non-linear flexure part has a material or constitution more deformable than the support means. Thereby, since the non-linear flexure part is flexed earlier than the support means at a predetermined pressure or more, the piezoelectric sensor supported by the support means has an improved detection precision and less possibility of false detection, because the non-linear flexure part is deformed suddenly due to a pressing force caused by a getting over action of the intruder.

A twelfth invention provides the intrusion detection device according to any one of the ninth to eleventh inventions, characterized by further comprising a pressing portion at a position where a force is applied to the pressure sensitive means. Thereby, since the pressing portion deforms the support means and the piezoelectric sensor inside the support means in a direction where the pressing force is applied, the detection precision is improved and the possibility of false detection is reduced.

A thirteenth invention provides the intrusion detection device according to the twelfth invention, characterized in that the pressing portion uses a material less deformable than the support means. Thereby, since the pressing portion can sufficiently deform the support means and the piezoelectric sensor inside the support means in a direction where the pressing force is applied, the detection precision is improved and the possibility of false detection is reduced.

A fourteenth invention provides the intrusion detection device according to the twelfth or thirteenth invention, characterized in that the pressing portions are provided at any intervals. Thereby, since the pressure sensitive means near a portion pressed by the intruder is flexed more severely than in the surrounding, the detection of the intruder is facilitated.

A fifteenth invention provides the intrusion detection device according to any one of the twelfth or fourteenth inventions, characterized in that the pressing portion is contact with the support means via an R plane or at an acute angle or obtuse angle. Thereby, since a pressure exerted by the intruder is propagated to the pressure sensitive means sharply, the detection of the intruder is facilitated.

A sixteenth invention provides the intrusion detection device according to any one of the ninth to sixteenth inventions, characterized in that the detection means comprises detection level adjustment means for adjusting a detection level at which the pressure sensitive means functions. Thereby, the detection sensitivity can be adjusted on site in various mounting forms of the wall-like structure, whereby the installation ability is better and an adaptable range of product is broadened.

A seventeenth invention provides the intrusion detection device according to any one of the ninth to sixteenth inventions, characterized by further comprising threatening means for raising an alarm based on an output signal of the detection means. Thereby, the intruder can be threatened by the alarm and discouraged from making the intrusion.

An eighteenth invention provides the intrusion detection device according to any one of the ninth to seventeenth inventions, characterized by further comprising communication means for communicating an output signal of the detection means to an external apparatus. Thereby, it is notified an indoor warning terminal, an external telephone, a security company or the police that the intrusion of the intruder occurs, whereby it is possible to rapidly react to the occurrence of intrusion.

A nineteenth invention provides an intrusion detection device, comprising pressure sensitive means having a flexible cable-like piezoelectric sensor, a packet for storing the pressure sensitive means, and detection means for detecting that the pressure sensitive means functions based on an output signal of the pressure sensitive means, wherein the packet has a movable structure mounted on a wall-like structure and slidable on a face of the wall-like structure, and the packet has a variable shape. Thereby, since the intrusion is detected by detecting a pressure when the intruder puts the hand or foot on the packet mounted on the wall-like structure to get over the wall-like structure, there is no false detection caused by the animal intercepting the infrared beam as conventionally occurs, whereby the intrusion can be detected reliably. Also, since the piezoelectric sensor outputs a voltage signal according to an acceleration of deformation due to the piezoelectric effect, a pressure when the intruder puts the hand or foot on the packet attached to the wall-like structure is propagated via the support means to the piezoelectric sensor to cause a deformation of the piezoelectric sensor, and the intruder can be detected by detecting the deformation rapidly, whereby the detection precision is high. Also, since the movable part is slidable on the face of the mount part mounted on the wall-like structure, the stroke for enabling the pressure detection sensor to react stably and reliably can be kept even if the face of the wall-like structure is not flat. Also, the piezoelectric sensor is like the flexible cable and can be freely laid along the shape of various wall-like structures to cope with the face of various shapes having the plane, curved surface and concavity and convexity. Also, since the packet is variable in the shape, the intrusion detection device can be mounted on the wall-like structure of various shapes and sizes. Also, since the pressure sensitive means is stored within the support means, it has less influence of rain and wind and a strong weather resistance.

A twentieth invention provides an intrusion detection device comprising pressure sensitive means having a flexible cable-like piezoelectric sensor, a packet for storing the pressure sensitive means, and detection means for detecting that the pressure sensitive means functions based on an output signal of the pressure sensitive means, wherein the packet comprises a mount part mounted on a wall-like structure and a movable part slidable on a face of the mount part, and the packet has a variable shape. Thereby, since the piezoelectric sensor outputs a voltage signal according to an acceleration of deformation due to the piezoelectric effect, when the intruder puts the hand on the upper part of the wall-like structure in getting over the wall-like structure, the piezoelectric sensor detects this pressure to output a voltage signal and detect the intrusion rapidly, whereby there is no false detection caused by the animal intercepting the infrared beam as conventionally occurs, and the intrusion can be detected reliably. Also, the pressure sensitive means is like the flexible cable and can be freely laid along the shape of various wall-like structures. Since the piezoelectric sensor is stored within the support means, it has less influence of rain and wind and is excellent in the weather resistance. Even with a structure in which the stroke of the packet to allow the pressure sensitive means to make the detection is not smoothly performed because the wall-like structure is not flat, the mount part is mounted on the wall-like structure, and the movable part is slid along the mount part, so that the stroke of the movable part to allow the pressure sensitive means to make the detection stably and reliably can be kept. Also, since the shape of the packet can be varied, the wall-like structure of various shapes and sizes can be treated.

A twenty first invention provides the intrusion detection device according to the nineteenth or twentieth invention, characterized in that the packet has an expansion part and can vary the shape. Thereby, the shape of the packet is varied according to a surface situation for disposition on the wall-like structure by the expansion part, and can be mounted in a suitable form, whereby the intrusion detection of the pressure sensitive means can be performed reliably.

A twenty second invention provides the intrusion detection device according to the twenty first invention, characterized in that the expansion part has a bellows part. Thereby, the intrusion detection device can be easily mounted on the wall-like structure of various shapes and sizes.

A twenty third invention provides the intrusion detection device according to any one of the nineteenth to twenty second inventions, characterized in that the detection means comprises detection level adjustment means for adjusting a detection level at which the pressure sensitive means functions. Thereby, even if the level of detecting the intruder is varied by changing the shape of the packet to be mounted on the wall-like structure of various shapes and sizes, the detection sensitivity can be adjusted on site, whereby the installation ability is better, and an adaptable range of product is broadened.

A twenty fourth invention provides an intrusion detection device comprises pressure sensitive means disposed on a wall-like structure such as a fence of veranda or a wall for the domicile, and detection means for detecting the intruder who intrudes by getting over the wall-like structure based on an output signal of the pressure sensitive means, in which the pressure sensitive means is disposed along a lower position a certain length down from an upper end part of the wall-like structure on the side of the house. Thereby, no unnecessary pressure is applied on the pressure sensitive means upon the motion of the animal or hanging the bedding, because the pressure sensitive means is disposed along a lower position a certain length down from an upper end part of the wall-like structure on the side of the house, whereby there is no false detection as conventionally occurs. Also, since the pressure sensitive means is disposed on the wall-like structure on the side of the house, it is not conspicuous from the outside and has a great-looking layout, and the intruder does not notice that the pressure sensitive means is installed, whereby the crime prevention effect is enhanced.

A twenty fifth invention provides the intrusion detection device according to the twenty fourth invention, wherein a groove portion is provided at a lower position a certain length down from the upper end part of the wall-like structure on the side of the house, in which the pressure sensitive means is disposed in the groove portion. Since the groove portion is provided in disposing the pressure sensitive means on the wall-like structure, the pressure sensitive means is easily installed in the work.

A twenty sixth invention provides the intrusion detection device according to the twenty fourth invention, wherein a step portion is provided at a lower position a certain length down from the upper end part of the wall-like structure on the side of the house, in which the pressure sensitive means is disposed in the step portion. When the intruder intrudes by getting over the wall-like structure, the intruder holds up the body by putting the hand on the upper part of the wall-like structure, but if the step portion is provided, the intruder necessarily tries to put the hand on the step portion and apply a force, so that a pressure is likely to be applied on the pressure sensitive means disposed in the step portion, whereby the intrusion detection precision is improved.

A twenty seventh invention provides the intrusion detection device according to any one of the twenty fourth to twenty sixth inventions, further comprising support means for elastically supporting the pressure sensitive means. Since the support means elastically supports the pressure sensitive means, the pressure sensitive means is more likely to deform due to a pressure when the intruder puts the hand on the upper part of the wall-like structure in getting over the wall-like structure, so that an output signal according to a deformation can be quickly outputted from the pressure sensitive means, whereby the detection sensitivity is improved.

A twenty eighth invention provides the intrusion detection device according to the twenty seventh invention, wherein the pressure sensitive means comprises a non-linear flexure part having an elastic characteristic of being non-linearly flexed if a load of a predetermined weight or more is applied. Even if a pressure is applied on the pressure sensitive means upon the motion of the animal or hanging the bedding, the non-linear flexure part is not flexed unless a load of a predetermined weight or more is applied thereon, so that the pressure sensitive means is not deformed, whereby there is no false detection.

A twenty ninth invention provides the intrusion detection device according to any one of the twenty fourth to twenty eighth inventions, wherein the pressure sensitive means comprises a flexible cable-like piezoelectric sensor. Since the piezoelectric sensor outputs a voltage signal according to an acceleration of deformation due to the piezoelectric effect, the intrusion can be detected by detecting rapidly a deformation caused by a pressure when the intruder puts the hand on the upper part of the wall-like structure. Further, the piezoelectric sensor is like the flexible cable and can be freely laid along the shape of various wall-like structures.

A thirtieth invention provides the intrusion detection device according to any one of the twenty fourth to twenty ninth inventions, further comprising alarm generation means for generating an alarm based on an output signal of the detection means. Thereby, the intruder can be threatened by generating the alarm, and discouraged from making the intrusion.

A thirty first invention provides the intrusion detection device according to any one of the twenty fourth to thirtieth inventions, further comprising communication means for communicating an output signal of the detection means to an external apparatus. Thereby, it is notified an indoor warning terminal, an external telephone, a security company or the police that the intrusion of the intruder occurs, whereby it is possible to rapidly react to the occurrence of intrusion.

A thirty first invention provides an intrusion detection device comprising a top beam provided on the upper face of a wall-like structure such as a handrail of veranda, a fence or a wall for the domicile, an elastic body carried between the wall-like structure and the top beam, pressure sensitive means supported by the elastic body between the wall-like structure and the top beam, and detection means for detecting the intruder based on an output signal of the pressure sensitive means. Thereby, since the pressure sensitive means is provided inside the top beam provided on the wall-like structure, the intruder does not notice that the intrusion detection device is installed, whereby the crime prevention effect is enhanced by preventing the intrusion from the dead zone for the device, and the intrusion detection performance is improved.

A thirty second invention provides the intrusion detection device according to the thirty first invention, wherein the top beam is vertically movable on the upper face of the wall-like structure. Thereby, when the intruder intrudes by getting over the wall-like structure, the intruder holds up the body by putting the hand on the top beam on the upper part of the wall-like structure, but because the pressure sensitive means elastically supported is provided inside the top beam that is vertically movable, if the intruder tries to intrude by applying a load on the top beam, the top beam is not only flexed but also vertically moved, increasing a deformation applied on the pressure sensitive means, whereby the detection sensitivity is increased, and the intrusion detection performance is improved. In order that the getting over action of the person who intrudes is only detected, but the contact or life conduct of the small animal or the resident is not detected, the top beam is only vertically movable, whereby the false detection is prevented.

A thirty third invention provides the intrusion detection device according to the thirty first or thirty second invention, wherein the pressure sensitive means is disposed on a fixing part provided in the elastic body. Thereby, in the work for disposing the pressure sensitive means on the wall-like structure, the pressure sensitive means is easily installed. Since the pressure sensitive means can be fixed without the adhesive or fixing member, the deformation can be detected highly sensitively without impairing the flexibility of the pressure sensitive means, whereby the detection sensitivity is increased and the intrusion detection performance is improved.

A thirty fourth invention provides the intrusion detection device according to any one of the thirty first to thirty three inventions, further comprising a non-linear flexure part having an elastic characteristic of being flexed non-linearly if a load of a predetermined weight or more is applied. Thereby, even if a pressure is applied on the pressure sensitive means upon the motion of the animal or hanging the bedding, the non-linear flexure part is not flexed unless a load of a predetermined weight or more is applied thereon, so that the pressure sensitive means is not also deformed. Therefore, the contact of the small animal or the life conduct such as hanging the bedding is not detected, but the intrusion by the getting over action is only detected, whereby the intrusion detection performance is improved by preventing false detection.

A thirty fifth invention provides the intrusion detection device according to any one of the thirty first to thirty fourth inventions, wherein the pressure sensitive means comprises a flexible cable-like piezoelectric sensor. Since the piezoelectric sensor outputs a voltage signal according to an acceleration of deformation due to the piezoelectric effect, the intrusion can be detected by detecting rapidly a deformation caused by a pressure when the intruder puts the hand on the upper part of the wall-like structure. Further, the piezoelectric sensor is like the flexible cable and can be freely laid along the shape of various wall-like structures.

A thirty sixth invention provides the intrusion detection device according to any one of the thirty first to thirty fifth inventions, further comprising alarm generation means for generating the alarm based on an output signal of detection means. Thereby, the resident can be informed promptly by generating the alarm. Also, if the alarm has the threatening effect by generating an alarm sound or light, the intruder can be threatened at the same time with the alarm, and discouraged from making the intrusion.

A thirty seventh invention provides the intrusion detection device according to any one of the thirty first to thirty sixth inventions, further comprising communication means for communicating an output signal of the detection means to an external apparatus. Thereby, it is notified an indoor warning terminal, an external telephone, a security company or the police that the intrusion of the intruder occurs, whereby it is possible to rapidly react to the occurrence of intrusion.

A thirty eighth invention provides the intrusion detection device according to any one of the thirty first to thirty seventh inventions, further locking reinforcement means for reinforcing the locking of the domicile based on an output signal of the detection means. Thereby, if the intrusion of getting over the wall-like structure is detected, the further intrusion into the domicile can be prevented by reinforcing the locking of the domicile.

A thirty ninth invention provides an intrusion detection device comprising pressure sensitive means, a packet for storing the pressure sensitive means, and detection means for detecting that the pressure sensitive means functions based on an output signal of the pressure sensitive means, wherein the pressure sensitive means comprises a flexible cable-like piezoelectric sensor. Since the piezoelectric sensor outputs a voltage signal according to an acceleration of deformation due to the piezoelectric effect, the piezoelectric sensor is deformed by a pressure when the intruder puts the hand on the upper part of the wall-like structure, and outputs a signal, so that the intrusion can be detected rapidly. Further, the piezoelectric sensor is like the flexible cable and can be freely laid along the shape of various wall-like structures. And since the intrusion is detected by detecting a pressure when the intruder puts the hand on the upper part of the wall-like structure in getting over the wall-like structure, there is no false detection caused by the animal intercepting the infrared beam as conventionally occurs, whereby the intrusion can be detected reliably. Also, since the pressure sensitive means is stored within the packet, there is less influence of rain and wind, and a strong weather resistance. Further, the workability is excellent because the intrusion detection device can be mounted directly on the surface of the fence.

A fortieth invention provides the intrusion detection device according to the thirty ninth invention, wherein the packet is composed of a lamina in which at least one of metal and synthetic resin is stacked by lamination. Thereby, there is no influence of rain and wind, and the strong weather resistance is provided by using a laminate film having high waterproof performance. And the workability is excellent because the intrusion detection device can be mounted directly on the surface of the fence.

A forty first invention provides the intrusion detection device according to the thirty ninth or fortieth invention, wherein the packet comprises fixing means for fixing on the outside stably. Thereby, the intrusion detection device can be firmly fixed on the outside such as a fence.

A forty second invention provides the intrusion detection device according to any one of the thirty ninth to forty first invention, further comprising support means for elastically supporting the pressure sensitive means inside the packet. Thereby, since the support means elastically supports the pressure sensitive means, the pressure sensitive means is more likely to deform due to a pressure when the intruder puts the hand on the upper part of the wall-like structure to get over the wall-like structure, and an output signal according to a deformation can be outputted from the pressure sensitive means rapidly, whereby the detection sensitivity is improved. Also, in the work, the pressure sensitive means is deformed according to the shape of an opposed fixing face by the elastic support means, whereby the intrusion detection device can be mounted on the upper face of the wall-like structure or fence having various shapes such as plane, curved surface and concavity and convexity.

A forty third invention provides the intrusion detection device according to the forty second invention, wherein the support means comprises a non-linear flexure part. Thereby, since the non-linear flexure part is the support means molded to be flexed by a predetermined pressing force or more, the piezoelectric sensor that is the pressure sensitive means supported by the support means functions by a pressing force caused by a getting over action of the intruder, but does not detect any signal of noise component such as small animal, wind, rain or snow. Hence, there is no false detection and the detection precision is improved.

A forty fourth invention provides the intrusion detection device according to any one of the thirty ninth to forty third inventions, wherein the detection means comprises detection level adjustment means for adjusting a detection level at which the pressure sensitive means functions. Thereby, the detection sensitivity can be adjusted on site in various mounting forms of the fence or the like, whereby the installation ability is better and an adaptable range of product is broadened.

A forty fifth invention provides the intrusion detection device according to any one of the thirty ninth to forty fourth inventions, further comprising threatening means for generating the alarm based on an output signal of the detection means. Thereby, the intruder can be threatened by the alarm and discouraged from making the intrusion.

A forty sixth invention provides the intrusion detection device according to any one of the thirty ninth to forty fifth inventions, further comprising communication means for communicating an output signal of the detection means to an external apparatus. Thereby, it is notified an indoor warning terminal, an external telephone, a security company or the police that the intrusion of the intruder occurs, whereby it is possible to rapidly react to the occurrence of intrusion.

A forty seventh invention provides an intrusion detection device comprising pressure sensitive means for detecting the intruder who intrudes into the dwelling by getting over the handrail of veranda or the fence, detection means for detecting the intruder who intrudes into the dwelling based on a sensor signal detected by the pressure sensitive means, data communication means for transmitting the information concerning the intrusion detection to a central processing unit, based on a detection signal from the detection means, report means for making a report to the outside, based on a detection signal of the detection means, and a power supply part for supplying electric power from a built-in battery to the pressure sensitive means, the detection means, the data communication means and the report means. Thereby, since the intrusion detection device is disposed on the handrail of veranda or inside the fence, it is not required to install the equipment such as a control unit outside, whereby the wiring work is not required, and the appearance is not impaired by the control unit or the like. Also, since the monitoring apparatus installed is not seen from the outside, the intrusion detection device has a great-looking layout. Moreover, it is possible to notify an indoor warning terminal, an external telephone, a security company or the police by transmitting the information concerning the intrusion detection to the central processing unit, and thereby to rapidly react to the occurrence of intrusion.

A forty eighth invention provides the intrusion detection device according to the forty seventh invention, further comprising sensitivity switching means for switching the detection sensitivity of the pressure sensitive means, because the detection sensitivity of the pressure sensitivity is changed depending on the building material for the fence or handrail or the installation situation. Thereby, the false detection is unlikely to occur, and the detection sensitivity can be adjusted in accordance with the installation situation.

A forty ninth invention provides the intrusion detection device according to the forty seventh or forty eighth invention, further comprising support means for elastically supporting the pressure sensitive means. Thereby, since the support means elastically holds the pressure sensitive means, the pressure sensitive means is more likely to deform due to a pressure when the intruder puts the hand or foot in getting over the fence or handrail, and an output signal according to a deformation can be outputted from the pressure sensitive means rapidly, whereby the detection sensitivity is improved. Also, since the pressure sensitive means is built in the support means or mounted along the shape of the support means, the pressure sensitive means can be disposed with the support means inside the fence or handrail, and it is not required that the pressure sensitive means is fixed by using a fixture or the like, whereby the installation ability is improved.

A fiftieth invention provides the intrusion detection device according to any one of the forty seventh to forty ninth inventions, wherein the handrail of veranda and the veranda (wall-like structure) are connected using a vibration propagation member in the constitution where the handrail of veranda is attached to the veranda (wall-like structure). Thereby, if the pressure sensitive means is mounted on the veranda (wall-like structure), the intruder can be naturally detected when the intruder puts the hand or foot on the veranda (wall-like structure) to get over the veranda. Further, when the intruder does not put the hand or foot on the veranda (wall-like structure) but puts the hand or foot on the handrail installed on the veranda to get over the veranda, the vibration in getting over the handrail is propagated through the vibration propagation member to the pressure sensitive means disposed on the veranda (wall-like structure), so that the intrusion can be detected. Therefore, even if the pressure sensitive means is not disposed on the handrail of veranda, the intrusion can be detected, whereby the cost is reduced and the installation ability is improved.

A fifty first invention provides the intrusion detection device according to the forty ninth invention, wherein the pressure sensitive means comprises a non-linear flexure part having an elastic characteristic of being non-linearly flexed if a load of a predetermined weight or more is applied. Even if a pressure is applied on the pressure sensitive means upon the motion of the small animal, the non-linear flexure part is not flexed unless a load of a predetermined weight or more is applied thereon, so that the pressure sensitive means is not deformed, whereby there is no false detection.

A fifty second invention provides the intrusion detection device according to any one of the forty seventh to fifty first inventions, wherein the pressure sensitive means comprises a flexible cable-like piezoelectric sensor. Since the piezoelectric sensor outputs a voltage signal according to an acceleration of deformation due to the piezoelectric effect, the intrusion can be detected by detecting rapidly a deformation caused by a pressure when the intruder puts the hand or foot on the handrail of veranda or the fence. Further, the piezoelectric sensor is like the flexible cable and can be freely laid along the shape of the handrail of veranda or the fence.

A fifty third invention provides an intrusion detection device, comprising pressure sensitive means disposed on the handrail of a wall-like structure such as veranda, elastic support means for elastically supporting the pressure sensitive means, and detection means for detecting the intruder who intrudes into the dwelling based on a sensor signal detected by the pressure sensitive means, in which the elastic support means is disposed on the handrail and covered with a handrail cover. Thereby, since the elastic support means is covered with the handrail cover, the appearance is not impaired. Further, since the intruder does not notice that the pressure sensitive means is disposed, the crime prevention effect is enhanced.

A fifty fourth invention provides the intrusion detection device according to the fifty third invention, wherein the elastic support means is provided with a convex portion. Thereby, if the elastic support means is pressed, the pressure sensitive means supported by the elastic support means is more likely to flex, whereby the detection sensitivity is improved. The convex portion is desirably provided in a region which is possibly subjected to pressure, and desirably provided like a band on the elastic body that is molded like a band. In the case of extrusion molding, though there is a merit that the elastic body is easily manufactured, only the convex portion may be partially provided.

A fifty fifth invention provides the intrusion detection device according to the fifth third or fifth fourth invention, wherein pressing means for pressing the elastic support means is provided on a face opposed to the elastic support means inside the handrail cover that covers the elastic support means.

Hence, when the handrail is pressed, the pressure sensitive means supported by the elastic support means is more likely to flex, whereby the detection sensitivity is improved.

A fifty sixth invention provides the intrusion detection device according to the fifty third invention, wherein pressing member support means for attaching second pressing means is provided on an upper face of the inside of the handrail cover that covers the elastic support means, namely, a face opposed to the elastic support means inside.

A fifty seventh invention provides the intrusion detection device according to the fifty sixth invention, wherein the second pressing means is attached to the pressing member support means. Thereby, the second pressing means can be adjusted to a designated position by freely sliding it after the second pressing means is attached to the pressing member support means, whereby the spacing between the pressing means can be easily adjusted.

A fifty eighth invention provides the intrusion detection device, further comprising third pressing means that can be attached by covering a part of the elastic support means for supporting the pressure sensitive means. Thereby, the third pressing means can be easily attached to the elastic support means. When the handrail is pressed, the pressure sensitive means supported by the elastic support means is more likely to flex, whereby the detection sensitivity is improved.

A fifty ninth invention provides the intrusion detection device, wherein fourth pressing means are molded at predetermined intervals in the second elastic support means for supporting the pressure sensitive means. Thereby, even if the pressing means is not retrofitted, when the handrail is pressed, the pressure sensitive means supported by the elastic support means is more likely to flex, whereby the detection sensitivity is improved. The predetermined interval may be any interval.

A sixtieth invention is characterized in that the pressure sensitive means is bent like a wave. And even if the pressing means is not attached, when the handrail is pressed, a bent part of the pressure sensitive means is subjected to deflection, and more likely to cause a displacement, whereby the detection sensitivity is improved.

A sixty first invention is characterized by further comprising third elastic support means for elastically supporting the pressure sensitive means, in which the third elastic support means is bent. Thereby, if the pressure sensitive means is disposed on the upper face of the third elastic support means that is bent, the pressure sensitive means supported on the upper part of the bent part of the third elastic support means causes a displacement due to a pressure to which the handrail cover is subjected, whereby the detection voltage is more likely to occur. Also, if the pressure sensitive means is disposed along the third elastic support means that is bent, the pressure sensitive means is easily bent in the shape, and is more likely to deform due to pressure. Hence, the detection sensitivity is improved.

A sixty second invention provides the intrusion detection device according to any one of the fifty third to sixty first inventions, wherein the pressure sensitive means comprises a flexible cable-like sensor. Since the piezoelectric sensor outputs a voltage signal according to an acceleration of deformation due to the piezoelectric effect, the intrusion can be detected by detecting rapidly a deformation when the intruder puts the hand or foot on the handrail of veranda or the fence. Also, since the piezoelectric sensor is like the flexible cable, the piezoelectric sensor can be freely laid along various shapes of the handrail of veranda or the fence.

The embodiments of the present invention will be described below with reference to the drawings. This invention is not limited to those embodiments.

### EMBODIMENT 1

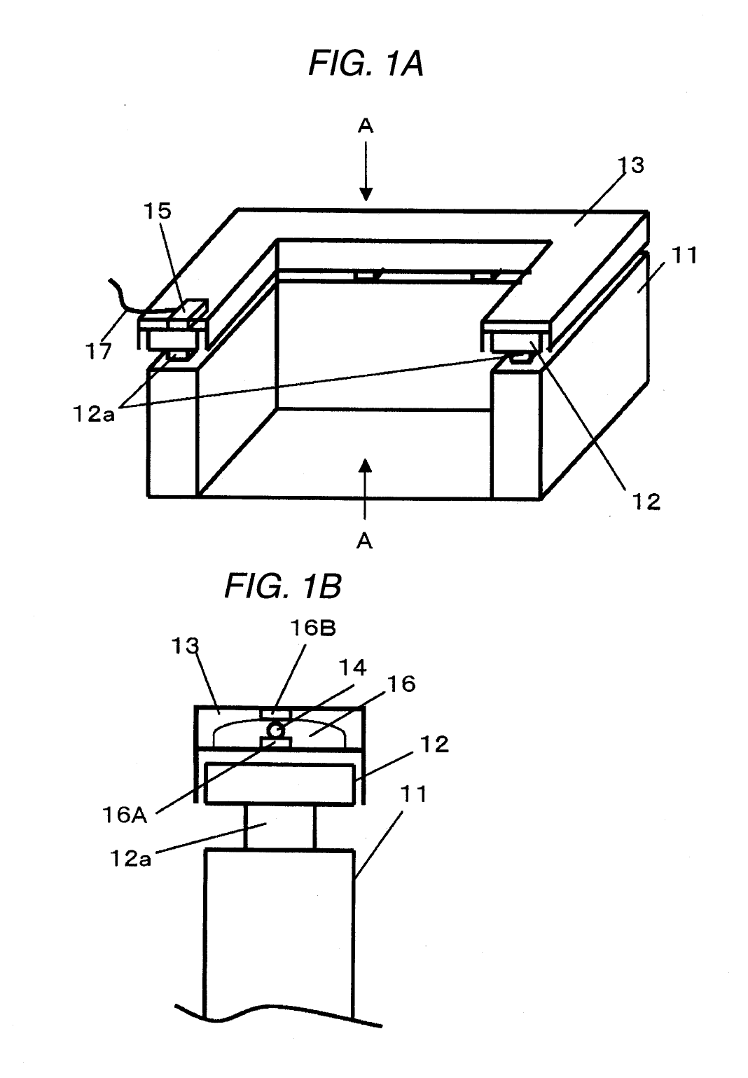

FIG. 1A is a constitutional view of a wall-like structure having installed an intrusion detection device according to a first embodiment of the invention and FIG. 1B is a cross-sectional view of the wall-like structure, taken along the A-A line in FIG. 1A. In FIG. 1A, reference numeral 11 denotes the wall-like structure such as a fence of veranda or balcony for the domicile, a wall or a fence surrounding the premises, and reference numeral 12 denotes a handrail installed on the upper part of the wall-like structure 11. The handrail 12 may be dispensed with. Reference numeral 13 denotes a packet made of metal, resin or wood, in which the packet is mounted on the handrail 12. If the handrail 12 is not provided, the packet is mounted on the wall-like structure 11. As shown in FIG. 1B, reference numeral 14 denotes a piezoelectric sensor (pressure sensitive means) that is stored inside the packet 13. The piezoelectric sensor 14 is like the flexible cable as the pressure sensitive means. That is, the pressure sensitive means stored in the packet is deformed to output a signal as the packet is subjected to a pressure and varied in the shape. Also, reference numeral 16 denotes support means, in which the piezoelectric sensor 14 is supported by the support means 16 composed of an elastic body softer than the piezoelectric sensor 14. The piezoelectric sensor 14 is provided with a slit in a part of the support means 16 and fitted through the slit into the support means 16 for supporting it. The elastic body uses a foam of synthetic resin such as EPDM or thermoplastic elastomer, of which the hardness and the expansion ratio are selected so that the compressibility (load value causing a unit displacement) may be smaller than the piezoelectric sensor 14. A non-linear flexure part 16A and a pressing portion 16B are provided adjacent to the piezoelectric sensor 14 and the support means 16. Thereby, the piezoelectric sensor 15 is more likely to deform. The constitution near the piezoelectric sensor 14 and the support means 16 will be described later in detail. As shown in FIG. 1A, reference numeral 15 denotes a control unit, which is disposed at an end part of the piezoelectric sensor 14. Also, reference numeral 17 denotes a communication cable, through which a signal from communication means, not shown, within the control unit 15 is conveyed to the outside.

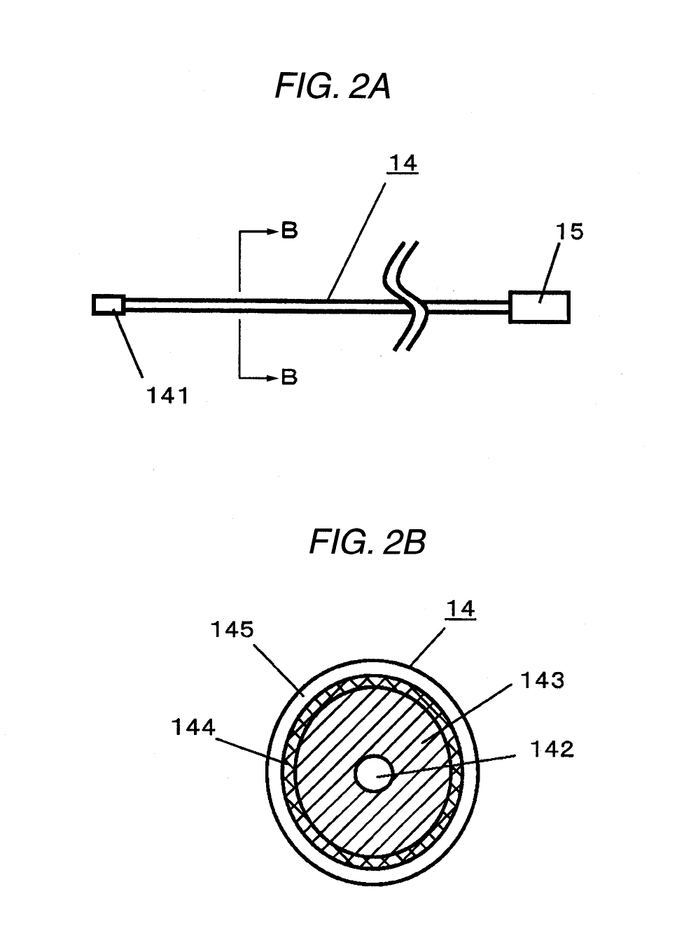

FIG. 2A is a constitutional view of the piezoelectric sensor 14 and the control unit 15 and FIG. 2B is a cross-sectional view of the piezoelectric sensor, taken along the line B-B in FIG. 2A. In FIG. 2A, the piezoelectric sensor 14 has a tip part 141 where a resistor for detecting the disconnection or short-circuit of electrode is built in. In FIG. 2B, the piezoelectric sensor 14 comprises a center electrode 142 made of conductor, a piezoelectric layer 143, a ground electrode 144 made of conductor, and a covering layer 145 made of an elastic body. The piezoelectric layer 143 may be made of resin-based piezoelectric polymer, such as polyvinylidene fluoride. However, it is not preferred to employ piezoelectric polymer because the heat resistant temperature is about 80° C. at the upper limit, the intrusion detection device is primarily employed outdoors, and particularly in summer, the surface temperature of the wall-like structure 11 sometimes reaches as high as near 100° C. due to the direct rays of the sun. The piezoelectric layer 143 may be made of piezoelectric compound in which a powder of piezoelectric ceramics is mixed into a specific resin base material, because the high temperature durability of 100° C. or more is provided. Such piezoelectric compound is preferably employed.

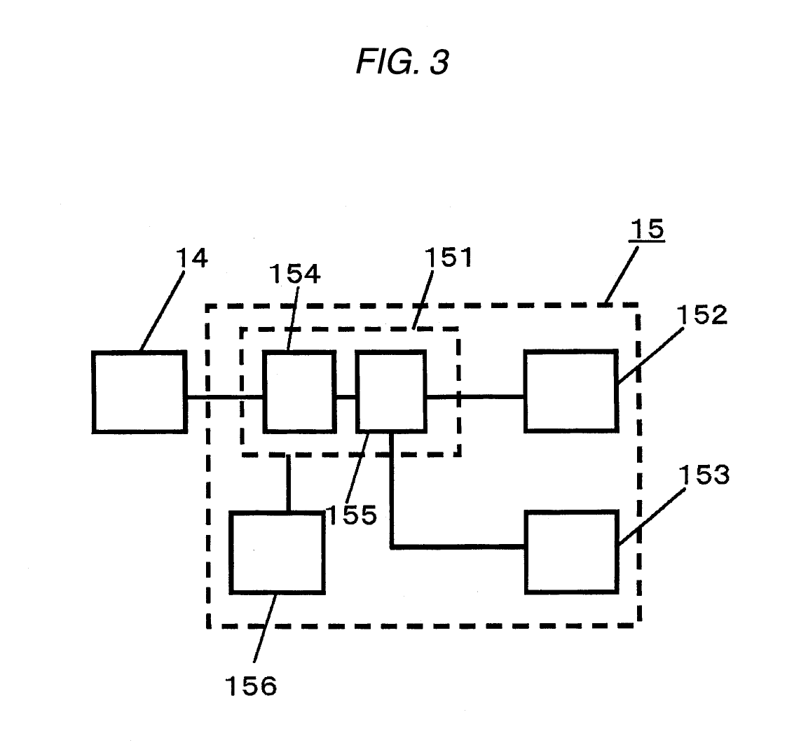

FIG. 3 is a block diagram of the intrusion detection device according to the first embodiment of the invention. In FIG. 3, the control unit 15 comprises detection means 151, threatening means 152 and communication means 153. The detection means 151 comprises a filter part 154 for filtering an output signal from the piezoelectric sensor 14 with a predetermined filtering characteristic, and amplifying the signal at a predetermined amplification degree, and a comparator part 155 for comparing the output signal of the filter part 154 with a preset value to determine the intrusion. The filtering characteristic of the filter part 154 is such that the frequency at the time of contact of the human body such as a hand is 10 Hz or less, especially in a range from 3 to 8 Hz, the vibration due to rainfall is 10 Hz or more, and the vibration due to wind is 1 Hz or less. Therefore, the filter part may be a band pass filter for passing the signal components of 3 to 8 Hz, for example, as the filtering characteristic. Reference numeral 156 denotes detection level adjustment means for adjusting the detection level.

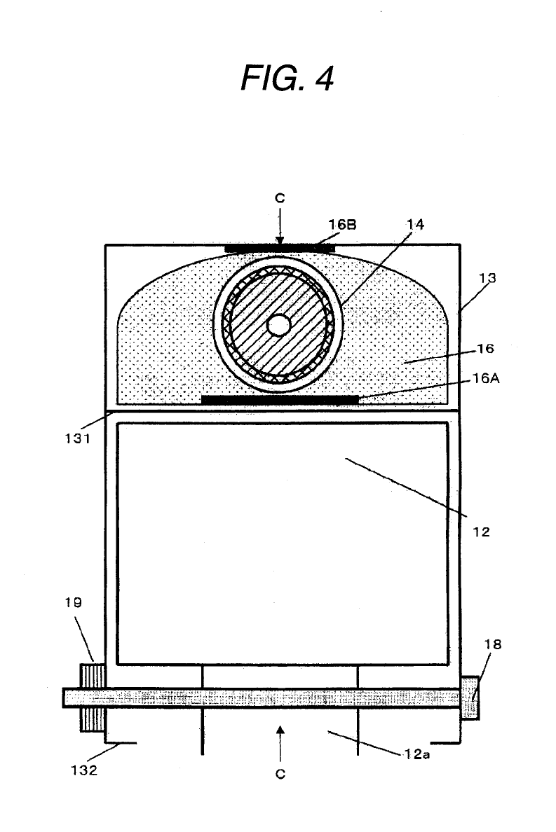

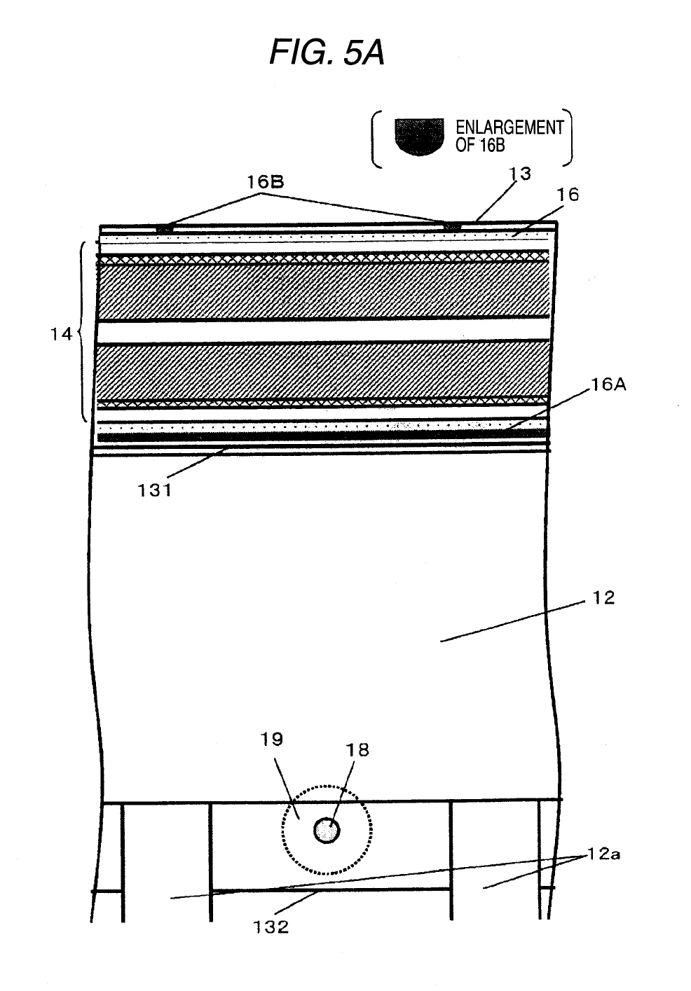

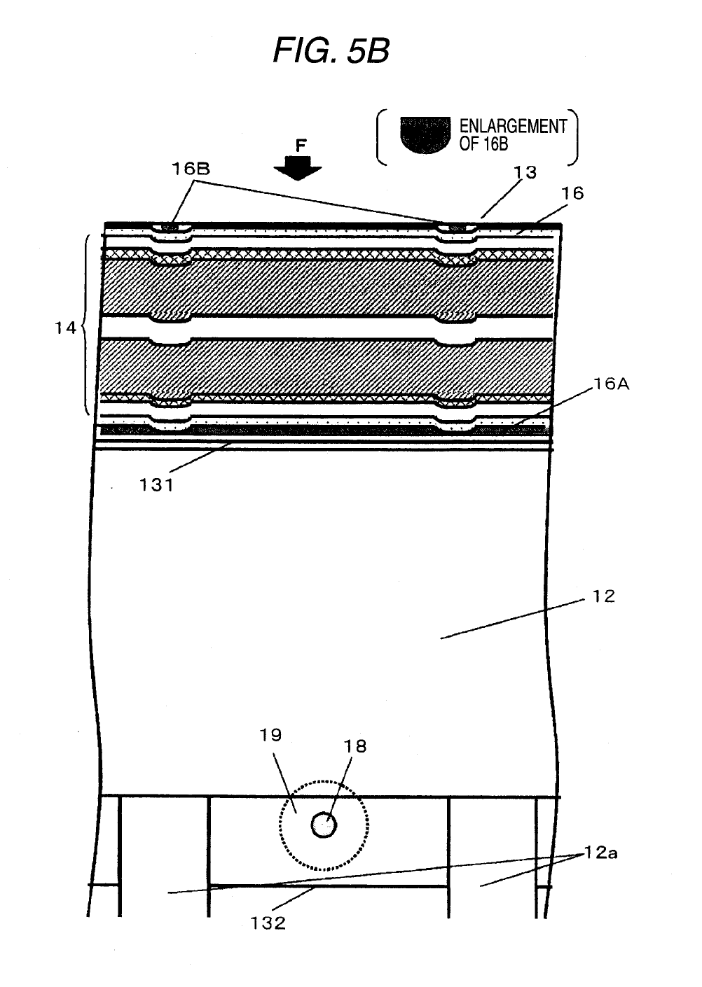

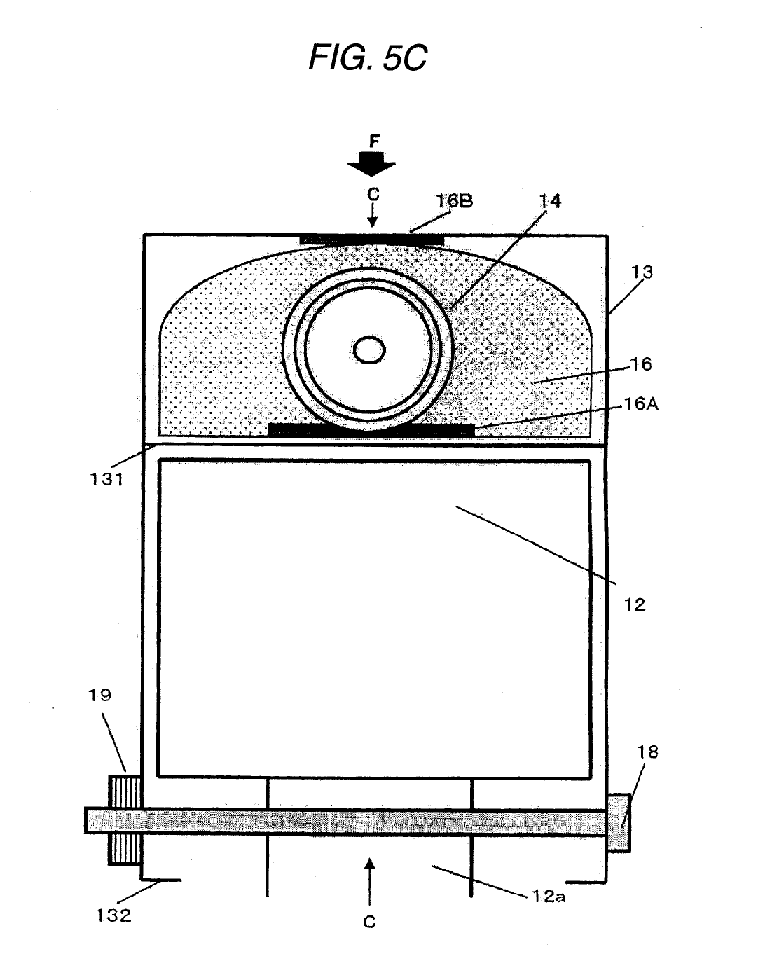

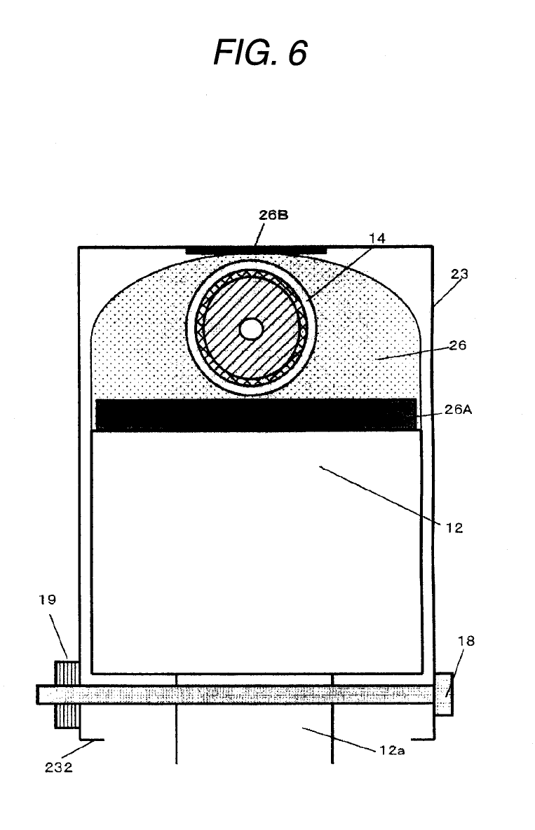

FIG. 4 is a detailed cross-sectional view, corresponding to the A-A cross-section of FIG. 1A, of the intrusion detection device according to the first embodiment of the invention. FIG. 5A is a C-C cross-sectional view of FIG. 4. Also, FIGS. 6, 7, 8, 9 and 10 are the detailed cross-sectional views, corresponding to the A-A cross-section of FIG. 1A, of the intrusion detection device according to the second, third, fourth, fifth and sixth embodiments of the invention.

Referring now to FIG. 4 and FIGS. 5A, 5B and 5C, the intrusion detection device according to the first embodiment will be described below. FIGS. 4 and 5A are the longitudinal cross-sectional views, FIG. 5B is a view showing a state where the intrusion detection device is deformed by the pressure in FIG. 5A, and FIG. 5C is a cross-sectional view of FIG. 5B. In these drawings, reference numeral 12 denotes a handrail of the wall-like structure, reference numeral 12a denotes a strut for the handrail, and reference numeral 13 denotes a packet made of metal, resin or wood. The piezoelectric sensor 14 and the support means 16 are stored inside the packet 13. The packet 13 has a storage portion for the piezoelectric sensor 14 like a bag on a face 131, in which the bag is preferably sealed but may not be necessarily sealed if it is covered with the packet. Also, the packet 13 is bent inwards like a face 132 on the lower part. Also, the face 132 is fitted with the handrail 12 to fix the packet. The piezoelectric sensor 14 and the support means 16 are stored inside the packet 13. Reference numerals 18 and 19 denote fixing means on the lower part of the packet 13, in which reference numeral 18 denotes a vis and reference numeral 19 denotes a nut. The packet 13 is fixed by using the vis 18 and the nut 19. This packet is fixed in a portion where the strut 12a is not provided as shown in FIG. 5B. The packet may be fastened using a string-like faster part, other than the vis 18 and the nut 19. Also, the fixing means 18 and 19 may be dispensed with. Also, the bent part 132 on the lower part may be dispensed with. The non-linear flexure part 16A is a mechanism with the non-linear flexing constitution using a solid, a hollow or a spring, and a material or mechanism more deformable than the support means 16. The pressing portion 16B is made of metal, resin or wood, and a material or mechanism less deformable than the support means 16. The non-linear flexure part 16A is provided inside the support means. Also, the pressing portion 16B is provided at a position where a force is applied via the support means 16 to the piezoelectric sensor 14. That is, when the intruder presses the packet, the packet is pressed in a direction of the force F, so that the pressing portion 16B is pressed by the force, and the pressing portion 16B flexes the support means 16 and the piezoelectric sensor 14 as shown in FIG. 5B. At this time, the support means 16 and the piezoelectric sensor 14 press the non-linear flexure part 16A more deformable than the support means 16, as seen in cross section as shown in FIG. 5C, whereby the non-linear flexure part is a more deformable mechanism than the support means 16.

The piezoelectric sensor 14 is flexed in the above manner, so that the intruder can be detected. The pressing portion 16B has an R plane here to apply a pressure to the support means 16 and the piezoelectric sensor 14 more easily, as shown in FIG. 5A. Alternatively, the pressing portion 16 B may have an acute angle or an obtuse angle. Of course, it may be planar. Also, the pressing portions 16B are disposed at regular intervals. Thereby, since the support means 16 and the piezoelectric sensor 14 near the region pressed by the intruder are only flexed, the detection is further facilitated. The non-linear flexure part 16A and the pressing portion 16B may not be necessarily provided.

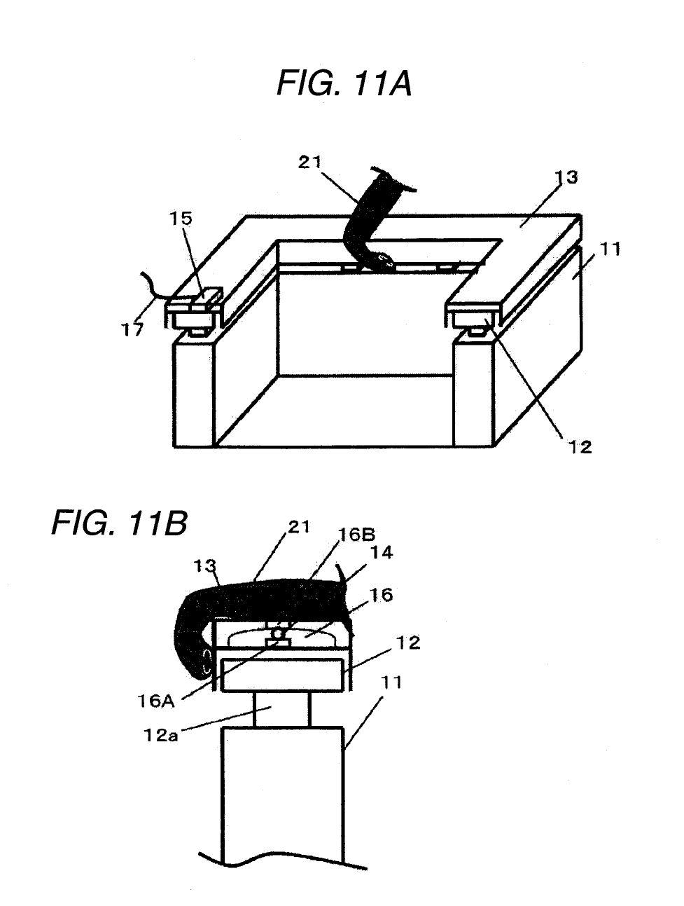

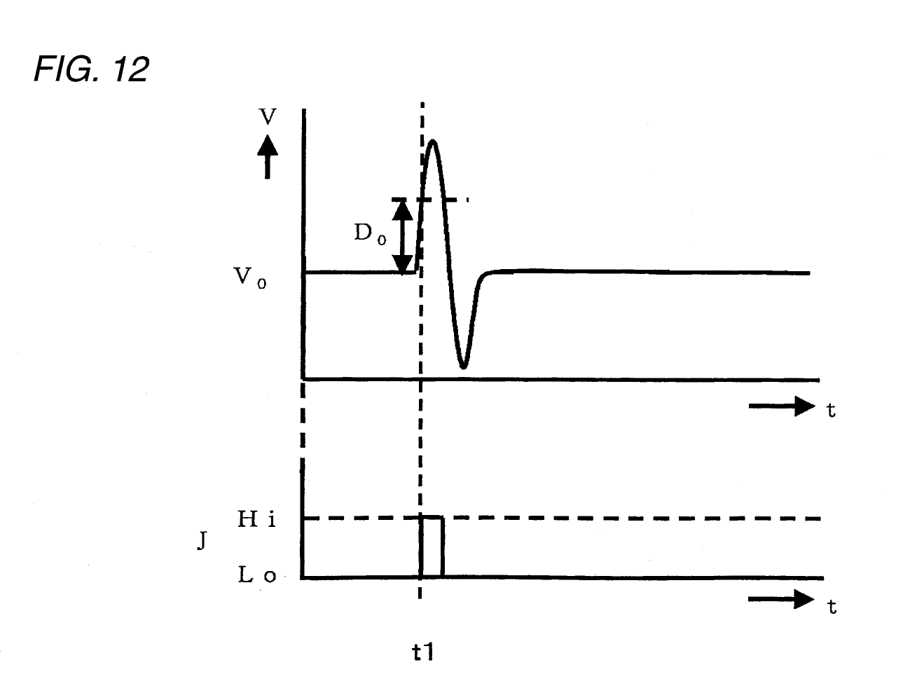

Referring to FIGS. 11A, 11B and 12, the operation and action of the intrusion detection device with the above constitution will be described below. FIG. 11A is a view showing a state where the intruder puts a hand 21 on the upper part of the wall-like structure 11 to hold up the body when intruding by getting over the wall-like structure 11, and FIG. 11B is a cross-sectional view of FIG. 11A. FIG. 12 is a characteristic chart showing an output signal V of the filter part 154 and an output signal J of the comparator part 155, varying over time, when the intruder intrudes.

First of all, if the intruder puts the hand 21 on the packet 13 mounted on the handrail 12 of the wall-like structure 11, a pressure due to the fingers of the hand 21 is applied to the piezoelectric sensor 14 and the support means 16, as shown in FIG. 11A. Since the support means 16 has greater flexibility than the piezoelectric sensor 14, the support means 16 is compressed by the pressure due to the contact with the fingers, so that the piezoelectric sensor 14 is also deformed easily, as shown in FIG. 11. And a signal according to an acceleration of deformation of the piezoelectric sensor 14 due to the piezoelectric effect is outputted from the piezoelectric sensor 14.

An output signal of the piezoelectric sensor 14 in a frequency band from 3 to 8 Hz at the time of contact with the hand 21 is passed through the filter part 154, but a signal in the other frequency band is removed. FIG. 12 shows an output voltage V of the filter part 154. At the time of contact with the hand 21, a signal component larger than the reference potential V₀ appears in V. In this case, with a structure in which the piezoelectric sensor 14 is mounted on the upper part of the handrail 12 of the wall-like structure 11, the deformation of the piezoelectric sensor 14 at the time of contact with the hand 21 is small. However, in this embodiment, since the support means 16 is composed of the elastic body having more flexibility than the piezoelectric sensor 14, the support means 16 is easily compressed at the time of contact, so that the packet 13 is slidable along the side face of the handrail 12 downward in a direction of the pressing force F, increasing the amount of deformation of the piezoelectric sensor 14. In this manner, if the force is applied in the direction of the pressing force F, the pressure detection sensor can be flexed. This slide stroke is set to about 1 mm, and if there is a stroke of about 1 mm in the mounted state, a voltage output from the pressure sensitive means sufficiently occurs. Further, the non-linear flexure part 16A has a material or component more deformable than the support means 16, and the pressing portion 16B has a material or component less deformable than the support means 16, whereby the pressing portion 16B passes the pressure of the hand 21 to the piezoelectric sensor 14, so that the piezoelectric sensor 14 is flexed. Also, the non-linear flexure part 16A is deformed due to the pressure, and the packet 13 is further slid, so that the amount of deformation is increased. In this manner, the piezoelectric sensor 14 elastically supported by the support means has a larger amount of deformation. The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1.

If the comparator part 155 outputs a pulse signal of intrusion determination, an alarm sound is generated for a certain time from the threatening means 152 to threaten the intruder. At the same time, the notifying means 153 notifies an indoor warning terminal, an external telephone, a security company or the police that the intrusion of the intruder occurs. Also, the packet 13 is fastened by using the vis 18 and the nut 19 as the fixing means for fixing on the handrail 12 of the wall-like structure 11, and can be moved vertically along the face of the handrail 12.

Also, the packet 13 is fitted with the handrail 12 by bending inwards the lower part such as the face 132, so that the packet 13 is not removed from the handrail 12. That is, the packet is movable vertically, but the face 132 serves as an upward detent.

Since the detection level adjustment means for adjusting the detection level is provided, it is possible to adjust a minute difference in the detection level between various wall-like structures having different structures for mounting, and also cope with a minute difference in the detection level due to a different way of mounting depending on the site environment, whereby the workability is excellent and the application range is wide. Also, the detection level can be adjusted in accordance with a secular change or a preference of the customer.

Also, the threatening means is provided for generating the alarm based on an output signal of the detection means, whereby the intruder can be threatened and discouraged from making the intrusion.

Further, the communication means for communicating the output signal of the detection means to the external apparatus is provided, whereby it can be notified an indoor warning terminal, an external telephone, a security company or the police that the intrusion of the intruder occurs, to rapidly react to the occurrence of intrusion.

Though in this embodiment the slidable direction is almost vertical along the side face of the handrail, the slidable direction is not limited to the vertical direction, depending on the form in which the wall-like structure or the handrail is installed, in which it is required that the direction for receiving the pressure may be the movable direction properly.

Also, the non-linear flexure part 16A is provided on the opposite face of the pressure detection sensor where the pressing force is received, in which the distance to the pressure receiving face is made as small as possible, thereby enhancing the installation effect of the pressing portion 16B.

It is desirable that the pressing portions are provided at one or more positions, and the arrangement density is properly changed in view of the constitution of the wall-like structure or the installation situation in which the wall-like structure is installed in the house. For example, the flexure of the handrail itself is smaller at a direct upper part of the strut 12a, and the detection sensitivity of the pressure sensitive means itself is possibly low. In that case, the arrangement density of the pressing portion may be increased. For example, a tape-like part having projection as the pressing portion is pasted inside the packet, in which if the number of tapes to be pasted is decided depending on whether the required arrangement density of projections is high or low, the pressing portion can be constituted efficiently. Also, it is effective that plural kinds of tapes having different density of projections are prepared, and the kind of tape to be pasted is selected according to the required arrangement density. Also, when there is a small difference in the required arrangement density between the places, a plurality of tape-like parts having projections are pasted at any intervals, whereby the number of parts to be pasted can be reduced, and the pressing portions can be constituted efficiently. In this manner, since the arrangement of the pressing portions is variable, the pressing portions can be installed adaptively to the installation situation or structure of the wall-like structure.

### EMBODIMENT 2

FIG. 6 is a cross-sectional view, corresponding to the A-A cross-section of FIG. 1A, for the intrusion detection according to a second embodiment of the invention. Referring to FIG. 6, an intrusion detection device according to the second embodiment of the invention will be described below. In FIG. 6, reference numeral 12 denotes a handrail of the wall-like structure, and reference numeral 23 denotes a packet, in which the piezoelectric sensor 14 and the support means 26 are stored inside the packet 23. The packet 23 is bent inwards like a face 232 on the lower part. Also, the face 232 is fitted with the handrail 12 to fix the packet. The piezoelectric sensor 14 and the support means 26 are stored inside the packet 23. Reference numerals 18 and 19 denote fixing means on the lower part of the packet 23, in which reference numeral 18 denotes a vis and reference numeral 19 denotes a nut. The packet 23 is fixed by using the vis 18 and the nut 19. The packet may be fastened using a string-like faster part, other than the vis 18 and the nut 19. A non-linear flexure part 26A and a pressing portion 26B are provided adjacent to the piezoelectric sensor 14 and the support means 26 to make the piezoelectric sensor 14 more deformable. For example, the pressing portion 26B is made of solid less deformable than the support means 26, and the non-linear flexure part 26A is an object or component more deformable than the support means 26. The non-linear flexure part 26A and the pressing portion 26B are equivalent to the non-linear flexure part 16A and the pressing portion 16B, respectively.

The operation and action of the intrusion detection device with the above constitution will be described below mainly regarding the feature portion of the embodiment 2 that is different from the embodiment 1 as described with reference to FIGS. 11 and 12. In this embodiment, the support means 26 is composed of an elastic body having more flexibility than the piezoelectric sensor 14, and the support means 26 is easily compressed at the time of contact, making the packet 23 slidable downward, so that the amount of deformation of the piezoelectric sensor 14 is increased. Further, the pressing portion 26B is less deformable than the support means 26, and the non-linear flexure part 26A is more deformable than the support means 26, whereby the pressing portion 26B conveys 21a pressure from the hand to the piezoelectric sensor 14 and presses the piezoelectric sensor 14. Also, the non-linear flexure part 26A is deformed due to pressure, and the packet 23 is further slid downward, so that the amount of deformation is increased. In this manner, the piezoelectric sensor 14 has a larger amount of deformation. The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1.

Also, the packet 23 is fastened by using the vis 18 and the nut 19 as the fixing means for fixing on the handrail 12 of the wall-like structure 11, and can be moved vertically along the face of the handrail 12 stably.

Also, the packet 23 is fitted with the handrail 12 by bending inwards the lower part such as the face 232, so that the packet 23 is not removed from the handrail 12.

### EMBODIMENT 3

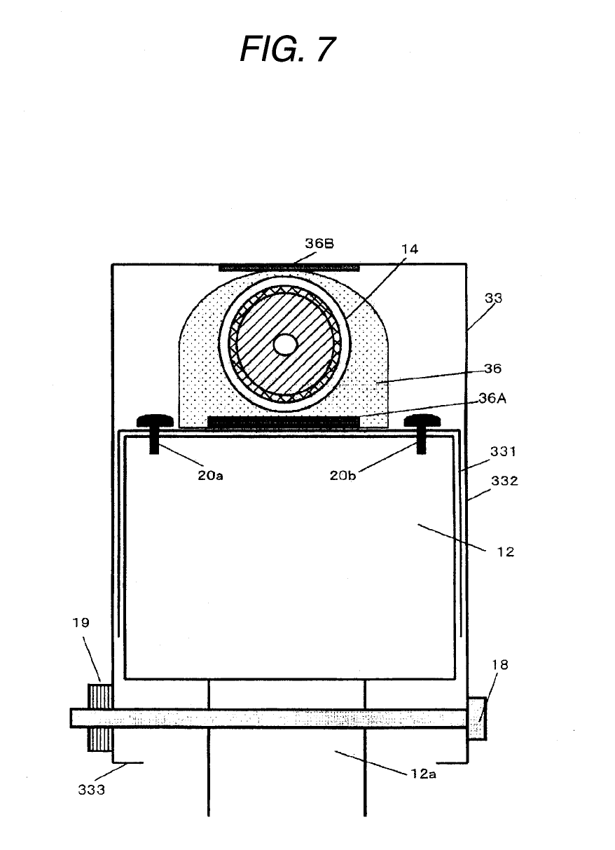

FIG. 7 is a cross-sectional view, corresponding to the A-A cross-section of FIG. 1A, for the intrusion detection according to a third embodiment of the invention. Referring to FIG. 7, an intrusion detection device according to the third embodiment will be described below. In FIG. 7, reference numeral 12 denotes a handrail of the wall-like structure, and reference numeral 33 denotes a packet, in which the packet 33 has a mount part 331 and a movable part 332. The piezoelectric sensor 14 and the support means 36 are stored inside the packet 33, surrounded by the mount part 331 and the movable part 332. The packet 33 is bent inwards like a face 333 on the lower part. Also, the face 333 is fitted with the handrail 12 to fix the packet. Reference numerals 18 and 19 denote fixing means on the lower part of the packet 33, in which reference numeral 18 denotes a vis and reference numeral 19 denotes a nut. The packet 33 is fixed by using the vis 18 and the nut 19. The packet may be fastened using a string-like faster part, other than the vis 18 and the nut 19. Reference signs 20a and 20b denote fixing means for use to fix the mount part 331 of the packet 33 to the handrail 21. Though in this embodiment a tapping pin is employed, a screw with nut, an adhesive tape or an adhesive agent may be employed. A non-linear flexure part 36A and a pressing portion 36B are provided adjacent to the piezoelectric sensor 14 and the support means 36 to make the piezoelectric sensor 14 more deformable. For example, a non-linear flexure part 36C is made of solid less deformable than the support means 36, and the non-linear flexure part 36A is an object or component more deformable than the support means 36. The non-linear flexure part 36A and the pressing portion 36B are equivalent to the non-linear flexure part 16A and the pressing portion 16B, respectively.

The operation and action of the intrusion detection device with the above constitution will be described below mainly regarding the feature portion of the embodiment 3 that is different from the embodiments 1 and 2 as described with reference to FIGS. 11 and 12. In this embodiment, the support means 36 is composed of an elastic body having more flexibility than the piezoelectric sensor 14, and the support means 36 is easily compressed at the time of contact, making the movable part 332 of the packet 33 slidable downward, so that the amount of deformation of the piezoelectric sensor 14 is increased. Further, the pressing portion 36B is less deformable than the support means 36, and the non-linear flexure part 36A is more deformable than the support means 36, whereby the pressing portion 36B conveys a pressure from the hand 21 to the piezoelectric sensor 14 and presses the piezoelectric sensor 14. Also, the non-linear flexure part 36A is deformed due to pressure, and the movable part 332 is further slid downward, so that the amount of deformation is increased. In this manner, the piezoelectric sensor 14 has a larger amount of deformation.

The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1. At this time, the mount part 331 of the packet 33 is fixed to the handrail 12 of the fixing means 20. Herein, the fixing means 20 is a tapping vis. Also, movable part 332 is fastened by using the vis 18 and the nut 19 as the fixing means, and can be moved vertically along the face of the handrail 12 stably. Also, the movable part 332 is fitted with the handrail 12 by bending inwards the lower part such as the face 333, so that the packet 33 is not removed from the handrail 12.

### EMBODIMENT 4

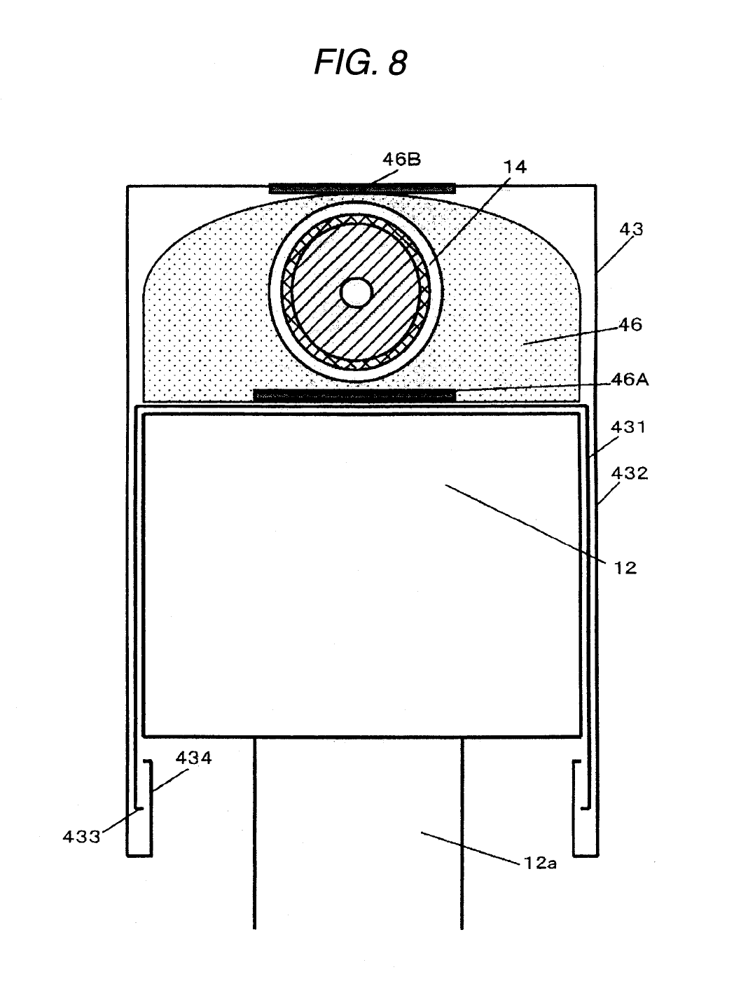

FIG. 8 is a cross-sectional view, corresponding to the A-A cross-section of FIG. 1A, for the intrusion detection according to a fourth embodiment of the invention. Referring to FIG. 8, an intrusion detection device according to the fourth embodiment will be described below. In FIG. 8, reference numeral 12 denotes a handrail of the wall-like structure, and reference numeral 43 denotes a packet, in which the packet 43 has a mount part 431 and a movable part 432. The piezoelectric sensor 14 and the support means 46 are stored inside the packet 43, surrounded by the mount part 431 and the movable part 432. The mount part 431 of the packet 33 is bent inwards like a face 433 on the lower part. Also, a face 434 of the movable part 432 has an inward bendable structure. With a structure of the face 433 and the face 434, the mount part 431 and the movable part 432 are fitted together. Also, the mount part 431 is fitted with the handrail 12. However, the vertical movement of the movable part 432 is permitted. A non-linear flexure part 46A and a pressing portion 46B are provided adjacent to the piezoelectric sensor 14 and the support means 46 to make the piezoelectric sensor 14 more deformable. For example, a non-linear flexure part 46C is made of solid less deformable than the support means 46, and the non-linear flexure part 46A is an object or component more deformable than the support means 46. The non-linear flexure part 46A and the pressing portion 46B are equivalent to the non-linear flexure part 16A and the pressing portion 16B, respectively.

The operation and action of the intrusion detection device with the above constitution will be described below mainly regarding the feature portion of the embodiment 4 that is different from the embodiments 1 to 3 as described with reference to FIGS. 11 and 12. In this embodiment, the support means 46 is composed of an elastic body having more flexibility than the piezoelectric sensor 14, and the support means 46 is easily compressed at the time of contact, making the movable part 432 of the packet 43 slidable downward, so that the amount of deformation of the piezoelectric sensor 14 is increased. Further, the pressing portion 46B is less deformable than the support means 46, and the non-linear flexure part 46A is more deformable than the support means 46, whereby the pressing portion 46B conveys a pressure from the hand 21 to the piezoelectric sensor 14, and presses the piezoelectric sensor 14. Also, the non-linear flexure part 46A is deformed due to pressure, and the movable part 432 is further slid downward, so that the amount of deformation is increased. In this manner, the piezoelectric sensor 14 has a larger amount of deformation.

The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1. At this time, the mount part 431 of the packet 43 is fitted and fixed with the handrail 12 through the face 433. Since the movable part 432 is fitted with the mount part 431 through the face 434, it is vertically movable, but is not removed and can be stably vertically moved.

### EMBODIMENT 5

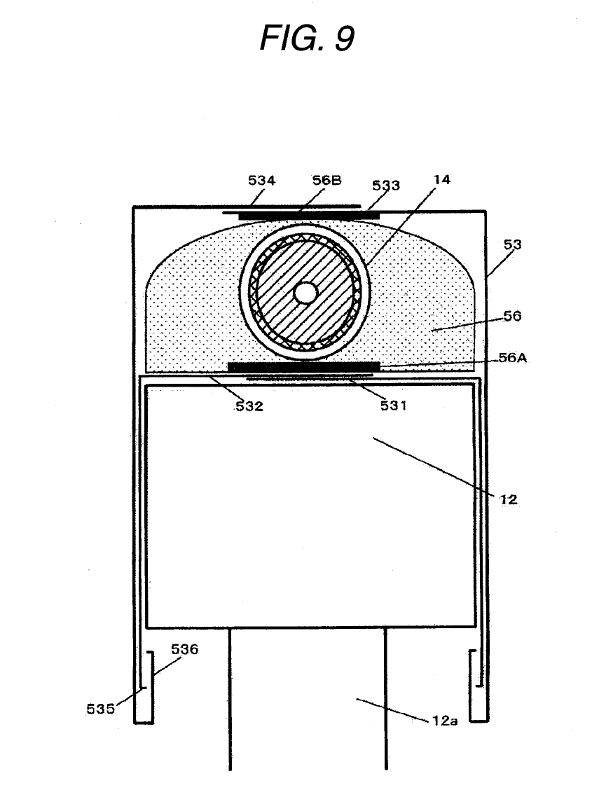

FIG. 9 is a cross-sectional view, corresponding to the A-A cross-section of FIG. 1A, for the intrusion detection according to a fifth embodiment of the invention. Referring to FIG. 9, an intrusion detection device according to the fifth embodiment will be described below. In FIG. 9, reference numeral 12 denotes a handrail of the wall-like structure, and reference numeral 53 denotes a packet, in which the packet 53 has the mount parts 531, 532 and the movable parts 533, 534. The mount parts 531 and 532 have a mutually overlapping portion, and can cope with a change in the size of the handrail 12. Likewise, the movable parts (shape variable parts) 533 and 534 have a mutually overlapping portion, and can cope with a change in the size of the handrail 12. They have the variable shape to conform to various shapes of the handrail, and in this application, the size in the width direction can be adjusted. The piezoelectric sensor 14 and the support means 56 are stored inside the packet 53, surrounded by the mount part 531, 532 and the movable parts 533, 534. The mount parts 531 and 532 of the packet 53 are bent inwards like a face 535 on the lower part. Also, a face 536 of the movable parts 533 and 534 has an inward bendable structure. The face 535 and the face 536 are fitted together. Also, the mount parts 531 and 532 are fitted with the handrail 12. However, the vertical movement of the movable parts 533 and 534 is permitted. A non-linear flexure part 56A and a pressing portion 56B are provided adjacent to the piezoelectric sensor 14 and the support means 56 to make the piezoelectric sensor 14 more deformable. For example, the pressing portion 56B is made of solid less deformable than the support means 56, and the non-linear flexure part 56A is an object or component more deformable than the support means 56. The non-linear flexure part 56A and the pressing portion 56B are equivalent to the non-linear flexure part 16A and the pressing portion 16B, respectively.

The operation and action of the intrusion detection device with the above constitution will be described below mainly regarding the feature portion of the embodiment 5 that is different from the embodiments 1 to 4 as described with reference to FIGS. 11 and 12. In this embodiment, the support means 56 is composed of an elastic body having more flexibility than the piezoelectric sensor 14, and the support means 56 is easily compressed at the time of contact, making the movable parts 531 and 532 of the packet 53 slidable downward, so that the amount of deformation of the piezoelectric sensor 14 is increased. Further, the pressing portion 56B is less deformable than the support means 56, and the non-linear flexure part 56A is more deformable than the support means 56, whereby the pressing portion 56B conveys a pressure from the hand 21 to the piezoelectric sensor 14, and presses the piezoelectric sensor 14. Also, the non-linear flexure part 56A is deformed due to pressure, and the movable parts 533 and 534 are further slid downward, so that the amount of deformation is increased. In this manner, the piezoelectric sensor 14 has a larger amount of deformation. The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1. At this time, the mount parts 531 and 532 of the packet 53 are fitted and fixed with the handrail 12 through the face 535. Also, the movable parts 533 and 534 are fitted with the mount parts 531 and 532 through the face 536, and vertically movable, but is not removed and can be stably vertically moved.

### EMBODIMENT 6

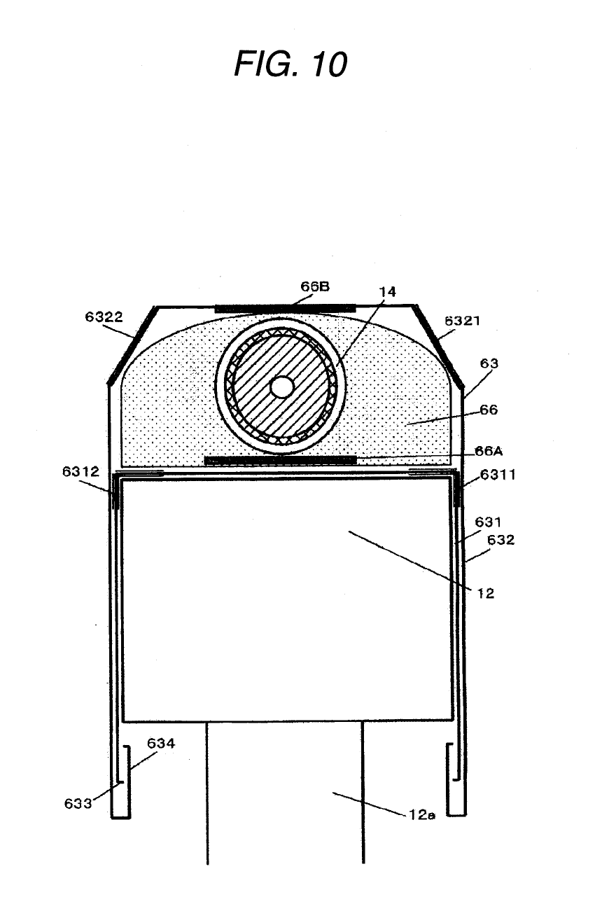

FIG. 10 is a cross-sectional view, corresponding to the A-A cross-section of FIG. 1A, for the intrusion detection according to a sixth embodiment of the invention. Referring to FIG. 10, an intrusion detection device according to the sixth embodiment will be described below. In FIG. 10, reference numeral 12 denotes a handrail of the wall-like structure, and reference numeral 63 denotes a packet, in which the packet 63 has a mount part 631 and a movable part 632. The mount part 631 has the bellows parts 6311 and 6312. The movable part 632 has the bellows parts 6321 and 6322. The bellows parts 6311, 6312, 6321 and 6322 are easily deformed to cope with a change in the size or shape of the handrail 12. The piezoelectric sensor 14 and the support means 66 are stored inside the packet 63. The mount part 631 of the packet 63 is bent inwards like a face 633 on the lower part. Also, a face 634 of the movable part 632 has an inward bendable structure. The face 633 and the face 634 are fitted together. Also, the mount part 631 is fitted with the handrail 12. However, the vertical movement of the movable part 632 is permitted. A non-linear flexure part 66A and a pressing portion 66B are provided adjacent to the piezoelectric sensor 14 and the support means 66 to make the piezoelectric sensor 14 more deformable. For example, the pressing portion 66B is made of solid less deformable than the support means 66, and the non-linear flexure part 66A is an object or component more deformable than the support means 66. The non-linear flexure part 66A and the pressing portion 66B are equivalent to the non-linear flexure part 16A and the pressing portion 16B, respectively.

The operation and action of the intrusion detection device with the above constitution will be described below mainly regarding the feature portion of the embodiment 6 that is different from the embodiments 1 to 5 as described with reference to FIGS. 11 and 12. In this embodiment, the support means 66 is composed of an elastic body having more flexibility than the piezoelectric sensor 14, and the support means 66 is easily compressed at the time of contact, making the movable part 631 of the packet 63 slidable downward, so that the amount of deformation of the piezoelectric sensor 14 is increased. Further, the pressing portion 66B is less deformable than the support means 66, and the non-linear flexure part 66A is more deformable than the support means 66, whereby the pressing portion 66B conveys a pressure from the hand 21 to the piezoelectric sensor 14, and presses the piezoelectric sensor 14. Also, the non-linear flexure part 66A is deformed due to pressure, and the movable part 632 is further slid downward, so that the amount of deformation is increased. In this manner, the piezoelectric sensor 14 has a larger amount of deformation. The acceleration that is the second order differential value of the amount of deformation is increased, so that the output signal of the piezoelectric sensor 14 is also increased. The comparator part 155 determines that a part of the body contacts the piezoelectric sensor if the amplitude |V-V₀| of V from V₀ is greater than D₀, and outputs a pulse signal L₀→Hi→L₀ as a determination output at time t1. At this time, the mount part 631 of the packet 63 is fitted and fixed with the handrail 12 through the face 633. Also, the movable part 632 is fitted with the mount part 631 through the face 634, and vertically movable, but is not removed and can be stably vertically moved.

Though in this embodiment 6 and the embodiment 5 the packet has a variable shape by being slidable in the width direction of the handrail and having the bellows on the corner portion of the packet, the invention is not limited to those embodiments as far as the packet is provided with an expansion mechanism. The expansion means may be constructed mechanically or using an expansion material to achieve the same effect. After the packet is mounted with the expansion means, a fixing member is provided, and the packet is installed along the shape of the handrail 12. For example, the bellows part is fixed by an adhesive member, or fixed on the lower part by a vis as in the embodiment 2, whereby the packet is fixed in accordance with the width of the handrail. Also, in the case where the packet is slidable as in the embodiment 5, one end face of the sliding part is desirably sealed and bonded with the other slide face.

### EMBODIMENT 7

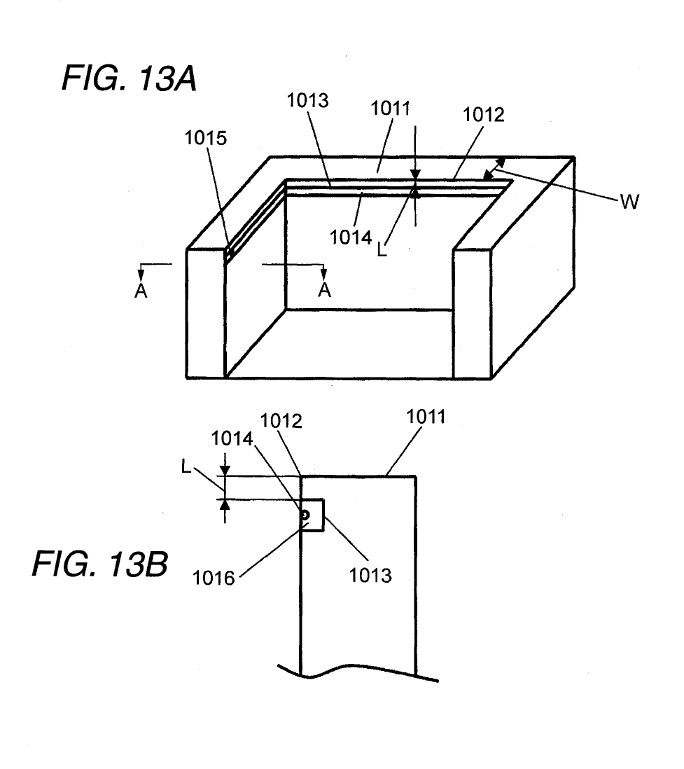

FIG. 13A is a constitutional view of a wall-like structure having installed an intrusion detection device according to a seventh embodiment of the invention, and FIG. 13B is a cross-sectional view of the wall-like structure, taken along the A-A line in FIG. 13A. In FIG. 13A, a groove portion 1013 is formed along the lower position a certain length L down from an upper end part 1012 of the wall-like structure 1011 such as a fence of veranda or a wall for the domicile on the domicile side, in which a flexible cable-like piezoelectric sensor 1014 as pressure sensitive means is disposed in the groove portion 1013.

The length L may be primarily set to the width W of the upper part of the wall-like structure 1011. For example, if W is large, it is difficult to put the hand on the upper part of the wall-like structure 1011 in making the intrusion, whereby L is made smaller. Conversely, if W is small, it is easy to put the hand on the upper part of the wall-like structure 1011 in making the intrusion, whereby L is made larger. In consideration of a state of putting the hand securely, it is required that at least the first joint and the second joint of the fingers touch a wall face of the wall-like structure 11 on the domicile side. From this point of view, L is desirably 10 mm or more.

A control unit 1015 is provided at an end part of the piezoelectric sensor 1014. In FIG. 13B, the piezoelectric sensor 1014 is supported by the support means composed of an elastic body softer than the piezoelectric sensor 1014. The piezoelectric sensor 1014 is provided with a slit in a part of the support means 1016, and fitted through the slit into the support means 1016 for supporting it. The elastic body uses a foam of synthetic resin such as EPDM or thermoplastic elastomer, of which the hardness and the expansion ratio are selected so that the compressibility (load value causing a unit displacement) may be smaller than the piezoelectric sensor 1014.

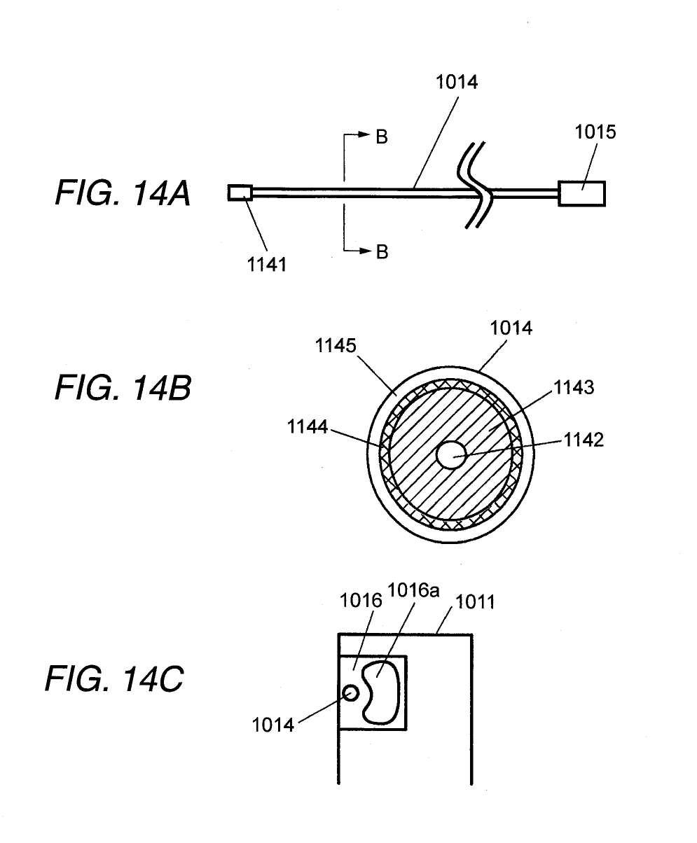

FIG. 14A is a constitutional view of the piezoelectric sensor 1014 and the control unit 1015 and FIG. 14B is a cross-sectional view of the piezoelectric sensor, taken along the line B-B in FIG. 14A. In FIG. 14A, the piezoelectric sensor 1014 has a tip part 1141 where a resistor for detecting the disconnection or short-circuit of electrode is built in. In FIG. 14B, the piezoelectric sensor 1014 comprises a center electrode 1142 made of conductor, a piezoelectric layer 1143, a ground electrode 1144 made of conductor, and a covering layer 1145 made of an elastic body. The piezoelectric layer 1143 may be resin-based piezoelectric polymer, such as polyvinylidene fluoride. However, it is not preferred to employ piezoelectric polymer because the heat resistant temperature is about 80° C. at the upper limit, the intrusion detection device is primarily employed outdoors, and particularly in summer, the surface temperature of the wall-like structure 1011 sometimes reaches as high as near 100° C. due to the direct rays of the sun. The piezoelectric layer 1143 may be made of piezoelectric compound in which a powder of piezoelectric ceramics is mixed into a specific resin base material, because the high temperature durability of 100° C. or more is provided. Such piezoelectric compound is preferably employed.

A hollow part 1016a may be provided adjacent to the piezoelectric sensor 1014 on the wall side of the support means 1016 to make the piezoelectric sensor 1014 more deformable, for example, as shown in FIG. 14C. And the slit into which the piezoelectric sensor 1014 is fitted may be sealed by an adhesive, in which it is preferred that a seal member is made of a material having elasticity.

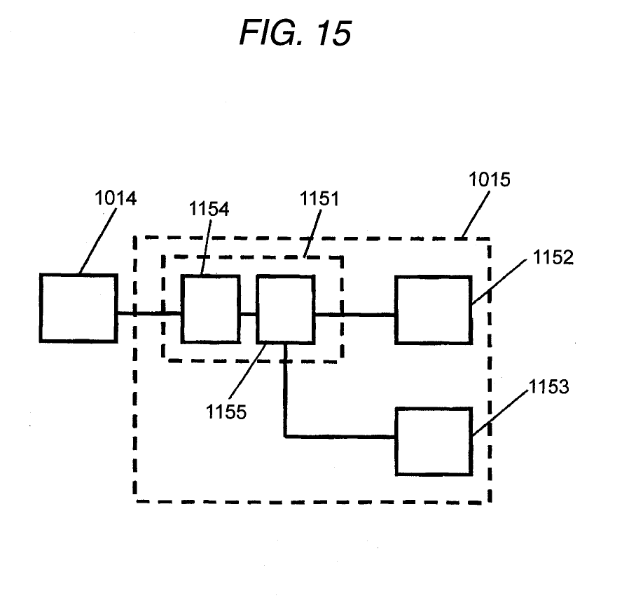

FIG. 15 is a block diagram of the intrusion detection device according to the seventh embodiment of the invention. In FIG. 15, the control unit 1015 comprises detection means 1151, alarm generation means 1152 and communication means 1153. The detection means 1151 comprises a filter part 1154 for filtering an output signal from the piezoelectric sensor 1014 with a predetermined filtering characteristic, and amplifying the signal at a predetermined amplification degree, and a comparator part 1155 for comparing the output signal of the filter part 1154 with a preset value to determine the intrusion. The filtering characteristic of the filter part 1154 is such that the frequency at the time of contact of a hand 1017 is 10 Hz or less, especially in a range from 3 to 8 Hz, the vibration due to rainfall is 10 Hz or more, and the vibration due to wind is 1 Hz or less. Therefore, the filter part may be a band pass filter for passing the signal components of 3 to 8 Hz, for example, as the filtering characteristic.

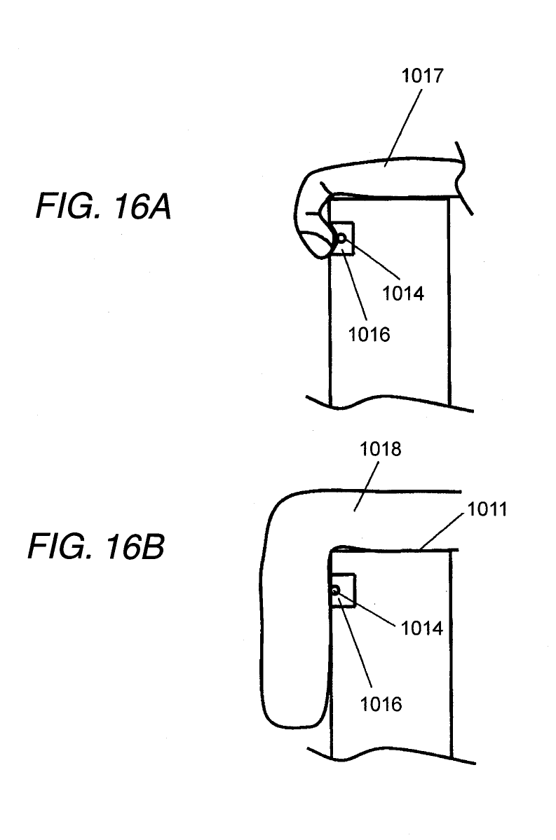

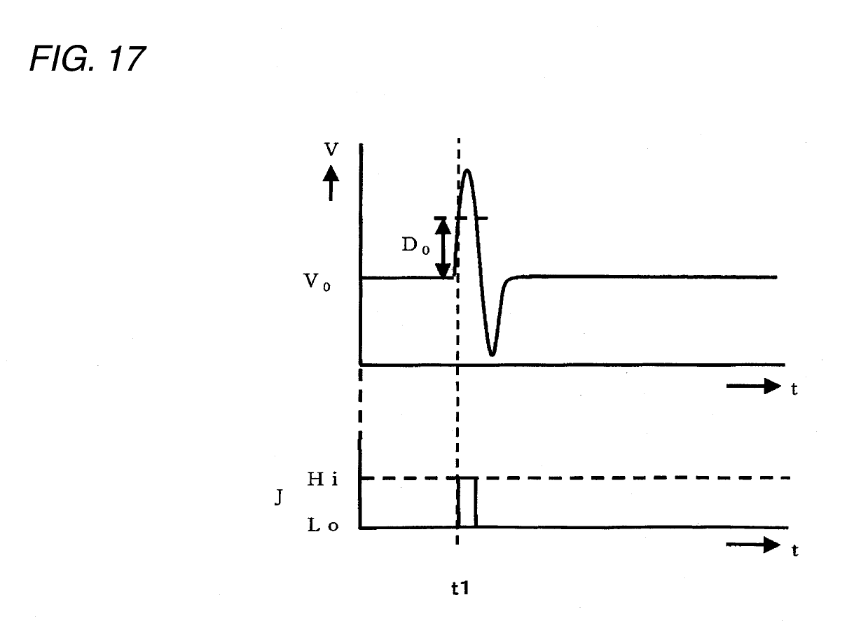

Referring to FIGS. 16 and 17, the operation and action of the intrusion detection device with the above constitution will be described below. FIG. 16A is a view showing a state where the intruder puts the hand 1017 on the upper part of the wall-like structure 1011 to hold up the body when the intruder intrudes by getting over the wall-like structure 1011, and FIG. 16B is a state where a bedding 1018 is hung on the wall-like structure 1011 in hanging the bedding. FIG. 17 is a characteristic chart showing an output signal V of the filter part 1154 and an output signal J of the comparator part 1155, varying over time, when the intruder intrudes.

First of all, if the intruder puts the hand 1017 on the upper part of the wall-like structure 1011, a pressure due to the fingers of the hand 1017 is applied to the piezoelectric sensor 1014 and the support means 1016, as shown in FIG. 16A. Since the support means 1016 has greater flexibility than the piezoelectric sensor 1014, the support means 1016 is compressed by the pressure due to the contact with the fingers, so that the piezoelectric sensor 1014 is also deformed easily, as shown in FIG. 16A. And a signal according to an acceleration of deformation of the piezoelectric sensor 1014 due to the piezoelectric effect is outputted from the piezoelectric sensor 1014.

An output signal of the piezoelectric sensor 1014 in a frequency band from 3 to 8 Hz at the time of contact with the hand 1017 is passed through the filter part 1154, but a signal in the other frequency band is removed. FIG. 17 shows an output voltage V of the filter part 1154. At the time of contact with the hand 1017, a signal component larger than the reference potential V₀ appears in V. In this case, with a structure in which the piezoelectric sensor 1014 is simply disposed on the wall-like structure 1011, the deformation of the piezoelectric sensor 1014 at the time of contact with the hand 1017 is small. However, in this embodiment, the support means 1016 is composed of the elastic body having more flexibility than the piezoelectric sensor 1014, as shown in FIG. 13B, and the support means 1016 is easily compressed at the time of contact, so that the amount of deformation of the piezoelectric sensor 1014 is increased. In this manner, the piezoelectric sensor 1014 has a larger amount of deformation. The acceleration that is the second order differential value of the amount of deformation is increased, so that the output signal of the piezoelectric sensor 1014 is also increased. The comparator part 1155 determines that a part of the body contacts the piezoelectric sensor if the amplitude |V-V₀| of V from V₀ is greater than D₀, and outputs a pulse signal L₀→Hi→L₀ as a determination output at time t1.

If the comparator part 1155 outputs a pulse signal of intrusion determination, an alarm sound is generated for a certain time from the alarm generation means 152 to threaten the intruder. At the same time, the notifying means 1153 notifies an indoor warning terminal, an external telephone, a security company or the police that the intrusion of the intruder occurs.

As described above, with the intrusion detection device according to this embodiment, since the piezoelectric sensor as the pressure sensitive means is disposed along the lower position a certain length down from the upper end part of the wall-like structure on the domicile side, no unnecessary pressure is applied upon the motion of the animal or hanging the bedding, whereby there is no false detection as conventionally occurs. Also, since the piezoelectric sensor is disposed on the domicile side of the wall-like structure, it is not conspicuous from the outside, and has a great-looking layout. Further, the intruder does not notice that the piezoelectric sensor is installed, whereby the crime prevention effect is enhanced.

Since there is the groove portion, when the piezoelectric sensor is disposed on the wall-like structure, the piezoelectric sensor is easily installed owing to the groove portion in the work. Further, the piezoelectric sensor is protected against the natural conditions such as rain and wind or daylight by the groove, whereby the durability is improved.

Also, since the support means elastically supports the piezoelectric sensor, the piezoelectric sensor is likely to deform due to a pressure when the intruder puts the hand on the upper part of the wall-like structure in getting over the wall-like structure, and can output an output signal according to deformation rapidly, whereby the detection sensitivity is improved.

Also, since the pressure sensitive means comprises the flexible cable-like piezoelectric sensor, and the piezoelectric sensor outputs a voltage signal according to an acceleration of deformation due to the piezoelectric effect, the intrusion can be detected by detecting a deformation due to a pressure when the intruder puts the hand on the upper part of the wall-like structure. Further, the piezoelectric sensor is like the flexible cable and can be freely laid along the shape of various wall-like structures.

Also, the alarm generation means for generating the alarm based on an output signal of the detection means is provided, whereby it is possible to threaten and discourage the intruder from making the intrusion by raising the alarm.

Further, the communication means for communicating the output signal of the detection means to the external apparatus is provided, whereby it can be notified an indoor warning terminal, an external telephone, a security company or the police that the intrusion of the intruder occurs, to rapidly react to the occurrence of intrusion.

### EMBODIMENT 8

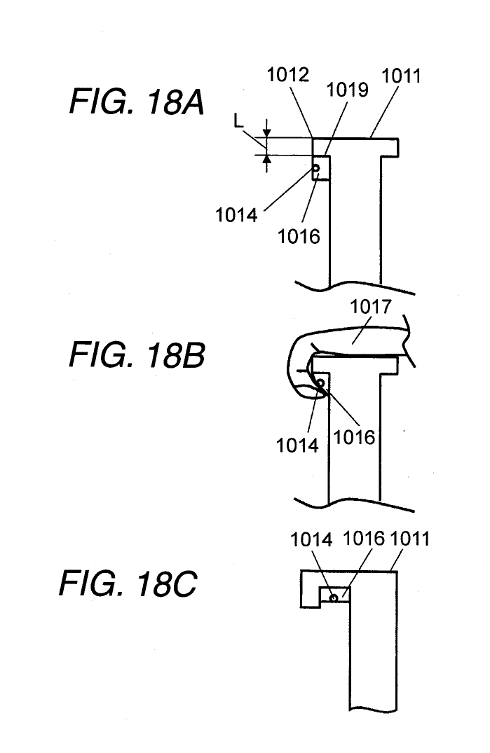

FIG. 18A is a cross-sectional view of an intrusion detection device according to an embodiment 8 of the invention, and FIG. 18B is a view showing a state where the intruder puts a hand 1017 on the upper part of the wall-like structure 1011 to hold up the body when the intruder intrudes by getting over the wall-like structure 1011. In FIG. 18A, the intrusion detection device of this embodiment is provided with a step part 1019 at a lower position a certain length L down from an upper end part 1012 of the wall-like structure 1011 on the domicile side. The piezoelectric sensor 1014 as the pressure sensitive means together with the support means 1016 is disposed on the step part 1019.

With the above constitution, since the intruder holds up the body in intruding by getting over the wall-like structure 1011, the intruder puts the hand 1017 on the upper part of the wall-like structure and holds up the body, as shown in FIG. 18B. However, if the step part 1019 is provided, the intruder necessarily tries to put the hand 1017 on the step part and apply a force, whereby it is prone that a pressure is applied to the piezoelectric sensor 1014 and the support means 1016 disposed on the step part 1019. Thereby, since the piezoelectric sensor 1014 is deformed more strongly than in the embodiment 7, a signal having a greater amplitude is outputted due to the piezoelectric effect from the piezoelectric sensor 1014, whereby the intrusion detection performance is improved.

The support means 1016 having the piezoelectric sensor 1014 may be provided inside the handrail of the wall-like structure of inverse L-character type, as shown in FIG. 18C.

### EMBODIMENT 9

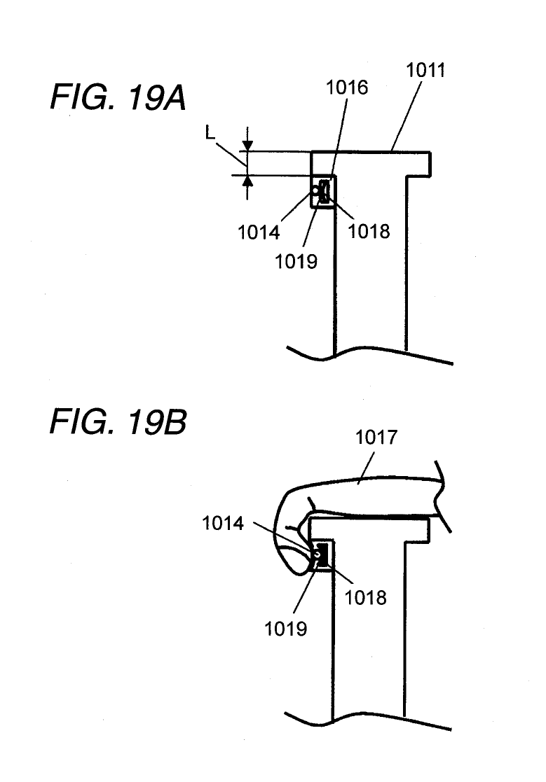

FIG. 19A is a cross-sectional view of an intrusion detection device according to an embodiment 9 of the invention, and FIG. 19B is a view showing a state where the intruder puts a hand 1017 on the upper part of the wall-like structure 1011 to hold up the body when the intruder intrudes by getting over the wall-like structure 1011. In FIG. 19A, the intrusion detection device of this embodiment is provided with a non-linear flexure part 1018 having an elastic characteristic of being flexed non-linearly if a load of a predetermined weight or more is applied to the piezoelectric sensor 1014 as the pressure sensitive means. The non-linear flexure part 1018 is disposed inside a hollow part 1019 formed in the support means 1016. The non-linear flexure part 1018 is composed of a thin elastic body molded like a strap and having a convex portion. For example, the elastic body for use with Convex Measure commercially available may be employed, because this elastic body is simple and highly practical.

With the above constitution, if the fingers of the hand 1017 contact the piezoelectric sensor 1014, a pressure is applied, and a load of a predetermined weight or more is applied, the non-linear flexure part 1018 is deformed suddenly like a concave to the residence side, and the piezoelectric sensor 1014 is greatly deformed, so that a large output signal appears from the piezoelectric sensor 1014 due to the piezoelectric effect, making it possible to detect the intrusion reliably.

On the other hand, even if a pressure is applied to the piezoelectric sensor 1014 upon the motion of the animal or hanging the bedding, the non-linear flexure part 1018 is not flexed unless a load of a predetermined weight or more is applied thereon, so that the piezoelectric sensor 1014 is not also deformed, whereby there is no false detection.

While in the embodiments 7 to 9 the piezoelectric sensor 14 is partly exposed to the outside, an insertion hole of the piezoelectric sensor 1014 may be provided in the support means 1018, and the piezoelectric sensor 1014 may be contained in the insertion hole and supported by the support means.

### EMBODIMENT 10

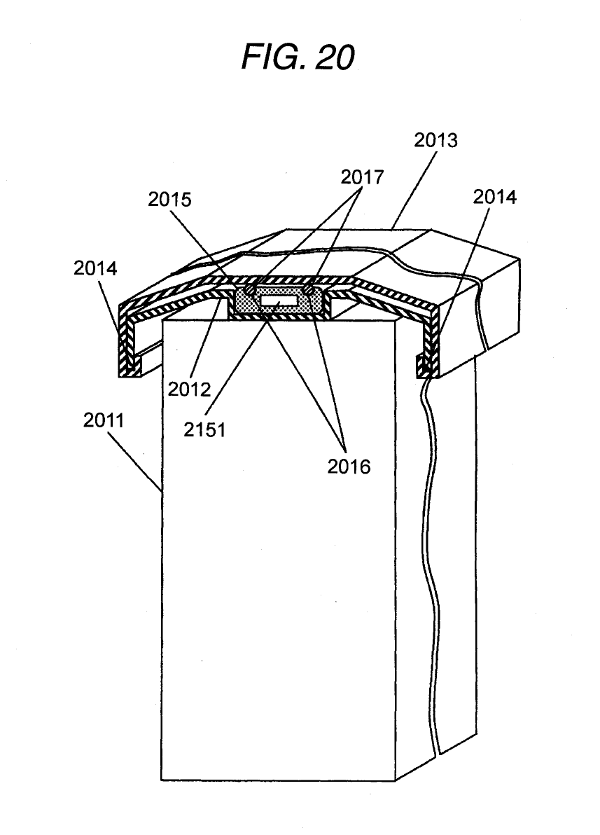

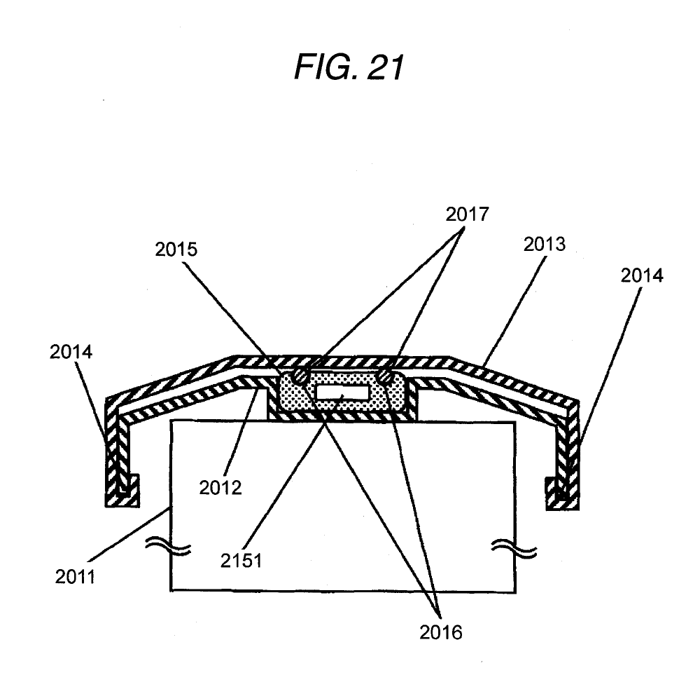

FIG. 20 is a perspective view of a wall-like structure having installed an intrusion detection device according to an embodiment 10 of the invention. FIG. 21 is a cross-sectional view of the intrusion detection device according to the embodiment 10 of the invention.

In FIGS. 20 and 21, a base 2012 is fixed on the upper face of the wall-like structure 2011 such as a wall, a balcony or a veranda fence for the domicile, and a top beam 2013 that is a cover member of substantial inverse U-character shape is engaged at both ends 2014 of the base 2012, and covers an upper face of the wall-like structure 2011. An elastic body 2015 is carried on the lower part of the top beam 2013, a fixing part 2016 like a U-character groove is formed on an upper face of the elastic body 2015, and a flexible cable-like piezoelectric sensor 2017 as the pressure sensitive means is disposed between the elastic body 2015 and the top beam 2013 in the form of being fitted into the fixing part 2016. This cover member may be composed of a member flexed when the intruder puts the hand or foot on the handrail in intruding. With this constitution, the cover member itself is subjected to pressure, flexed and moved to deform the pressure sensitive means. The elastic body uses a foam of synthetic resin such as EPDM or thermoplastic elastomer, of which the hardness and the expansion ratio are selected so that the compressibility (load value causing a unit displacement) may be smaller than the piezoelectric sensor 2017. A hollow part 2151 may be provided within the elastic body 2015 to increase the flexibility of the elastic body and enhance the detection sensitivity of the pressure sensitive means. The engagement between the base 2012 and the top beam 2013 is such that both ends of the top beam 2013 are formed like J-character, and the top beam 2013 is not removed simply, but vertically movable due to elasticity of the elastic body 2015, as shown in FIGS. 20 and 21. The vertical movement distance is formed to about 5 mm or less, preferably from 1 to 2 mm or less.

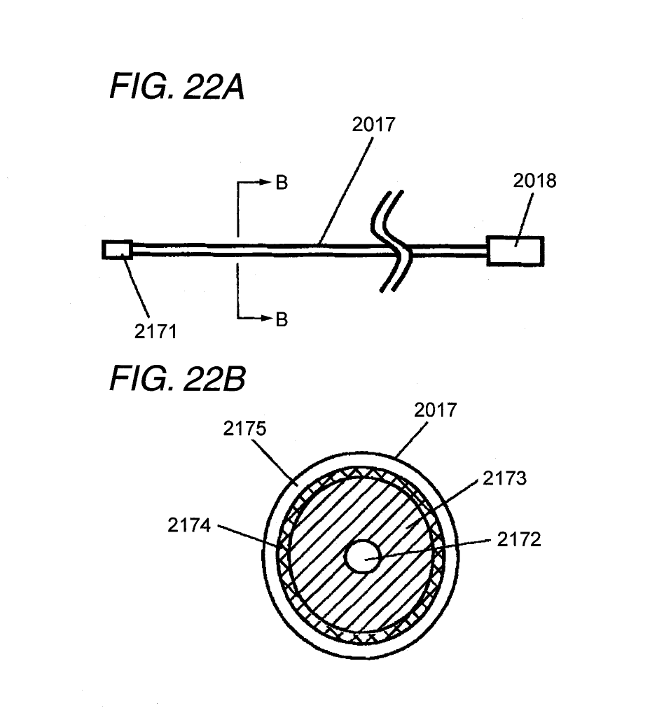

FIG. 22A is a constitutional view of the piezoelectric sensor 2017, and FIG. 22B is a cross-sectional view of the piezoelectric sensor, taken along the line B-B in FIG. 22A. In FIG. 22A, a control unit 1018 is provided at an end part of the piezoelectric sensor 1017. The piezoelectric sensor 2017 has a tip part 2171 where a resistor for detecting the electrode disconnection or short-circuit of electrode is built in. In FIG. 22B, the piezoelectric sensor 2017 comprises a center electrode 2172 made of conductor, a piezoelectric layer 2173, a ground electrode 2174 made of conductor, and a covering layer 2175 made of an elastic body. The piezoelectric layer 2173 may be resin-based piezoelectric polymer, such as polyvinylidene fluoride. However, it is not preferred to employ piezoelectric polymer because the heat resistant temperature is about 80° C. at the upper limit, the intrusion detection device is primarily employed outdoors, and particularly in summer, the surface temperature of the wall-like structure 2011 sometimes reaches as high as near 100° C. due to the direct rays of the sun. The piezoelectric layer 2173 may be made of piezoelectric compound in which a powder of piezoelectric ceramics is mixed into a specific resin base material, because the high temperature durability of 100° C. or more is provided. Such piezoelectric compound is preferably employed.

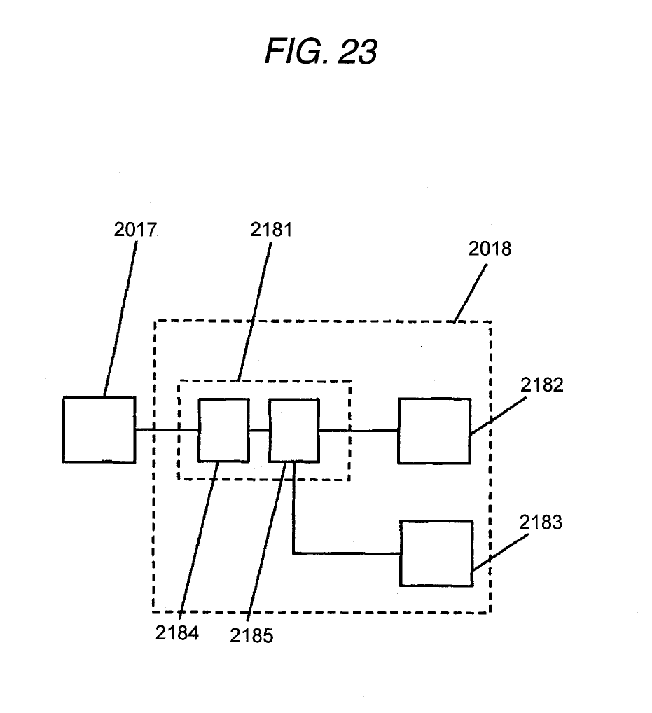

FIG. 23 is a block diagram of the intrusion detection device according to the embodiment 10 of the invention. In FIG. 23, the control unit 2018 comprises detection means 2181, alarm generation means 2182 and communication means 2183. The detection means 2181 comprises a filter part 2184 for filtering an output signal from the piezoelectric sensor 2017 with a predetermined filtering characteristic, and amplifying the signal at a predetermined amplification degree, and a comparator part 2185 for comparing the output signal of the filter part 2184 with a preset value to determine the intrusion. Under various conditions of vibration detected by the piezoelectric sensor 2017, the filtering characteristic is such that the vibration due to rainfall is 10 Hz or more, the vibration due to wind is 1 Hz or less, and the frequency due to a load in the intrusion motion of the intruder is 10 Hz or less, especially in a range from 3 to 8 Hz. The filter part 2184 may be a band pass filter for passing the signal components of 3 to 8 Hz, for example, as the filtering characteristic of the filter part 2184.

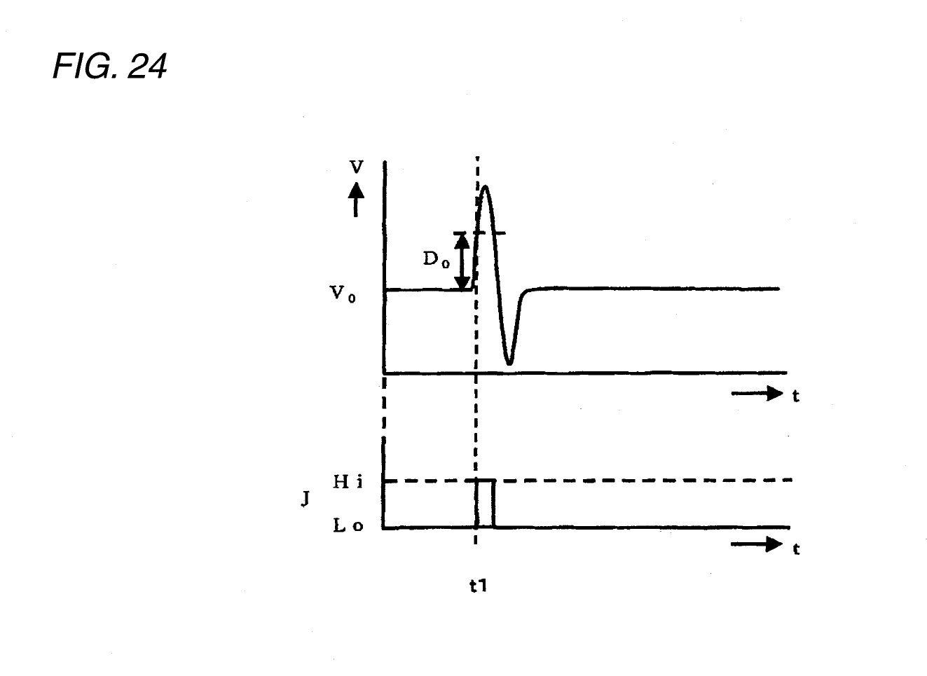

Referring to FIGS. 20, 21 and 24, the operation and action of the intrusion detection device with the above constitution will be described below. FIG. 24 is a characteristic chart showing an output signal V of the filter part 2184 and an output signal J of the comparator part 2185, varying over time, when the intruder intrudes.

First of all, the top beam 2013 is usually mounted on the upper face of the wall-like structure 2011, and has a great-looking layout in the design. And even if the intruder tries to confirm whether there is any device for crime prevention to intrude over the wall-like structure 2011, the device is hidden inside the top beam 2013 and not found at first glance. Next, if the intruder puts the hand on the upper part of the wall-like structure 2011 to hold up the body in intruding by getting over the wall-like structure 2011, a pressure due to the fingers of the hand is applied to the top beam 2013, so that the top beam 2013 is slightly flexed and pressed downward, applying a load on the elastic body 2015 and the piezoelectric sensor 1017. Since the piezoelectric sensor 2017 is easily deformed by this load, a signal according to an acceleration of deformation of the piezoelectric sensor 2017 due to the piezoelectric effect is outputted from the piezoelectric sensor 2017.

An output signal of the piezoelectric sensor 2017 in a frequency band from 3 to 8 Hz at the time of contact with the hand 2017 is passed through the filter part 2184, but a signal in the other frequency band is removed. FIG. 24 shows an output voltage V of the filter part 2184. At the time of contact with the hand, a signal component larger than the reference potential V₀ appears in V. In this case, with a constitution in which the piezoelectric sensor 2017 is disposed on the wall-like structure 2011, the deformation of the piezoelectric sensor 2017 at the time of contact with the hand 2017 is small. However, in this embodiment, the elastic body 2015 supporting the top beam 2013 has more flexibility than the piezoelectric sensor 2017, as shown in FIGS. 20 and 21, whereby the elastic body 2015 is easily compressed at the time of contact, so that the amount of deformation of the piezoelectric sensor 2017 is increased. Further, since the top beam 2013 is movable downward, the amount of deformation of the piezoelectric sensor 2017 is increased, whereby the amount of deformation of the piezoelectric sensor 2017 is larger even with a movement distance of 1 to 2 mm which is hardly sensed by the intruder. In this manner, the piezoelectric sensor 2017 has a larger amount of deformation. The acceleration that is the second order differential value of the amount of deformation is increased, so that the output signal of the piezoelectric sensor 2017 is also increased. The comparator part 2185 determines that a part of the body contacts the piezoelectric sensor if the amplitude |V-V₀| of V from V₀ is greater than D₀, and outputs a pulse signal L₀→Hi→L₀ as a determination output at time t1.

If the comparator part 2185 outputs a pulse signal of intrusion determination, an alarm sound is generated for a certain time from the alarm generation means 2182 to threaten the intruder. At the same time, the notifying means 2183 notifies an indoor warning terminal, an external telephone, a security company or the police that the intrusion of the intruder occurs.

As described above, with the intrusion detection device according to this embodiment, since the piezoelectric sensor as the pressure sensitive means is disposed inside the top beam provided on the wall-like structure, the pressure sensitive means has a great-looking layout, and the intruder does not notice that the intrusion detection device is installed, making it possible to prevent the intrusion through a dead zone of the device, whereby the crime prevention effect is enhanced and the intrusion detection performance is improved.

Though the intruder puts the hand on the top beam on the upper part of the wall-like structure to hold up the body in intruding by getting over the wall-like structure, if the intruder tries to intrude by applying a load on the top beam, the top beam is not only flexed but also vertically moved, increasing the deformation applied on the pressure sensitive means, because the pressure sensitive means is elastically supported inside the top beam that is vertically movable, whereby the detection sensitivity is increased and the intrusion detection performance is improved.

Since the fixing part 2016 like the U-character groove is provided in the elastic body, when the piezoelectric sensor is disposed on the wall-like structure, the piezoelectric sensor is easily installed in the work. The fixing part may be a hole (not shown) provided in the elastic body, through which the cable-like piezoelectric sensor can be passed, but it is desirable that a groove for fitting the pressure sensitive means is formed on the surface of the elastic body 2015, and the piezoelectric sensor 2017 is disposed in the groove. Because of the long piezoelectric sensor 2017, a way of incorporating the piezoelectric sensor into the elastic body is problematical, but a fixing method of this embodiment facilitates the work. And if the groove is not provided on the surface of the elastic body to fix the piezoelectric sensor, the adhesive or fixing member is required, but possibly degrades the flexibility of the pressure sensitive means, and should not be employed, if possible. Hence, in the work, the piezoelectric sensor can be disposed without impairing the flexibility of the pressure sensitive means, whereby the detection sensitivity is effectively enhanced by detecting the deformation sensitively. Further, the piezoelectric sensor 2017 is protected against the natural conditions such as rain and wind or daylight by the groove, whereby the durability is improved. Though the U-character groove is provided in this embodiment, the groove may have any of the shapes as far as the groove is in the form in which the upper face or side face is opened, and the long cable-like piezoelectric sensor can be easily fitted, positioned and fixed.

Particularly in this embodiment, the depth of the groove provided in the elastic body is shallower than the outer diameter of the piezoelectric sensor to directly contact with the top beam on the upper face. With this constitution, the vibration caused by the top beam can be detected more precisely.

Also, since the pressure sensitive means comprises the flexible cable-like piezoelectric sensor, and the piezoelectric sensor outputs a voltage signal according to an acceleration of deformation due to the piezoelectric effect, the intrusion can be detected by detecting a deformation due to a pressure when the intruder puts the hand on the upper part of the wall-like structure. Further, the piezoelectric sensor is like the flexible cable and can freely be disposed along the shape of various wall-like structures.

Also, since the alarm generation means for generating the alarm based on an output signal of the detection means is provided, the resident can be notified by generating the alarm. Also, if the alarm is given in the form of alarm sound, for example, the resident can be notified and the intruder threatened and discouraged from making the intrusion.

Further, since the communication means for communicating the output signal of the detection means to the external apparatus is provided, it can be notified an indoor warning terminal, an external telephone, a security company or the police that the intrusion of the intruder occurs, to rapidly react to the occurrence of intrusion.

### EMBODIMENT 11

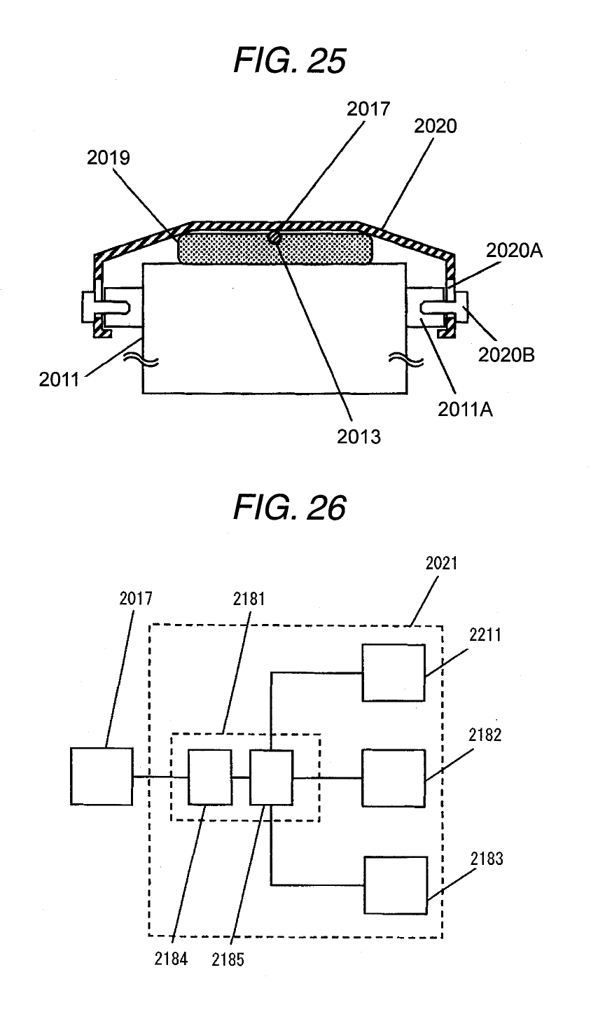

FIG. 25 is a cross-sectional constitutional view of an intrusion detection device according to an embodiment 11 of the invention, and FIG. 26 is a block diagram of the intrusion detection device according to the embodiment 11 of the invention. The same parts as for the intrusion detection device of the embodiment 10 are designated by the same reference numerals or signs, and not described here. In FIG. 25, a different point from the embodiment 10 is that an elastic body 2019 is provided directly on the upper face of the wall-like structure 2011, a top beam 2020 is provided to cover the upper face of the wall-like structure 2011, and the elastic body 2019 is carried between the wall-like structure 2011 and the top beam 2020. The fixing part 2016 like a groove is formed on the upper face of the elastic body 2019, and the flexible cable-like piezoelectric sensor 2017 as the pressure sensitive means is fitted into the fixing part 2016 and disposed between the elastic body 2019 and the top beam 2020. And the top beam 2020 is fixed to be vertically movable with the wall-like structure 2011, and fastened to an arm part 2011A protruding from the wall-like structure 2011 using a screw 2020B through a longitudinal hole 2020A provided in the top beam 2020 in FIG. 25.

Also, in FIG. 26, a control unit 2021 comprises locking reinforcement means 2211, in addition to detection means 2181, alarm generation means 2182, and communication means 2183, unlike the embodiment 10.

Referring to the drawings, the operation and action of the intrusion detection device with the above constitution will be described below. First of all, the top beam 2020 is usually mounted on the upper face of the wall-like structure 2011, and has a great-looking layout in the design. And even if the intruder tries to confirm whether or not there is any device for crime prevention device to intrude over the wall-like structure 2011, the device is hidden inside the top beam 2013 and not found at first glance. Next, if the intruder puts the hand on the upper part of the wall-like structure 2011 to hold up the body in intruding by getting over the wall-like structure 2011, the top beam 2020 is pressed downward by its load, applying a pressure on the piezoelectric sensor 2017 and the elastic body 2019. The elastic body 2019, which has more flexibility than the piezoelectric sensor 2017, is compressed, and the piezoelectric sensor 2017 is also easily deformed. And the deformation of the elastic body 2019 is stopped at a position where the load from the hand of the intruder and an elastic force of the elastic body 2019 are balanced, or a position where the top beam 2020 and the wall-like structure 2011 are contact. At this tine, a signal according to an acceleration of deformation of the piezoelectric sensor 2017 due to the piezoelectric effect is outputted from the piezoelectric sensor 2017, whereby the intrusion is determined.

If an output signal of the piezoelectric sensor 2017 is passed through the filter part 2184, and a pulse signal for intrusion determination is outputted from the comparator part 2185, an alarm sound is generated for a certain time from the alarm generation means 2182, and the notifying means 2183 notifies the intrusion of the intruder, whereby the locking reinforcement means 2211 reinforces the locking of the domicile to prevent further intrusion into the domicile. Particularly an already locked portion, for example, a balcony window is reinforced with the locking a plurality of keys in such a way that one of the keys which are provided at the normal time is manually locked, and the remaining keys are automatically locked to reinforce the locking with the plurality of keys, whereby the intruder has greater risk in making further intrusion into the domicile, because it takes more time, and is discouraged from making the intrusion.

As described above, the intrusion detection device according to the embodiment has a great-looking layout, because the pressure sensitive means is provided inside the top beam provided on the wall-like structure, and the intruder does not notice that the intrusion detection device is installed, whereby the crime prevention effect is enhanced by preventing the intrusion, and the intrusion detection performance is improved because there is no dead zone of the device.

Also, the locking reinforcement means for reinforcing the locking for the domicile based on an output signal of the detection means is provided to prevent further intrusion into the domicile. Particularly the already locked portion is further reinforced by automatically locking a plurality of keys, whereby the intruder is discouraged from making further intrusion into the domicile. Also, if the intrusion into one domicile is detected at one position, the locking for the overall domicile may be reinforced.

### EMBODIMENT 12

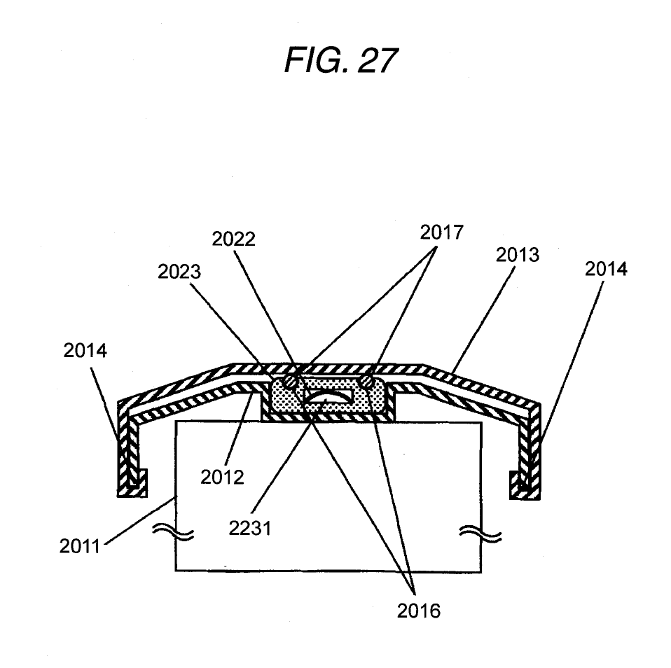

FIG. 27 is a cross-sectional view of an intrusion detection device according to an embodiment 12 of the invention. The same parts as for the intrusion detection device of the embodiments 10 and 11 are designated by the same reference numerals, and not described here. In FIG. 27, a different point from the embodiments 10 and 11 is that the piezoelectric sensor 2017 is provided in an elastic body 2023 comprising a non-linear flexure part 2022 having an elastic characteristic of being flexed non-linearly if a load of a predetermined weight or more is applied. The non-linear flexure part 2022 is disposed inside a hollow part 2231 formed in the elastic body 2023. The non-linear flexure part 2022 is composed of a thin elastic body formed like a strap and having a convex portion. For example, the elastic body for use with Convex Measure commercially available may be employed, because this elastic body is simple and highly practical.

With the above constitution, a pressure due to a load of the intruder is applied to the elastic body 2023, and if a load of a predetermined weight or more is applied, the non-linear flexure part 2022 is deformed suddenly like a concave to the side of the top beam 2013, and the piezoelectric sensor 2017 is also greatly deformed, so that a large output signal appears from the piezoelectric sensor 2017 due to the piezoelectric effect, whereby the intrusion can be detected reliably. On the other hand, even if a pressure is applied to the piezoelectric sensor 2017 upon the motion of the animal or the daily life action of the resident such as hanging the bedding, the non-linear flexure part 2022 is not flexed unless a load of a predetermined weight or more is applied thereon, so that the deformation of the piezoelectric sensor 2017 is small, and the output is minute, whereby it is possible to prevent the false detection based on the magnitude of the output signal.

Also, the piezoelectric sensor 2017 is provided in the fixing part directly above the hollow part 2231, whereby the detection can be made according to the elastic characteristic of the non-linear flexure part 2022.

While in the above embodiments the piezoelectric sensor 2017 is disposed in single track or double track, the number of cable-like piezoelectric sensors is not limited thereto. Also, the top beam itself may be decorated according to the resident's preference, whereby the design is improved although the weight of the top beam must not impair the flexibility of the elastic body and the piezoelectric sensor itself.

### EMBODIMENT 13

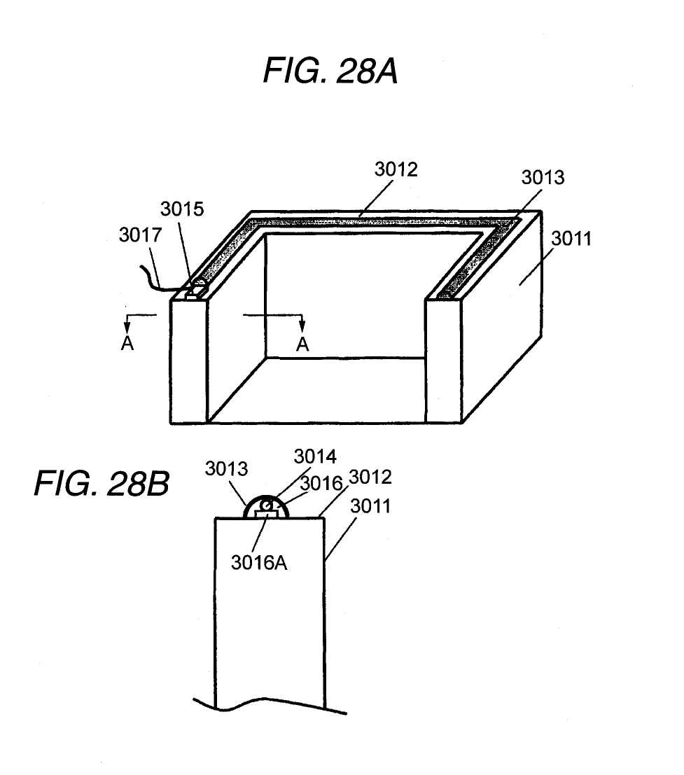

FIG. 28A is a constitutional view of a wall-like structure having installed an intrusion detection device according to a thirteenth embodiment of the invention, and FIG. 28B is a cross-sectional view of the wall-like structure, taken along the A-A line in FIG. 28A. In FIG. 28A, reference numeral 3011 denotes the wall-like structure such as a fence of veranda or balcony, a wall or a fence surrounding the premises for the domicile, and reference numeral 3012 denotes an upper end part of the wall-like structure 3011. Reference numeral 3013 denotes a packet composed of a lamina (hereinafter referred to as a laminate film) in which metal and synthetic resin are stacked by lamination. The packet 3013 is mounted in a sealed state on the upper end part 3012. As shown in FIG. 28B, reference numeral 3014 denotes a piezoelectric sensor (pressure sensitive means) that is stored inside the packet 3013. The piezoelectric sensor 3014 is like the flexible cable as the pressure sensitive means. Also, reference numeral 3016 denotes support means, in which the piezoelectric sensor 3014 is supported by the support means 3016 made of an elastic body softer than the piezoelectric sensor 3014. The piezoelectric sensor 3014 is provided with a slit in a part of the support means 3016, and fitted through the slit into the support means 3016 for supporting it. The elastic body uses a foam of synthetic resin such as EPDM or thermoplastic elastomer, of which the hardness and the expansion ratio are selected so that the compressibility (load value causing a unit displacement) may be smaller than the piezoelectric sensor 3014. A hollow part 3016A that is the non-linear flexure part is provided in the support means 3016, adjacent to the piezoelectric sensor 3014, so that the piezoelectric sensor 3014 is more likely to deform. As shown in FIG. 28A, reference numeral 3015 denotes a control unit, which is disposed at an end part of the piezoelectric sensor 3014. Also, reference numeral 3017 denotes a communication cable, through which a signal from communication means, not shown, within the control unit 3015 is conveyed to the outside.

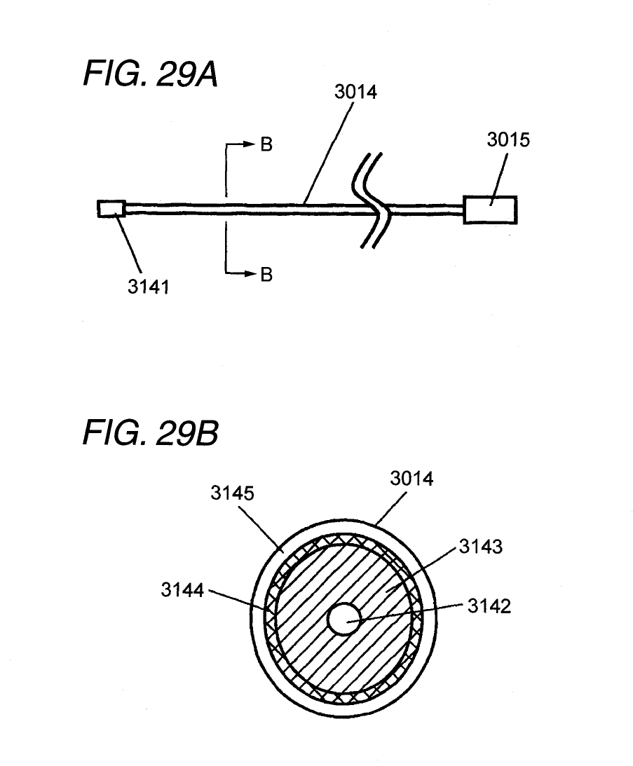

FIG. 29A is a constitutional view of the piezoelectric sensor 3014 and the control unit 3015, and FIG. 29B is a cross-sectional view of the piezoelectric sensor, taken along the line B-B in FIG. 29A. In FIG. 29A, the piezoelectric sensor 3014 has a tip part 3141 where a resistor for detecting the disconnection or short-circuit of electrode is built in. In FIG. 29B, the piezoelectric sensor 3014 comprises a center electrode 3142 made of conductor, a piezoelectric layer 3143, a ground electrode 3144 made of conductor, and a covering layer 3145 made of an elastic body. The piezoelectric layer 3143 may be resin-based piezoelectric polymer, such as polyvinylidene fluoride. However, it is not preferred to employ piezoelectric polymer because the heat resistant temperature is about 80° C. at the upper limit, the intrusion detection device is primarily employed outdoors, and particularly in summer, the surface temperature of the wall-like structure 3011 sometimes reaches as high as near 100° C. due to the direct rays of the sun. The piezoelectric layer 3143 may be made of piezoelectric compound in which a powder of piezoelectric ceramics is mixed into a specific resin base material, because the high temperature durability of 100° C. or more is provided. Such piezoelectric compound is preferably employed.

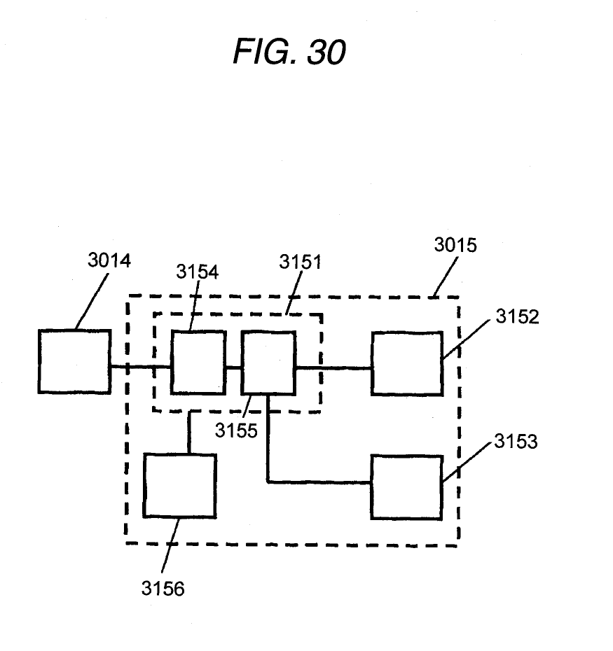

FIG. 30 is a block diagram of the intrusion detection device according to the thirteenth embodiment of the invention. In FIG. 30, the control unit 3015 comprises detection means 3151, threatening means 3152 and communication means 3153. The detection means 3151 comprises a filter part 3154 for filtering an output signal from the piezoelectric sensor 3014 with a predetermined filtering characteristic, and amplifying the signal at a predetermined amplification degree, and a comparator part 3155 for comparing the output signal of the filter part 3154 with a preset value to determine the intrusion. The filtering characteristic of the filter part 3154 is such that the frequency at the time of contact of a hand 3017 is 10 Hz or less, especially in a range from 3 to 8 Hz, the vibration due to rainfall is 10 Hz or more, and the vibration due to wind is 1 Hz or less. Therefore, the filter part may be a band pass filter for passing the signal components of 3 to 8 Hz, for example, as the filtering characteristic. Reference numeral 3156 denotes detection level adjustment means for adjusting the detection level.

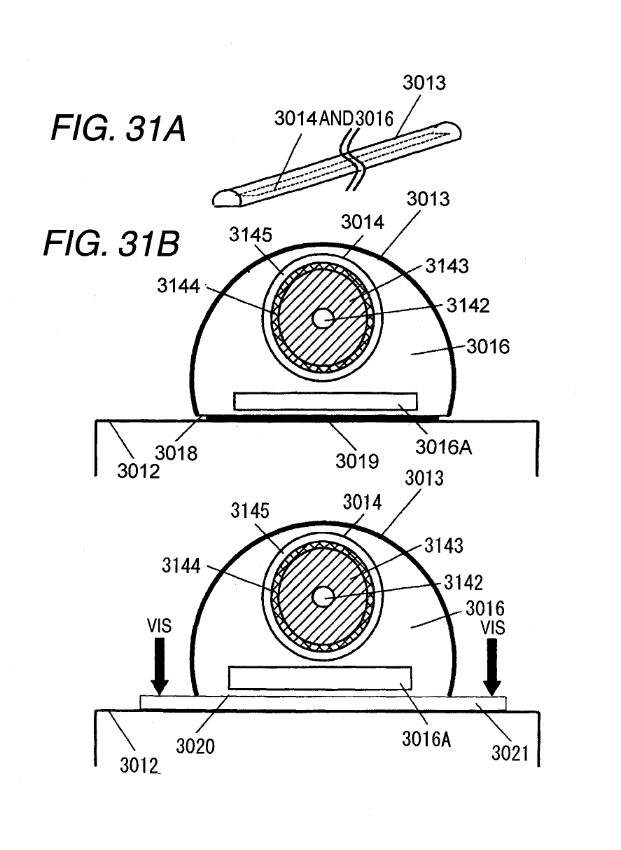

FIG. 31A is an image view of the packet of the intrusion detection device according to the thirteenth embodiment of the invention, FIG. 31B is one example of the cross-sectional view of FIG. 31A, and FIG. 31C is another example of the cross-sectional view of FIG. 31A. In FIG. 31A, reference numeral 3013 denotes the packet, which internally stores the piezoelectric sensor 3014 and the support means 3016. Also, the packet 3013 is sealed. That is, the pressure sensitive means contained in the packet is deformed to output a signal as the packet is subjected to pressure and varied in the shape. In FIG. 31B, the piezoelectric sensor 3014 and the support means 3016 are stored inside the packet 3013, in which a ground face of the packet 3013 with the outside is a plane part as indicated at 3018. The hollow part 3016A that is the non-linear flexure part is provided in the support means 3016, adjacent to the piezoelectric sensor 3014, so that the piezoelectric sensor 3014 is more likely to deform. Reference numeral 3019 denotes fixing means such as an adhesive or a tape with adhesive to fix on the upper end part 3012 of the wall-like structure 3011. Also, in FIG. 31C, the piezoelectric sensor 3014 and the support means 3016 are stored inside the packet 3013, in which the ground face of the packet 3013 with the outside is a plane part as indicated at 3020. The hollow part 3016A that is the non-linear flexure part is provided in the support means 3016, adjacent to the piezoelectric sensor 3014, so that the piezoelectric sensor 3014 is more likely to deform. Reference numeral 3021 denotes fixing means such as a vis to fix on the upper end part 3012 of the wall-like structure 3011. In the following explanation, the constitution of FIG. 31B is adopted.

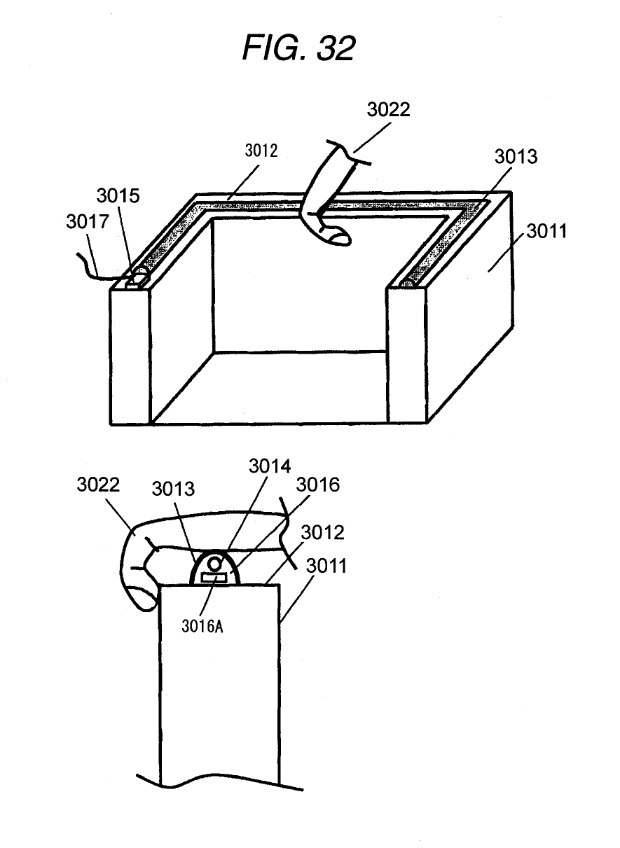

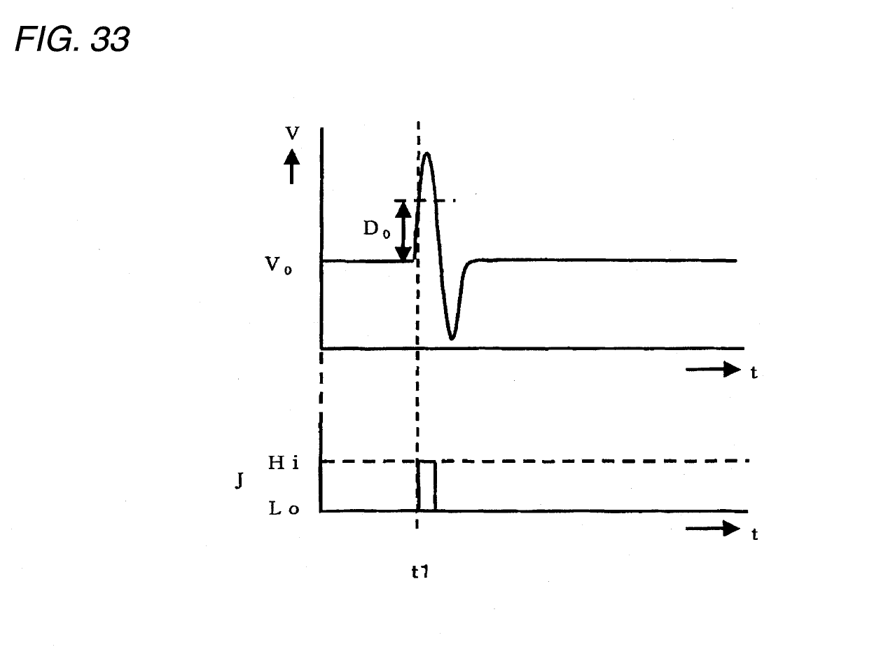

Referring to FIGS. 32 and 33, the operation and action of the intrusion detection device with the above constitution will be described below. FIG. 32A is a view showing a state where the intruder puts a hand 3022 on the upper part of the wall-like structure 3011 to hold up the body when the intruder intrudes by getting over the wall-like structure 3011, and FIG. 32B is a cross-sectional view of FIG. 32A. FIG. 33 is a characteristic chart showing an output signal V of the filter part 3154 and an output signal J of the comparator part 3155, varying over time, when the intruder intrudes.

First of all, if the intruder puts the hand 3017 on the upper part of the wall-like structure 3011, a pressure due to the fingers of the hand 3017 is applied to the piezoelectric sensor 3014 and the support means 3016, as shown in FIG. 32A. Since the support means 3016 has greater flexibility than the piezoelectric sensor 3014, the support means 3016 is compressed by the pressure due to the contact with the fingers, so that the piezoelectric sensor 3014 is also deformed easily, as shown in FIG. 32A. And a signal according to an acceleration of deformation of the piezoelectric sensor 3014 due to the piezoelectric effect is outputted from the piezoelectric sensor 3014. That is, the pressure sensitive means contained in the packet is deformed to output a signal as the packet is subjected to pressure and varied in the shape.

An output signal of the piezoelectric sensor 3014 in a frequency band from 3 to 8 Hz at the time of contact with the hand 3022 is passed through the filter part 3154, but a signal in the other frequency band is removed. FIG. 33 shows an output voltage V of the filter part 3154. At the time of contact with the hand 3022, a signal component larger than the reference potential V₀ appears in V. In this case, with the constitution in which the piezoelectric sensor 3014 is simply mounted on the wall-like structure 3011, the deformation of the piezoelectric sensor 3014 at the time of contact with the hand 3022 is small. However, in this embodiment, the support means 3016 is composed of the elastic body having more flexibility than the piezoelectric sensor 3014, and the support means 3016 is easily compressed at the time of contact, so that the amount of deformation of the piezoelectric sensor 3014 is increased. In this manner, the piezoelectric sensor 3014 has a larger amount of deformation. The acceleration that is the second order differential value of the amount of deformation is increased, so that the output signal of the piezoelectric sensor 3014 is also increased. The comparator part 3155 determines that a part of the body contacts the piezoelectric sensor if the amplitude |V-V₀| of V from V₀ is greater than D₀, and outputs a pulse signal L₀→Hi→L₀ as a determination output at time t1.

If the comparator part 3155 outputs a pulse signal of intrusion determination, an alarm sound is generated for a certain time from the threatening means 3152 to threaten the intruder. At the same time, the notifying means 3153 notifies an indoor warning terminal, an external telephone, a security company or the police that the intrusion of the intruder occurs.

Also, since the packet 3013 is composed of a lamina in which metal and synthetic resin are stacked by lamination and sealed, it can withstand against various water contents such as natural water contents of rain, snow and dew, washing, and water from the upper floor of the mansion, has a strong weather resistance against the sun light, and deteriorates slightly.

Also, the packet may be a laminate in which metal is stacked thereon, and the detection means, together with the pressure sensitive means, may be packed within the laminate, whereby there is a shield effect owing to the laminate and the external noise is prevented from being mixed.

Also, the packet 3013, of which the lower face is a planar part 3018, is fixed on the wall-like structure 3011 such as a fence by the fixing means 3019, and mounted stably and firmly. Also, the contact face with the upper end part 3012 of the wall-like structure is the plane as indicated at 3018 and 3020 to conform to the shape of the upper end part 3012, in which the support means 3016 composed of a soft elastic body is deformed according to the shape of the upper end part 3012 and installed. That is, since the packet is deformed according to the shape of the opposed fixing face by the elastic support means 3016 in the work, it can be mounted on the upper face of the wall-like structure or fence of various shapes having the plane, curved surface and concavity and convexity. Also, because packet is strong in the waterproof and the light fastness, it can be also mounted on the upper end part 3012 of the wall-like structure 3011, and has a merit that it can be easily mounted. Though in the embodiment, the non-linear flexure part is the hollow part 3016A, the piezoelectric sensor that is the pressure sensitive means supported by the support means functions due to a pressing force caused by the getting-over action of the intruder but does not detect the signal of noise component produced by the small animal, wind, rain or snow, because the non-linear flexure part (hollow part) 3016A is the support means molded to be flex by a predetermined pressing force or more.

Hence, there is no false detection and the detection precision is improved. Also, since the detection level adjustment means 3156 for adjusting the detection level is provided, it is possible to adjust a minute difference in the detection level between various wall-like structures 3011 having different structures for mounting, and also to cope with a minute difference in the detection level due to a difference in the mounting manner under different site environments, whereby the workability is excellent and the application range is wide. Also, the detection level can be adjusted in accordance with a secular change or a preference of the customer.

As described above, in the intrusion detection device according to this embodiment, since the piezoelectric sensor as the pressure sensitive means is stored hermetically in the packet composed of the laminar in which metal and synthetic resin are stacked by lamination, it can withstand against various water contents such as natural water content of rain, snow and dew, washing, and water from the upper floor of the mansion, has a strong weather resistance against the sun light, and is hardly deteriorated.

Also, since the packet is deformed according to the shape of the opposed fixing face by the elastic support means 3016, it can be mounted on the upper face of the wall-like structure or fence of various shapes having the plane, curved surface and concavity and convexity in the work. Also, since the packet is fixed to the wall-like structure such as a fence by the fixing means, and mounted stably and firmly. Also, because the packet is strong in the waterproof and the light fastness, it can be mounted on the upper end part of the wall-like structure, and has a merit that it can be easily mounted.

Also, since the detection level adjustment means for adjusting the detection level is provided, it is possible to adjust a minute difference in the detection level between various wall-like structures having different structures on which the packet is mounted, and to cope with a minute difference in the detection level due to the mounting manner under different site environments, whereby the workability is excellent and the application range is wide. Also, the detection level can be adjusted in accordance with a secular change or a preference of the customer.

Also, since the support means elastically holds the pressure sensitive means, the piezoelectric sensor is more likely to deform due to a pressure when the intruder puts the hand on the upper part of the wall-like structure in getting over the wall-like structure, making it possible to output an output signal according to a deformation from the pressure sensitive means rapidly, whereby the detection precision is improved.

Also, since the pressure sensitive means comprises the flexible cable-like piezoelectric sensor, and the piezoelectric sensor outputs a voltage signal according to an acceleration of deformation due to the piezoelectric effect, the intrusion can be detected by detecting a deformation due to a pressure when the intruder puts the hand on the upper part of the wall-like structure. Further, the piezoelectric sensor is like the flexible cable and can be freely laid along the shape of various wall-like structures.

Also, since the non-linear flexure part is the support means molded to be flexed by a predetermined pressing force or more, the piezoelectric sensor that is the pressure sensitive means supported by the support means functions due to a pressing force caused by the getting-over action of the intruder but does not detect the signal of noise component produced by the small animal, wind, rain or snow. Hence, there is no false detection and the detection precision is improved.

Though in this embodiment the non-linear flexure part is the hollow part, another member may be incorporated or a part of the support means may be constituted of a member made of a material having different elastic characteristic.

Also, since the packet is a laminate in which metal is stacked, there is the shield effect due to lamination, and the external noise is prevented from being mixed.

Also, the threatening means is provided for generating the alarm based on an output signal of the detection means, whereby the intruder can be threatened and discouraged from making the intrusion.

Further, since the communication means for communicating the output signal of the detection means to the external apparatus is provided, it can be notified an indoor warning terminal, an external telephone, a security company or the police that the intrusion of the intruder occurs, to rapidly react to the occurrence of intrusion.

### EMBODIMENT 14

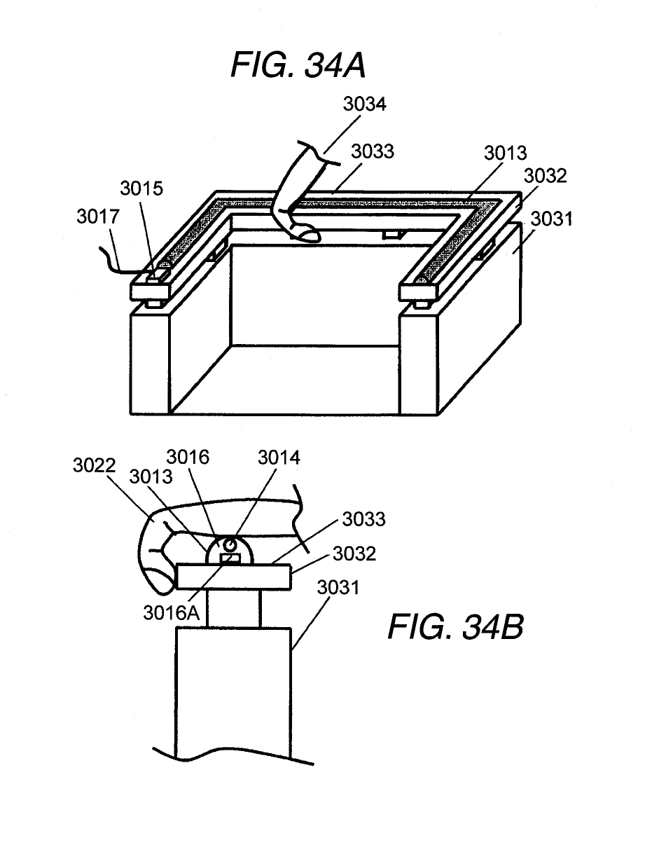

FIG. 34A is a constitutional view of a wall-like structure having installed an intrusion detection device according to a fourteenth embodiment of the invention, and FIG. 34B is a cross-sectional view of FIG. 34A. In FIG. 34A, reference numeral 3031 denotes the wall-like structure such as a fence of veranda or balcony, a wall or a fence surrounding the premises for the domicile, reference numeral 3032 denotes a handrail mounted on the upper face of the wall-like structure 3031, and reference numeral 3033 denotes an upper end part. The intrusion detection device of the invention can be mounted on the fence of veranda or balcony, wall or fence surrounding the premises for the domicile which is constituted of the wall-like structure 3031 and the handrail 3033 under the same operation of the thirteenth embodiment. The parts designated by the same numerals as in the first embodiment are identical.

Though in the embodiments 13 and 14, the control unit 3015 is installed outside the packet 3013, the control unit may be stored inside the packet 3013. Also, though the communication cable 3017 is employed for the communication with the outside, various wireless communications such as infrared ray or specific small power may be employed. The power source of the intrusion detection device may be a battery, or power may be supplied from the outside. In this case, the power supply may be superposed in the communication cable 3017. Also, the detection level adjustment means may be located outside the control unit, but not inside, to adjust the detection level through the communication cable. Also, it may be mounted not only on the upper end part of the wall-like structure but also in any place such as the lower face, side face or the inside of the handrail. Also, it may be mounted by dividing a specific part. For example, when it is mounted inside the handrail, the control unit is mounted on the outer surface of the handrail. Also, the plane part 3018 is not necessarily a complete plane for the packet 3013. Also, though the piezoelectric sensor 3014 is partially exposed to the outside, the support means may be provided with an insertion hole for the piezoelectric sensor 3014, in which the piezoelectric sensor 3014 is inserted and supported in the insertion hole. Also, a cavity part may be provided as support means 3018.

### EMBODIMENT 15

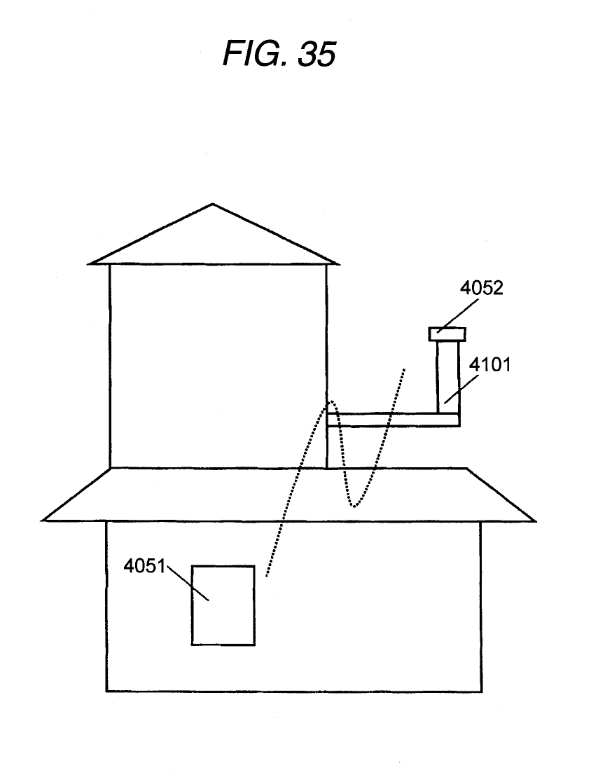

FIG. 35 is a system block diagram of a monitoring device according to a fifteenth embodiment of the invention.

In FIG. 35, the monitoring device is composed of a central processing unit 4051 and an intrusion detecting terminal unit 4052. Wireless communication means makes the communications between the central processing unit 4051 and the intrusion detecting terminal unit 4052.

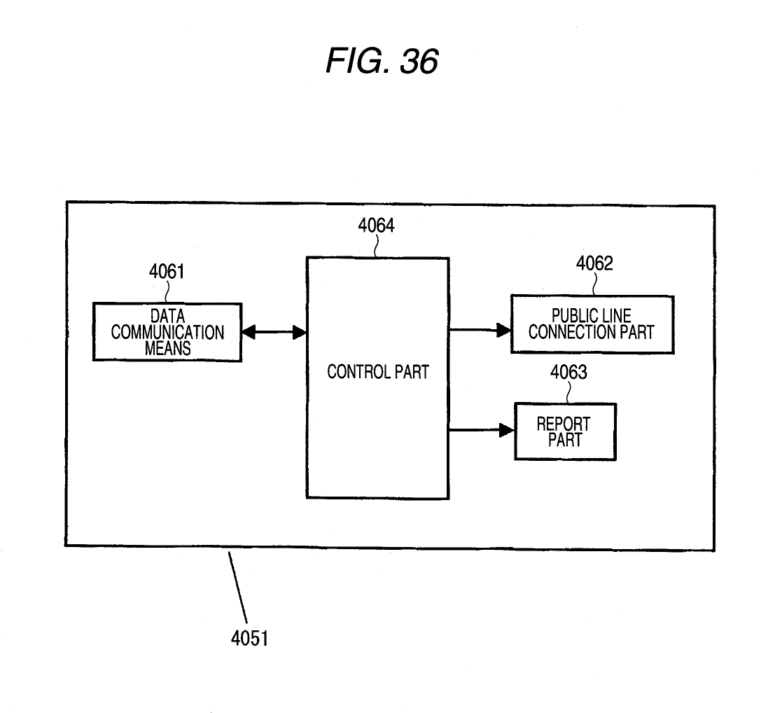

FIG. 36 is an internal block diagram of the central processing unit 4051. Reference numeral 4061 denotes data communication means for transmitting or receiving the information concerning the intrusion detection. Reference numeral 4062 denotes a public telephone line connection part that connects to an outside telephone upon receiving the information concerning the intrusion detection. Reference numeral 4063 denotes a report part that makes a report such as raising the alarm upon receiving the information concerning the intrusion detection. Reference numeral 4064 denotes a control part for controlling the data communication means 4061, the public telephone line connection part 4062 and the report part 4063. The central processing unit 4051 is installed inside the house, and upon receiving the information concerning the intrusion detection, notifies the user that the intrusion occurs by giving a report to the registered outside telephone or raising the alarm from the report part 4063. Also, the central processing unit may be integrated with a telephone set or a door phone.

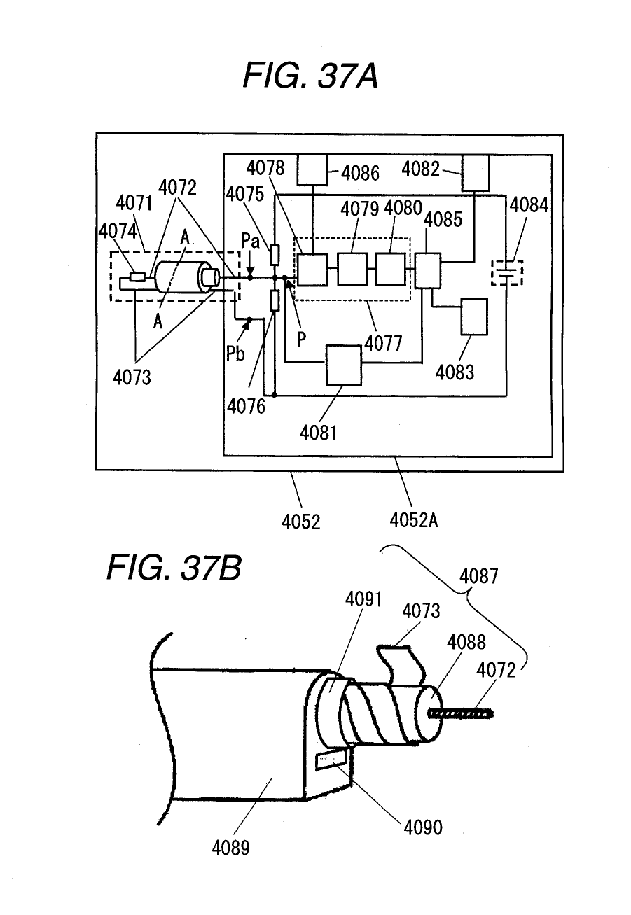

FIG. 37A is an internal block diagram of the intrusion detecting terminal unit 4052. In the embodiment 15, an instance where the intrusion detecting terminal unit 4052 is disposed on the handrail of veranda will be described below. Reference numeral 4071 denotes pressure sensitive means. The intrusion detecting terminal unit 4052 comprises a flexible cable-like piezoelectric sensor 4087 as the pressure sensitive means. Reference numeral 4072 denotes a center electrode. Reference numeral 4073 denotes a ground electrode. Reference numeral 4074 denotes a sensor side resistor provided as the resistor for detecting the disconnection between the center electrode 4072 and the ground electrode 4073. Reference numeral 4075 denotes a circuit side resistor for detecting the disconnection. Reference numeral 4076 denotes a signal deriving resistor for deriving the signal from the piezoelectric sensor 4087. Reference numeral 4077 denotes detection means. Reference numeral 4078 denotes an amplifier for amplifying the output signal from the piezoelectric sensor 4087. Reference numeral 4079 denotes a filter part for passing only the predetermined frequency component from the amplified output signal. The filtering characteristic of the filter part 4079 is such that the frequency at the time of contact with the person's hand is 10 Hz or less, especially in a range from 3 to 8 Hz, the vibration due to rainfall is 10 Hz or more, and the vibration due to wind is 1 Hz or less. Therefore, the filter part may be a band pass filter for passing the signal components of 3 to 8 Hz, for example, as the filtering characteristic. Reference numeral 4080 denotes a comparator part for comparing the output signal with the preset value to determine the intrusion. The detecting means 4077 comprises the amplifier 4078, the filter part 4079 and the comparator part 4080. Reference numeral 4081 denotes an abnormality determination part for determining the disconnection failure from the piezoelectric sensor 4087. Reference numeral 4082 denotes data communication means for transmitting or receiving the information concerning the intrusion detection to or from the central processing unit 4051. Reference numeral 4083 denotes report means for raising the alarm or turning on the light to threaten the intruder when the intrusion occurs. Reference numeral 4084 denotes a power supply part for supplying power from a built-in battery. Reference numeral 4085 denotes a terminal control part that transmits the information concerning the intrusion, together with the terminal unit code of its own, to the central processing unit 4051 by wireless using the data communication means 4082, if the pressure sensitive means 4071 detects the pressure. Also, if the abnormality determination part 4081 detects a disconnection failure, the report means 4083 makes a report. Reference numeral 4086 denotes sensitivity switching means for setting up the sensitivity by adjusting the gain of the amplifier 4078. Reference numeral 4052A denotes a shield part. The shield part 4052A shields a part of the intrusion detecting terminal unit 4052 except for the pressure sensitive means 4071. If the communication distance becomes shorter by shielding an antenna part of the communication means 4082, the antenna part may be placed outside the shield part 4052A. In FIG. 37B, the piezoelectric sensor 4087 is supported by the support means 4089 composed of an elastic body softer than the piezoelectric sensor 4087. The elastic body is selected in consideration of heat resistance and cold resistance for installation outdoors. Specifically, the elastic body in which the compliance is not degraded from −30° C. to 85° C. is preferably selected. Such a rubber may be ethylene propylene rubber (EPDM), chloroprene rubber (CR), butyl rubber (IIR), silicone rubber (Si), or thermoplastic elastomer. Also, the support means 4089 has a buffer part 4090 that is the non-linear flexure part formed hollow and compressible due to pressure. Further, a groove portion for fixing and supporting the piezoelectric sensor inside the handrail of veranda is formed on the bottom of the support means 4089. A method for fixing inside the handrail of veranda involves fitting inside the handrail of veranda or fixing with a tape, although any other methods may be taken as far as the piezoelectric sensor can be firmly fixed inside the handrail of veranda.

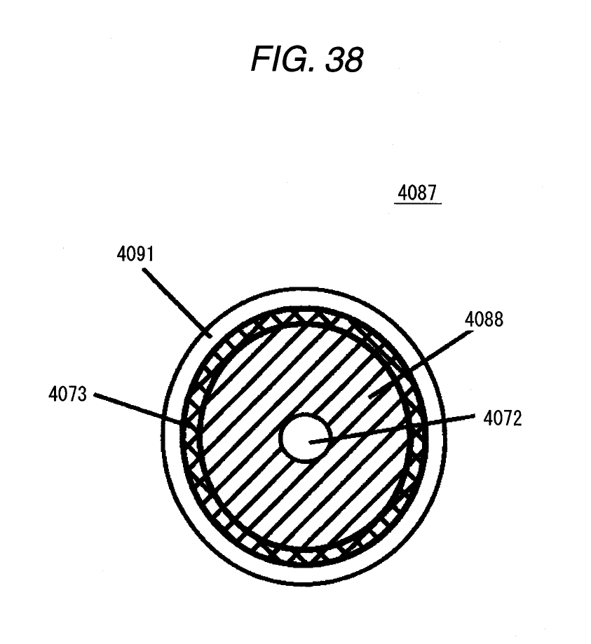

FIG. 38 is a cross-sectional view of the piezoelectric sensor 4087, taken along the line A-A in FIG. 37A. In FIG. 38, reference numeral 4072 denotes a center electrode, reference numeral 4088 denotes a piezoelectric layer, reference numeral 4073 denotes a ground electrode, and reference numeral 4091 denotes a covering layer.

Though the center electrode 4072 may be a normal metal solid conductor, an electrode in which the metal coil is wound around the insulating polymer fiber is employed here. The insulating polymer fiber and the metal coil are preferably polyester fiber commercially available in electric heating blankets and copper alloy containing 5 wt % of silver, respectively.

The piezoelectric layer 4088 is typically made of resin-based piezoelectric polymer such as polyvinylidene fluoride, but the high temperature durability is improved by using piezoelectric compound in which a powder of piezoelectric ceramics is mixed into polymer base material such as chlorinated polyethylene.

The ground electrode 4073 is composed of a strip electrode with a metal film boded on the polymer layer, which is wound around the piezoelectric layer 4088. And the ground electrode 4073 is preferably an electrode composed of an aluminum film bonded on the polymeric layer of polyethylene terephthalate (PET), because it has high thermal stability at 120° C. and is mass-produced commercially. To shield the piezoelectric sensor 4087 from the electric noise in the external environment, it is preferred that the ground electrode 4073 is wound around the piezoelectric layer 4088 to partially overlap.

The covering layer 4091 is made of polymer material having appropriate elasticity such as urethane, polyethylene or vinyl chloride.

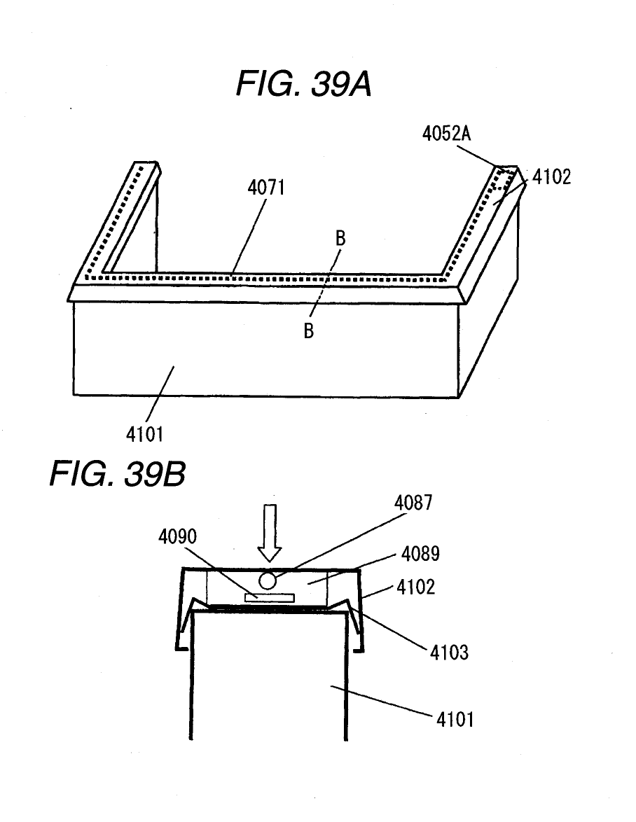

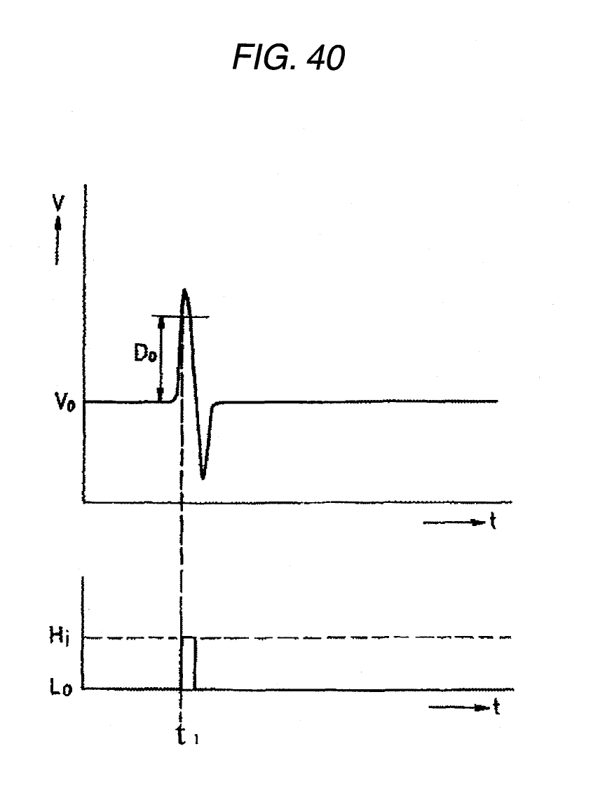

Referring to FIGS. 39 and 40, the operation and action of the monitoring device with the above constitution will be described below. FIG. 39A is a constitutional view where an intrusion detecting terminal unit 4052 is installed in the veranda (wall-like structure) 4101. A shield part 4052A and pressure sensitive means 4071 are installed inside the handrail of veranda. In this embodiment 15, the pressure sensitive means 4071 and the shield part 4052A are arranged in parallel. The reason why the parallel arrangement is made is that if the pressure sensitive means 4071 and the shield part 4052A are arranged in series, the intrusion may not be possibly detected when the intrusion occurs from above the shield part 4052A where the pressure sensitive means 4071 is not disposed. Even in the case where the shield part 4052A is sufficiently small and the pressure sensitive means 4071 and the shield part 4052A are arranged in series, the series arrangement can be taken if the intrusion from the shield part 4052A can be detected. FIG. 39B is a cross-sectional view where the intrusion detecting terminal unit 4052 is installed on the veranda (wall-like structure) 4101, taken along the line B-B in FIG. 39A. Reference numeral 4102 denotes a handrail (cover), in which a handrail (cover) auxiliary fixture 4103 is fixed to the veranda (wall-like structure) 4101 by a vis or the like, the support means 4089 containing the pressure sensitive means 4071 is installed thereon, and the handrail (cover) 4102 is fitted into the handrail (cover) auxiliary fixture 4103 and fixed to the veranda (wall-like structure) 4101. Also, the buffer part 4090 that is the non-linear flexure part is provided under the piezoelectric sensor 4087 within the support means 4089, because the piezoelectric sensor 4087 is more likely to deform when a pressure is applied in the arrow direction of FIG. 39B. If the buffer part 4090 is provided above the piezoelectric sensor 4087, the false detection can be prevented when a pressure is applied in the arrow direction by the small animal. When the small animal rests on the handrail of veranda, the pressing force is smaller than the intruder, whereby the buffer part 4090 absorbs the force if the pressing force is so small as the minute vibration, so that the piezoelectric sensor 4087 is not flexed. If there is a large pressing force that occurs when the intruder puts the hand or foot, the buffer part 4090 can not absorb the force fully, whereby the detection is allowed. In the embodiment 15, the buffer part 4090 is provided under the piezoelectric sensor 4087.

FIG. 40 is a characteristic chart showing an output signal V of the filter part 4079 and an output signal of the comparator part 4080, varying over time, when the intruder intrudes.

First of all, if the intruder tries to get over the veranda (wall-like structure) 4101 by putting the hand or foot on the veranda (wall-like structure) 4101, a pressure is applied through the handrail cover 4102 to the piezoelectric sensor 4087 and the support means 4089 in the arrow direction in FIG. 39B. Since the upper face of the support means 4089 is closely contacted with a lower face handrail (cover) auxiliary fixture 4103 and attached on the handrail cover 4102, and the support means 4089 has more flexibility than the piezoelectric sensor 4087, the support means 4089 is compressed due to pressure, and the piezoelectric sensor 4087 is also easily deformed. And a signal according to an acceleration of deformation of the piezoelectric sensor 4087 is outputted from the piezoelectric sensor 4087.

The amplifier 4078 amplifies an output signal of the piezoelectric sensor 4087, and the filter part 4079 passes the signal in a specific frequency band and removes the signal in the other frequency bands. An output signal V of the filter part 4079 is shown in FIG. 40. When a pressure is applied by the hand or foot, a larger signal component than the reference potential V0 appears in V. The piezoelectric sensor 4087 has a larger amount of deformation. The acceleration that is the second order differential value of the amount of deformation is increased, so that the output signal of the piezoelectric sensor 4087 is also increased. The comparator part 4080 determines that the intruder tries to get over the veranda (wall-like structure) 4101 if the amplitude |V-V₀| of V from V₀ is greater than D₀, and outputs a pulse signal L₀→Hi→L₀ as a determination output at time t1.

If the comparator part 4080 outputs a pulse signal of intrusion determination, an alarm is sounded for a certain time from the report means 4083 to threaten the intruder. At the same time, the data communication means 4082 transmits the information concerning the intrusion detection to the central processing unit 4051. If the central processing unit 4051 receives the information concerning the intrusion detection, the report means 4063 sounds the alarm, or calls the registered telephone number from a public line connection part 4062 to notify the user that the intrusion occurs.

Since the sensitivity switching means 4086 can set up the sensitivity by adjusting the gain of the amplifier 4078, the sensitivity can be adjusted by an external switch in accordance with the installation situation. A method for adjusting the gain involves adjusting the resistance value using the external switch, or arranging a plurality of resistors beforehand and carrying out wiring to select a predetermined resistor from the plurality of resistors by switching the external switch. With such method, if the circuit parts are made adjustable, the gain can be adjusted according to each installation place in the work after the intrusion detecting terminal units are uniformly produced, whereby there is the effect that the workability and installation ability are improved. Also, another method for switching the sensitivity involves adjusting the value of D0 as shown in FIG. 40 in the comparator part 4080. A method for adjusting the value of D0 involves changing the value of D0 by adjusting the resistance value, like the method for adjusting the gain.

Next, a procedure for disconnection determination in the abnormality determination part 4081 will be described below. In FIG. 37A, it is assumed that the resistance values of the sensor side resistor 4074, the circuit side resistor 4075 and the signal deriving resistor 4076 are R1, R2 and R3, the voltage at point P is Vp and the voltage of the power source part 4084 is Vs. R1, R2 and R3 usually have resistance values of several mega to several tens mega ohms. When the electrode of the piezoelectric sensor 4087 is normal, Vp is equal to a partial voltage of Vs at a ratio of the parallel resistance of R2 and R3 to R1. Herein, since the resistance value of the piezoelectric layer 4088 is usually several hundreds mega ohms or more, it hardly contributes to the parallel resistance value of R2 and R3, and is ignored in calculating the partial voltage value. If the electrode of the piezoelectric sensor 4087 is disconnected, the point Pa or Pb is equivalently opened, so that Vp becomes a partial voltage value of R2 to R3. If the electrode is short-circuited, the points Pa and Pb are equivalently short-circuited, so that Vp is equal to Vs. In this manner, the abnormality determination part 4081 detects a failure such as a disconnection or short-circuit of the electrode for the piezoelectric sensor 4087, based on the value of Vp, whereby the reliability is improved

As described above, in the embodiment 15, since the intrusion detecting terminal unit with the piezoelectric sensor is disposed inside the handrail of the veranda, it has a great-looking layout and the intruder does not notice that the monitoring device is installed, whereby the crime prevention effect is enhanced. Also, since the power supply unit is not required, the installation range is broadened.

Since the piezoelectric sensor is built into the support means, the handrail cover is simply put with the support means and the shield portion inside and easily installed. Also, if it is installed inside the handrail, the durability against the natural conditions such as wind and rain or sunshine is improved. If the shield portion is built into the support means, the installation ability and durability are further improved. Also, since the support means elastically holds the piezoelectric sensor, the piezoelectric sensor is more likely to deform due to a pressure where the intruder gets over the veranda (wall-like structure), and can output an output signal according to a deformation rapidly, whereby the detection sensitivity is improved. Further, the sensitivity can be adjusted in accordance with the installation situation by the sensitivity switching means. Also, since the pressure sensitive means has the flexible cable-like piezoelectric sensor, and the piezoelectric sensor outputs a voltage signal according to an acceleration of deformation due to the piezoelectric effect, the intrusion can be detected by rapidly detecting the deformation caused by the pressure when the intruder puts the hand or foot on the veranda (wall-like structure). Further, the piezoelectric sensor is like the flexible cable and can be freely laid along the shape of various verandas (wall-like structures).

Also, the report means for making a report to the outside based on an output signal of the detection means is provided, whereby the intruder is threatened and discouraged from making the intrusion because the alarm is raised.

Moreover, since the information concerning the intrusion detection is sent to the central processing unit when the intruder intrudes, it is notified an indoor warning terminal, an external telephone, a security company or the police that the intrusion of the intruder occurs, whereby it is possible to rapidly react to the occurrence of intrusion.

Though in the embodiment 15 the communication medium is wireless, any communication media such as infrared communications, or fiber optics communications may be also employed to achieve the same effect.

### EMBODIMENT 16

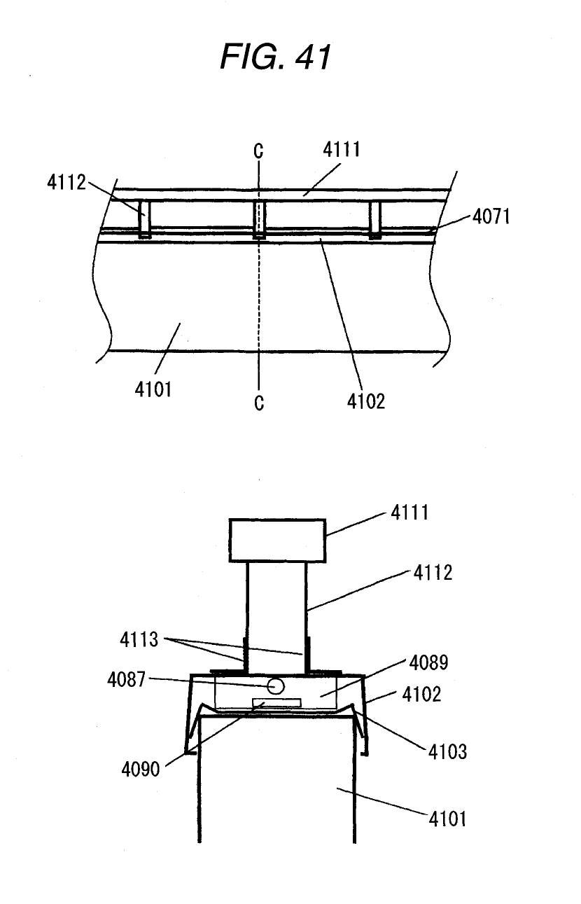

FIG. 41 is a constitutional view of a wall-like structure 4101 having installed a monitoring device according to an embodiment 16 of the invention. In FIG. 41A, pressure sensitive means 4071 is installed inside the handrail of the veranda. Reference numeral 4111 denotes a handrail A, which is fixed on the wall-like structure 4101 by support means 4112. Such handrail A4111 may be attached for decoration or to improve the handrail function. FIG. 41B is a cross-sectional view of FIG. 41A, taken along the line C-C. The support part 4112 and the handrail (cover) 4102 are fixed by a vibration propagation member 4113. The vibration propagation member 4113 is a metallic member having excellent transmissibility of vibration. Also, a cover for a fixing part of the support part 4112 and the handrail (cover) 4102 may be a metallic member having excellent transmissibility of vibration.

With the above constitution, when the intruder intrudes by getting over the handrail A 4111, a pressure is exerted on the handrail A 4111. The vibration due to the pressure is applied through the support part 4112 and the vibration propagation member 4113 to the piezoelectric sensor 4087 and the support means 4089. Thereby, even if the piezoelectric sensor 4087 is not built into the handrail A 4111, it is possible to detect that the intruder gets over the handrail A 4111, whereby the cost is reduced.

As described above, in the embodiment 16, even if the handrail of the veranda is not simply constituted of the handrail cover put on the wall-like structure, but mounted on the handrail cover, one sensor can detect the pressure on a handrail cover part and a handrail part thereon, whereby the cost is reduced. Further, it is not required that two sensors are built in, whereby the installation is simplified.

Also, the monitoring device of the invention is not limited to the above embodiment, but various changes may be made without departing from the spirit or scope of the invention.

### EMBODIMENT 17

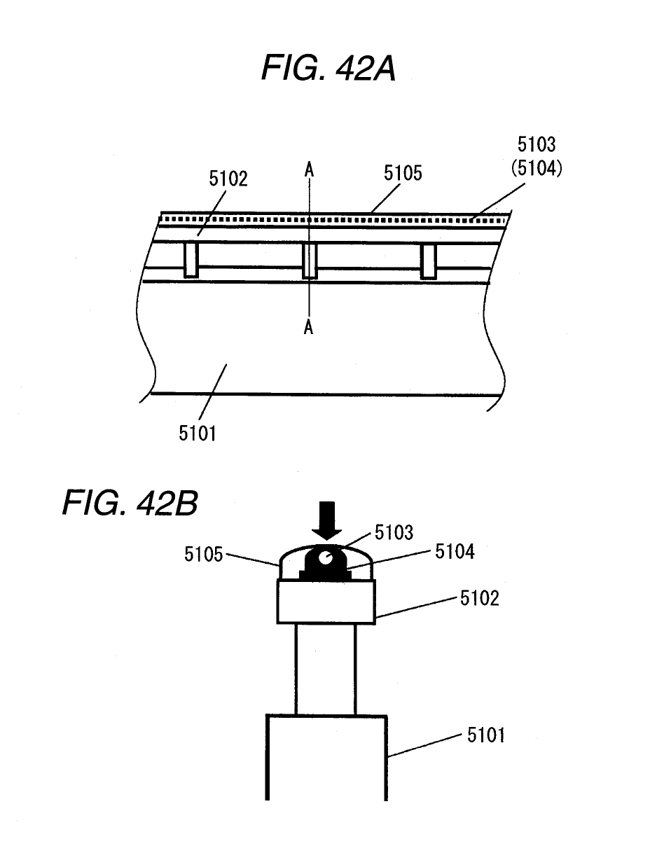

FIG. 42 is a constitutional view of a veranda (wall-like structure) 5101 having installed a monitoring device according to an embodiment 17 of the invention. In FIG. 42A, pressure sensitive means 5103 is supported by elastic support means 5104 composed of an elastic body softer than the pressure sensitive means 5103. The elastic body is selected in consideration of heat resistance and cold resistance for installation outdoors. Specifically, the elastic body in which the compliance is hardly decreased from −30° C. to 85° C. is preferably selected. Such a rubber may be ethylene propylene rubber (EPDM), chloroprene rubber (CR), butyl rubber (IIR), silicone rubber (Si), or thermoplastic elastomer. Also, the elastic support means has the shape having a convex portion. The convex portion is provided on a face opposed to the pressure receiving face and contacted with the cover. Though the pressure sensitive means is contained within the elastic support means, it is preferably disposed on the cover side to improve the detection sensitivity of pressure in the arrow direction. Also, the elastic support means 5104 is fixed on the upper part of the handrail 5102, and covered with a handrail cover 5015. FIG. 42B is a cross-sectional view of FIG. 42A, taken along the line A-A.

A method for fixing the elastic support means 5104 on the upper part of the handrail of veranda may involve fitting it into the upper part of the handrail of veranda, or employing an adhesive tape, or any other methods may be taken as far as the elastic support means can be firmly fixed on the upper part of the handrail of veranda.

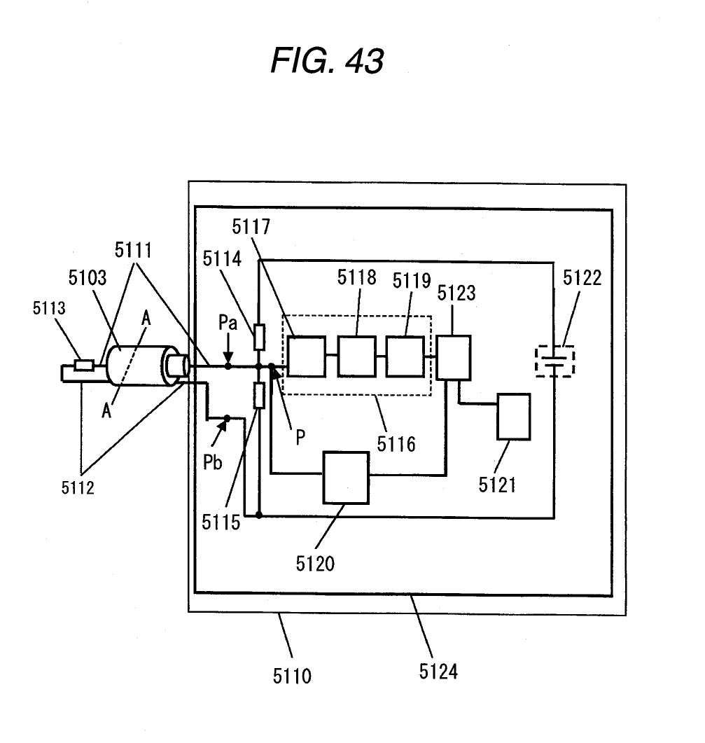

FIG. 43 is an internal block diagram of the pressure sensitive means 5103 and detection means 5110.

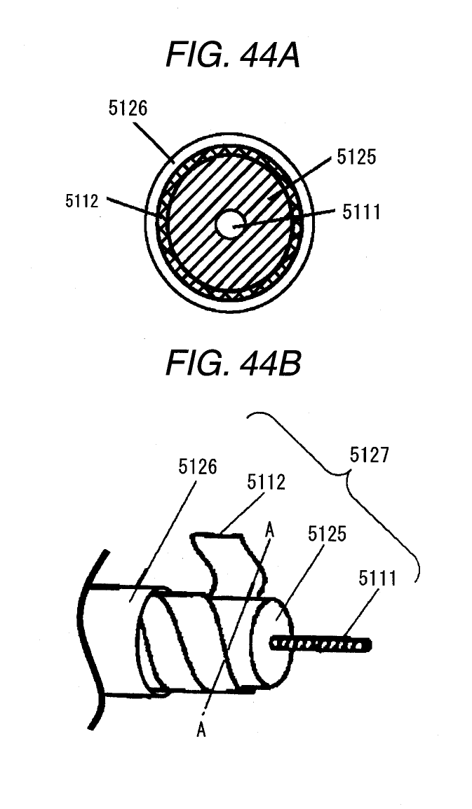

FIG. 44A is a cross-sectional view of FIG. 43, taken along the line A-A. In FIG. 44A, reference numeral 5111 denotes a center electrode, reference numeral 5125 denotes a piezoelectric layer, reference numeral 5112 denotes a ground electrode, and reference numeral 5126 denotes a covering layer. As shown in FIG. 44B, the pressure sensitive means 5103 is composed of the flexible cable-like piezoelectric sensor 5127.

In FIG. 43, reference numeral 5113 denotes a sensor side resistor provided as the resistor for detecting the disconnection between the center electrode 5111 and the ground electrode 5112 at an end part of the piezoelectric sensor. Reference numeral 5114 denotes a circuit side resistor for detecting the disconnection. Reference numeral 5115 denotes a signal deriving resistor for deriving the signal from the piezoelectric sensor 5127. Reference numeral 5116 denotes a detection part. Reference numeral 5117 denotes an amplifier for amplifying the output signal from the piezoelectric sensor 5127. Reference numeral 5118 denotes a filter part for passing only the predetermined frequency component from the amplified output signal. The filtering characteristic of the filter part 5118 is such that the frequency at the time of contact with the person's hand is 10 Hz or less, especially in a range from 3 to 8 Hz, the vibration due to rainfall is 10 Hz or more, and the vibration due to wind is 1 Hz or less. Therefore, the filter part may be a band pass filter for passing the signal components of 3 to 8 Hz, for example, as the filtering characteristic. Reference numeral 5119 denotes a comparator part for comparing the output signal with the preset value to determine the intrusion. The detection part 5116 comprises the amplifier 5117, the filter part 5118 and the comparator part 5119. Reference numeral 5120 denotes an abnormality determination part for determining the disconnection failure from the piezoelectric sensor 5127. Reference numeral 5121 denotes a report part for raising the alarm or turning on the light to threaten the intruder when the intrusion occurs. Reference numeral 5122 denotes a power supply part. Reference numeral 5123 denotes a control part for controlling the report part 5121 to raise the alarm, when the pressure is detected by the piezoelectric sensor 5127, or controlling the report part 5121 to make a report when a disconnection failure is detected by the abnormality determination part 5120. Reference numeral 5124 denotes a shield part. The shield part 5124 shields a part of the detection means 5110 except for the pressure sensitive means 5103.

Though the center electrode 5111 may be a normal metal solid conductor, an electrode in which the metal coil is wound around the insulating polymer fiber is employed here. The insulating polymer fiber and the metal coil are preferably polyester fiber commercially available in the electric heating blankets and copper alloy containing 5 wt % of silver, respectively.

The piezoelectric layer 5125 is typically made of a resin-based piezoelectric polymer such as polyvinylidene fluoride, and the high temperature durability is increased by using a piezoelectric compound in which a powder of piezoelectric ceramics is mixed into polymeric base material such as chlorinated polyethylene.

The ground electrode 5112 is a strip electrode in which a metallic film is bonded on a polymeric layer, and is wound around the piezoelectric layer 5125. And the polymeric layer is made of polyethylene terephthalate (PET). An electrode with an aluminum film bonded on the polymeric layer is preferable as the ground electrode 5112, because it has a high thermal stability at 120° C., and is mass-produced commercially. To shield the piezoelectric sensor 5127 from the electrical noise of external environment, it is preferable that the ground electrode 5112 is wound around the piezoelectric layer 5125 so as to partially overlap.

The covering layer 5126 is made of polymeric material having adequate elasticity such as urethane, polyethylene or vinyl chloride.

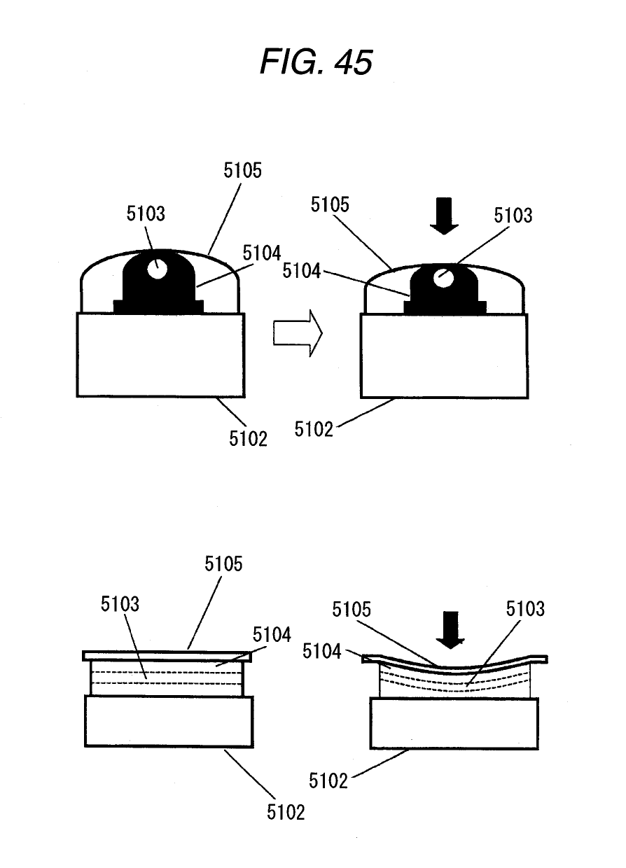

FIG. 45A is a cross-sectional view showing a state where the elastic support means 5104 and the pressure sensitive means 5103 are flexed, and FIG. 45B is a longitudinal cross-sectional view of the handrail.

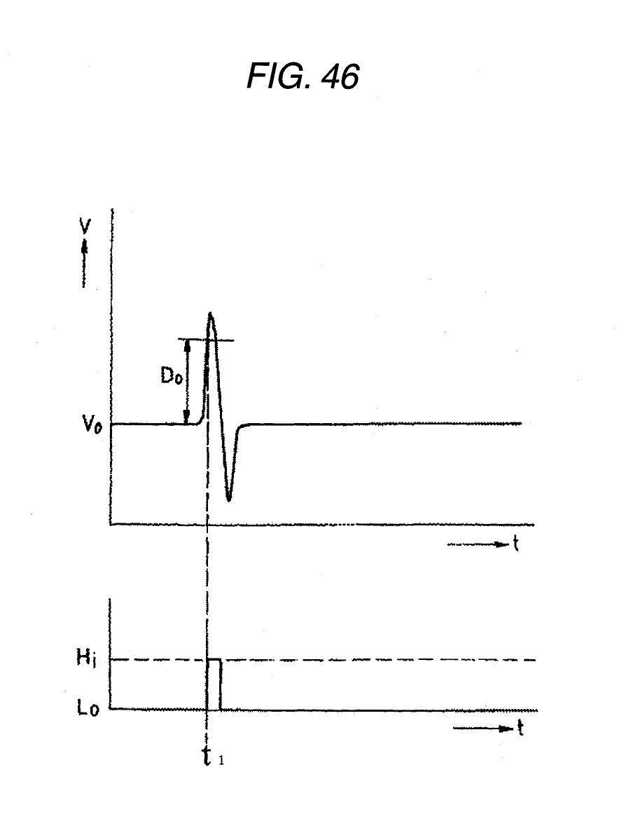

FIG. 46 is a characteristic chart showing an output signal V of the filter part 5118 and an output signal of the comparator part 5119, varying over time, when the intruder intrudes.

The operation and action of the monitoring device with the above constitution will be described below. The elastic support means 5104 where the pressure sensitive means 5103 is built in is fixed on the upper part of the handrail of veranda, and covered with the handrail cover 5105 thereon, as shown in FIG. 42. The detection means 5110 may be fixed at an end portion of the veranda.

First of all, if the intruder tries to get over the veranda (wall-like structure) 5101 by putting the hand or foot on the veranda (wall-like structure) 5101, a pressure is applied in the arrow direction to flex the handrail cover 5105 and then applied to the elastic support means 5104 and the pressure sensitive means 5103 owing to a displacement of the handrail cover, as shown in FIG. 42B. Since the handrail cover 5105 is formed in the hollow shape to make some flexure, and the elastic support means 5104 provided in the hollow part has more flexibility than the pressure sensitive means 5103, the elastic support means 5104 on the pressure receiving face is compressed due to pressure, and the pressure sensitive means 5103 is also easily deformed, as shown in FIG. 45. And a signal according to an acceleration of deformation of the piezoelectric sensor 5127 is outputted from the pressure sensitive means 5103.

The amplifier 5117 amplifies an output signal of the piezoelectric sensor 5127, and the filter part 5118 passes the signal in a specific frequency band and removes the signal in the other frequency band. An output signal V of the filter part 5118 is shown in FIG. 46. When the intruder applies a pressure by hand or foot, a larger signal component than the reference potential V₀ appears in V. The piezoelectric sensor 5127 has a larger amount of deformation. The acceleration that is the second order differential value of the amount of deformation is increased, so that the output signal of the piezoelectric sensor 5127 is also increased. The comparator part 5119 determines that the intruder tries to get over the veranda (wall-like structure) 5101 if the amplitude |V-V₀| of V from V₀ is greater than D₀, and outputs a pulse signal L₀→Hi→L₀ as a determination output at time t1.

If the comparator part 5119 outputs a pulse signal of intrusion determination, an alarm is sounded for a certain time from the report part 5121 to threaten the intruder.

Next, a procedure for disconnection determination in the abnormality determination part 5120 will be described below. In FIG. 43A, it is assumed that the resistance values of the sensor side resistor 5113, the circuit side resistor 5114 and the signal deriving resistor 5115 are R1, R2 and R3, the voltage at point P is Vp and the voltage of the power source part 5122 is Vs. R1, R2 and R3 usually have resistance values of several mega to several tens mega ohms. When the electrode of the piezoelectric sensor 5127 is normal, Vp is equal to a partial voltage of Vs at a ratio of the parallel resistance of R2 and R3 to R1. Herein, since the resistance value of the piezoelectric layer 5125 is usually several hundreds mega ohms or more, it hardly contributes to the parallel resistance value of R2 and R3, and is ignored in calculating the partial voltage value. If the electrode of the piezoelectric sensor 5127 is disconnected, the point Pa or Pb is equivalently opened, so that Vp becomes a partial voltage value of R2 to R3. If the electrode is short-circuited, the points Pa and Pb are equivalently short-circuited, so that Vp is equal to Vs. In this manner, the abnormality determination part 5120 detects a failure such as a disconnection or short-circuit of the electrode for the piezoelectric sensor 5127, based on the value of Vp, whereby the reliability is improved

As described above, in the embodiment 17, since the monitoring device comprising the elastic support means having the pressure sensitive means built in and the detection means for detecting the intruder intruding into the dwelling based on the sensor signal detected by the pressure sensitive means is disposed on the handrail of the veranda, the intruder is detected before enters the room, and threatened by the alarm even if the intruder tries to intrude into the dwelling, whereby there is no damage of breaking the window, and the user has a greater sense of security. Since the intruder is difficult to notice that the monitoring device is installed, the crime prevention effect is enhanced.

Also, since the pressure sensitive means is built in the elastic support means, the installation is easy because the elastic support means and the detection means are simply installed on the upper part of the handrail, and the handrail cover is put thereon. Also, since the monitoring device is covered with the handrail cover, the durability against the natural conditions such as wind and rain or sunshine is improved.

Also, since the elastic support means elastically holds the pressure sensitive means, the pressure sensitive means is more likely to deform due to a pressure when the intruder gets over the veranda (wall-like structure), and can output an output signal according to a deformation rapidly, whereby the detection sensitivity is improved. Also, since the pressure sensitive means has the flexible cable-like piezoelectric sensor, and the piezoelectric sensor outputs a voltage signal according to an acceleration of deformation due to the piezoelectric effect, the intrusion can be detected by rapidly detecting the deformation caused by the pressure when the intruder puts the hand or foot on the veranda (wall-like structure). Further, the piezoelectric sensor is like the flexible cable and can be freely laid along the shape of various verandas (wall-like structures).

### EMBODIMENT 18

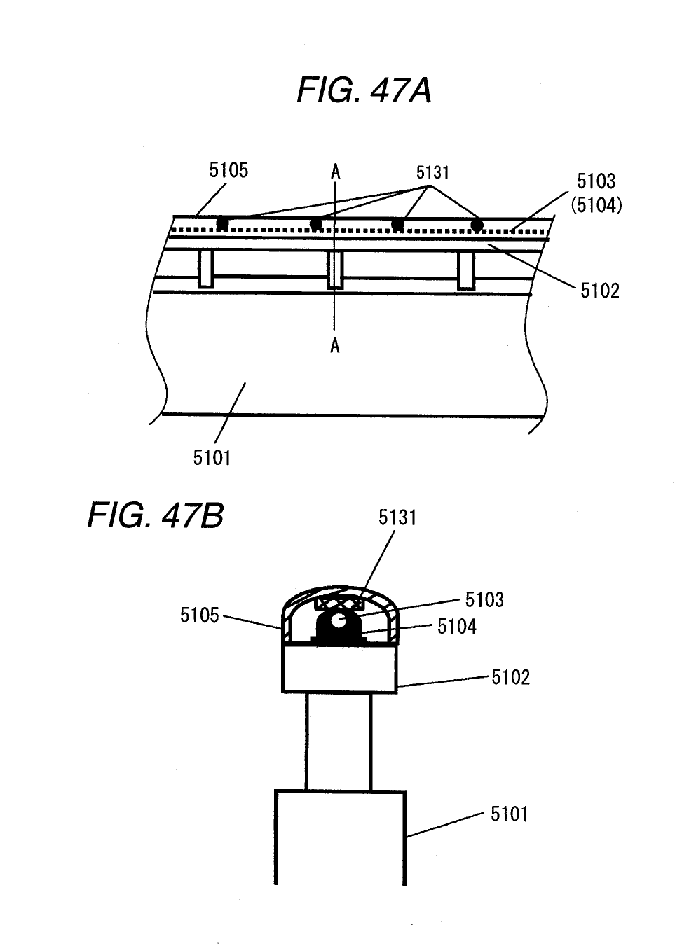

FIG. 47 is a constitutional view of a veranda (wall-like structure) 5101 having installed a monitoring device according to an embodiment 18 of the invention. In FIG. 47A, the pressure sensitive means 5103 is installed on the upper part of the handrail of veranda. And the pressing means 5131 is fixed on the handrail cover 5105. A fixing method may involve fitting the pressing means into the handrail cover, or employing an adhesive tape, or any other methods may be taken as far as the pressing means can be firmly fixed on the handrail cover. FIG. 47B is a cross-sectional view of FIG. 47A, taken along the line A-A. The pressing means and the elastic support means are provided to make a point contact.

With the above constitution, when the intruder intrudes by getting over the handrail 5102, a pressure is applied on the handrail 5102, and then applied on the elastic support means 5104 and the pressure sensitive means 5103 through the handrail cover 5105. At this time, because the pressing means 5131 is disposed, the pressure sensitive means 5103 (elastic support means 5104) is more likely to flex, so that the pressure is more strongly applied on the pressure sensitive means 5103 (elastic support means 5104). The pressing means has a higher hardness than the elastic support means. For example, a steel bar or rubber having higher hardness than the elastic support means may be employed.

Comparing a case where the pressing means and the elastic support means have a small contact point as in the constitution of this embodiment and a case where they have an extensive contact range, in the former case the amount of displacement of the piezoelectric sensor when the pressure is applied is larger and the acceleration is greater, so that the output signal of the piezoelectric sensor is increased. Therefore, when the detection means is employed in this embodiment, the detection sensitivity is improved and the precision of intrusion detection is improved.

As described above, in the embodiment 18, if the pressing means is disposed on the veranda cover, the sensor detection sensitivity due to pressure from the veranda cover is improved. By improving the detection sensitivity mechanically, the signal amplification in the detection means is made at the minimum limit, with less influence of electrical noise, whereby the intrusion can be reliably detected without false detection.

The shape and the mounting spacing of the pressing means are not specifically limited, but may be only required to further improve the sensitivity.

### EMBODIMENT 19

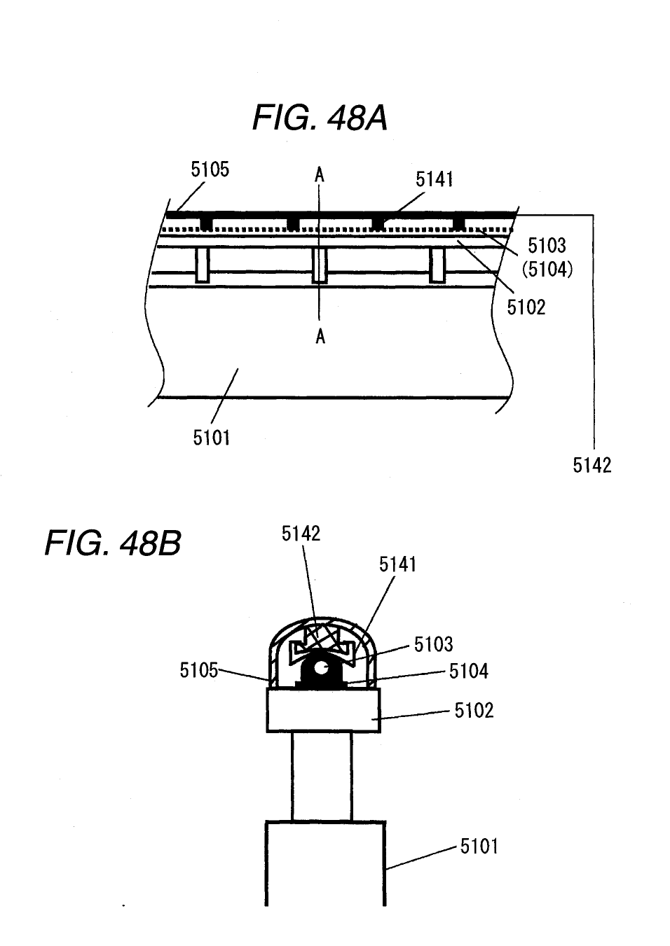

FIG. 48 is a constitutional view of the veranda (wall-like structure) 5101 having installed a monitoring device according to an embodiment 19 of the invention. In FIG. 48A, the pressure sensitive means 5103 is installed on the upper part of the handrail of veranda. And the handrail cover 5105 is provided with pressing member support means 5142 inside the handrail cover 5105, and can be fixed by fitting second pressing means 5141. FIG. 48B is a cross-sectional view of FIG. 48A, taken along the line A-A.

With the above constitution, when the intruder intrudes by getting over the handrail 5102, a pressure is applied on the handrail 5102, and then applied through the handrail cover 5105 on the elastic support means 5104 and the pressure sensitive means 5103. At this time, because the second pressing means 5141 is disposed, the pressure sensitive means 5103 (elastic support means 5104) is more likely to flex, so that the pressure is more strongly applied on the pressure sensitive means 5103 (elastic support means 5104). The second pressing means has a higher hardness than the elastic support means.

As described above, in the embodiment 19, if the second pressing means is disposed on the handrail cover, the sensitivity due to pressure on the handrail cover is improved. By improving the detection sensitivity mechanically, the signal amplification in the detection means is made at the minimum limit, with less influence of electrical noise, whereby the intrusion can be reliably detected without false detection.

Since the pressing member support means is provided inside the handrail cover, and the second pressing means is made slidable, the interval between the second pressing means can be simply changed in installing the handrail cover, whereby the handrail cover can be easily mounted by changing the interval in accordance with the situation on the spot in the work.

Also, the second pressing means of this embodiment has the shape in which the shape of the face opposed to the elastic support means is different from that of the other embodiments, and applies the pressure in the shape of a bowl along the R shape of the elastic supporter. With this constitution, when the elastic supporter is pressed by the pressure from the upper face of the handrail, the elastic supporter is not yielded left or right, but can be pressed directly down. If the shape of the pressing means is inverse to the bowl shape, the elastic support means is yielded left or right, so that the pressure from the upper face of the handrail is not easily passed.

Though in this embodiment the shape of the second pressing means is like the bowl, the shape and the mounting interval of the second pressing means are not specifically limited, but it is only required to further improve the sensitivity.

### EMBODIMENT 20

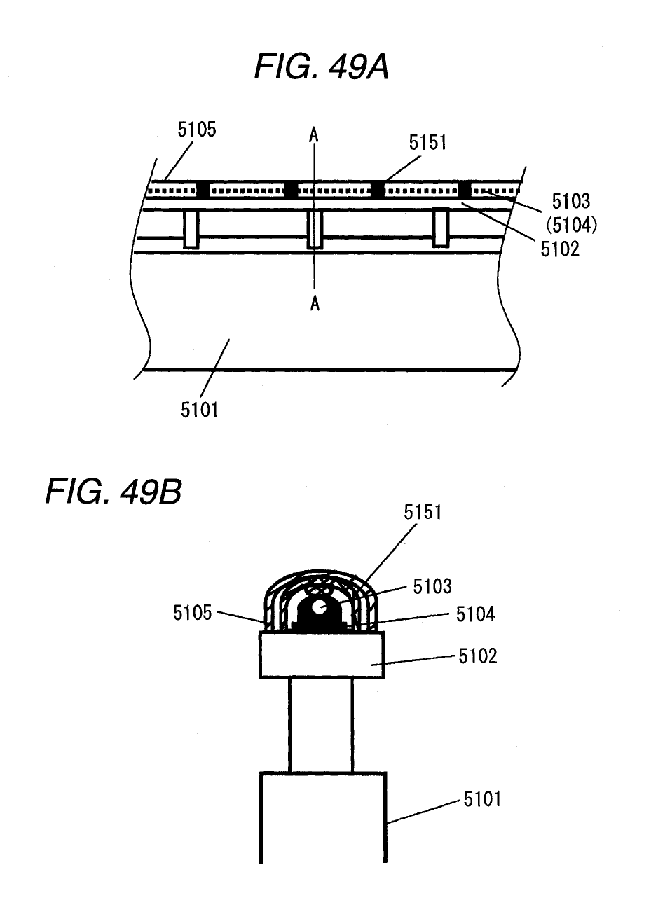

FIG. 49 is a constitutional view of the veranda (wall-like structure) 5101 having installed a monitoring device according to an embodiment 20 of the invention. In FIG. 49A, the pressure sensitive means 5103 is installed on the upper part of the handrail of veranda. And the third pressing means 5151 is mounted on the pressure sensitive means 5103. The third pressing means is provided with a convex portion on the upper part. A method for mounting the third pressing means 5151 may involve employing an adhesive tape, or fitting the third pressing means 5151 into a base material provided on the upper part of the handrail. FIG. 49B is a cross-sectional view of FIG. 49B, taken along the line A-A.

With the above constitution, when the intruder intrudes by getting over the handrail 5102, a pressure is applied on the handrail 5102, and then applied through the handrail cover 5105 on the elastic support means 5104 and the pressure sensitive means 5103. At this time, because the third pressing means 5151 is disposed, the pressure sensitive means 5103 (elastic support means 5104) is more likely to flex, so that the pressure is more strongly applied on the pressure sensitive means 5103 (elastic support means 5104). The third pressing means has a higher hardness than the elastic support means. Also, the third pressing means is provided with pressing means in the central part in the shape along the inner side face of the handrail cover, and easily mounted by fitting it into the upper face of the handrail, whereby it is not required to bond the pressing means onto the upper face of the handrail cover, and the mounting interval of the pressing means can be appropriately decided.

As described above, in the embodiment 20, if the third pressing means is disposed on the veranda cover, the sensitivity due to pressure on the veranda cover is improved. By improving the detection sensitivity mechanically, the signal amplification in the detection means is made at the minimum limit, with less influence of electrical noise, whereby the intrusion can be reliably detected without false detection.

The shape and the mounting interval of the third pressing means are not specifically limited, but it is only required to further improve the sensitivity.

### EMBODIMENT 21

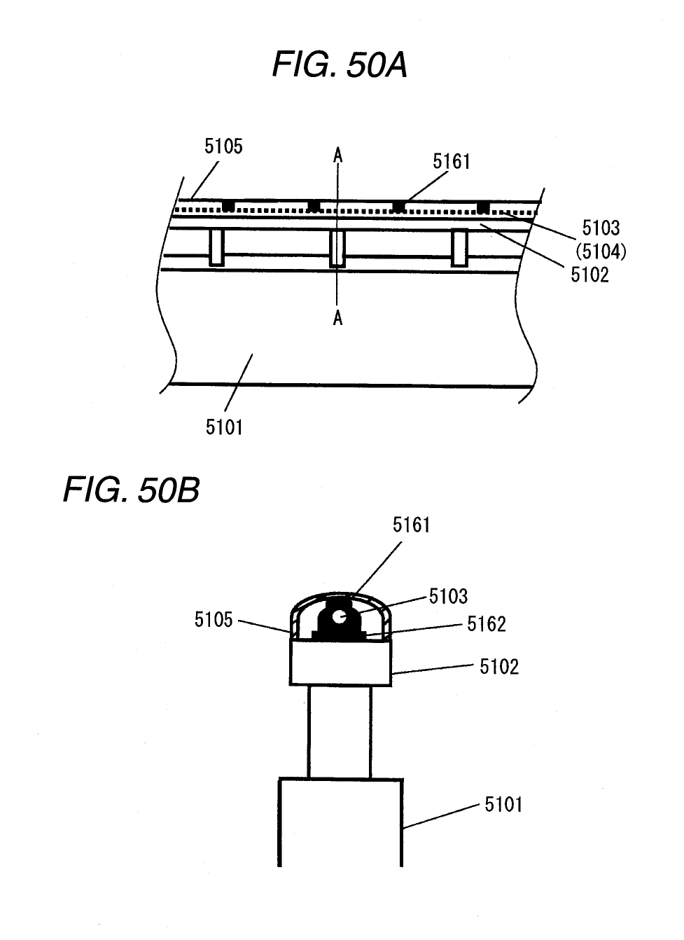

FIG. 50 is a constitutional view of the veranda (wall-like structure) 5101 having installed a monitoring device according to an embodiment 21 of the invention. In FIG. 50A, the pressure sensitive means 5103 is installed on the upper part of the handrail of veranda. And the fourth pressing means are provided at regular intervals on the upper part of the second elastic support means 5162. FIG. 50B is a cross-sectional view of FIG. 50B, taken along the line A-A.

With the above constitution, when the intruder intrudes by getting over the handrail 5102, a pressure is applied on the handrail 5102, and then applied through the handrail cover 5105 on the second elastic support means 5162 and the pressure sensitive means 5103. At this time, because the fourth pressing means 5161 is formed in the second elastic support means, the pressure sensitive means 5103 (second elastic support means 5162) is more likely to flex, so that the pressure is more strongly applied on the pressure sensitive means 5103 (second elastic support means 5162). Though in this embodiment a convex portion of the pressing means is provided on the upper part and outside of the elastic support means, the convex portion may be provided on the side of the pressure sensitive means of the elastic support means.

As described above, in the embodiment 21, if the fourth pressing means is formed in the second elastic support means, the sensitivity due to pressure on the veranda cover is improved. By improving the detection sensitivity mechanically, the signal amplification in the detection means is made at the minimum limit, with less influence of electrical noise, whereby the intrusion can be reliably detected without false detection.

Though in the embodiment 21 the fourth pressing means is formed in the second elastic support means, the fourth pressing means may be retrofitted to the elastic support means.

The shape and the mounting interval of the fourth pressing means are not specifically limited, but only required to further improve the sensitivity.

### EMBODIMENT 22

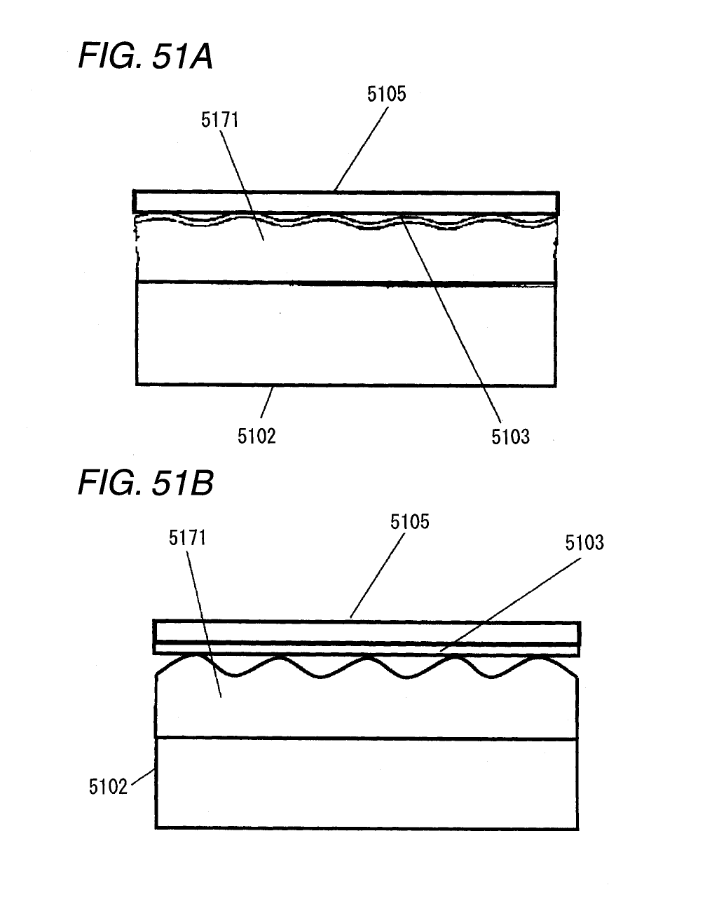

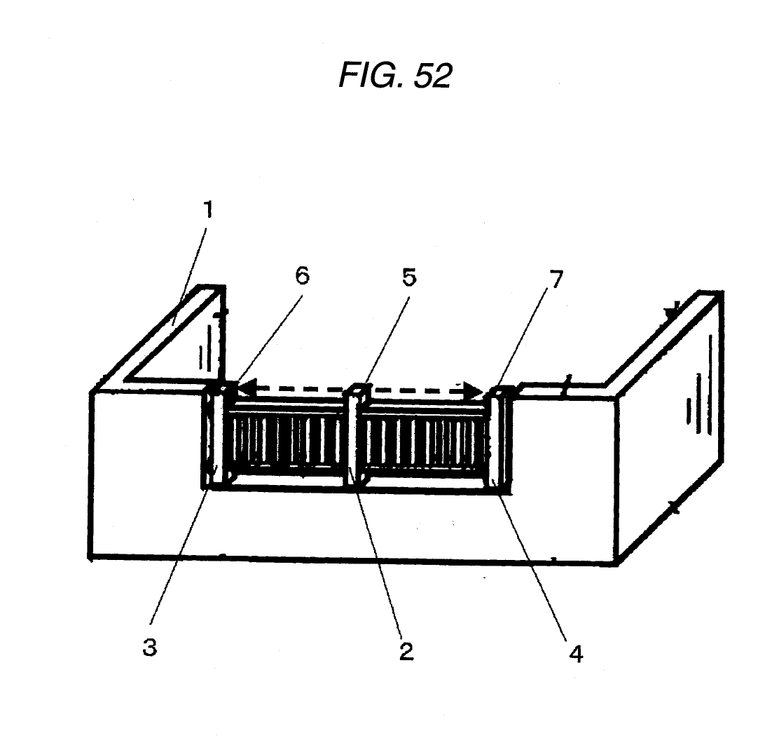

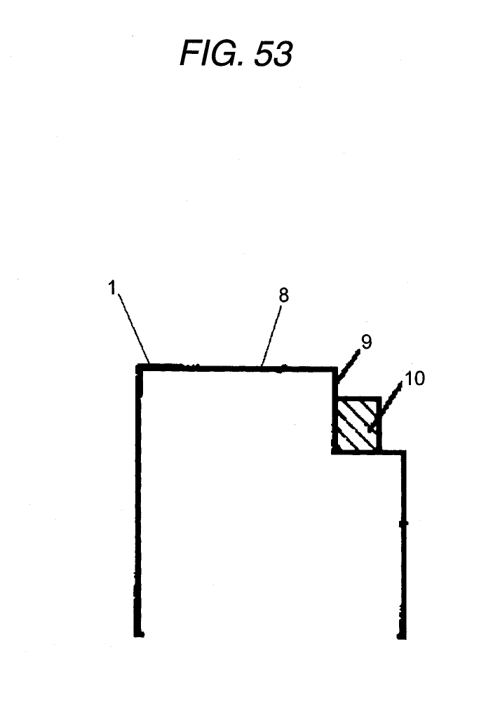

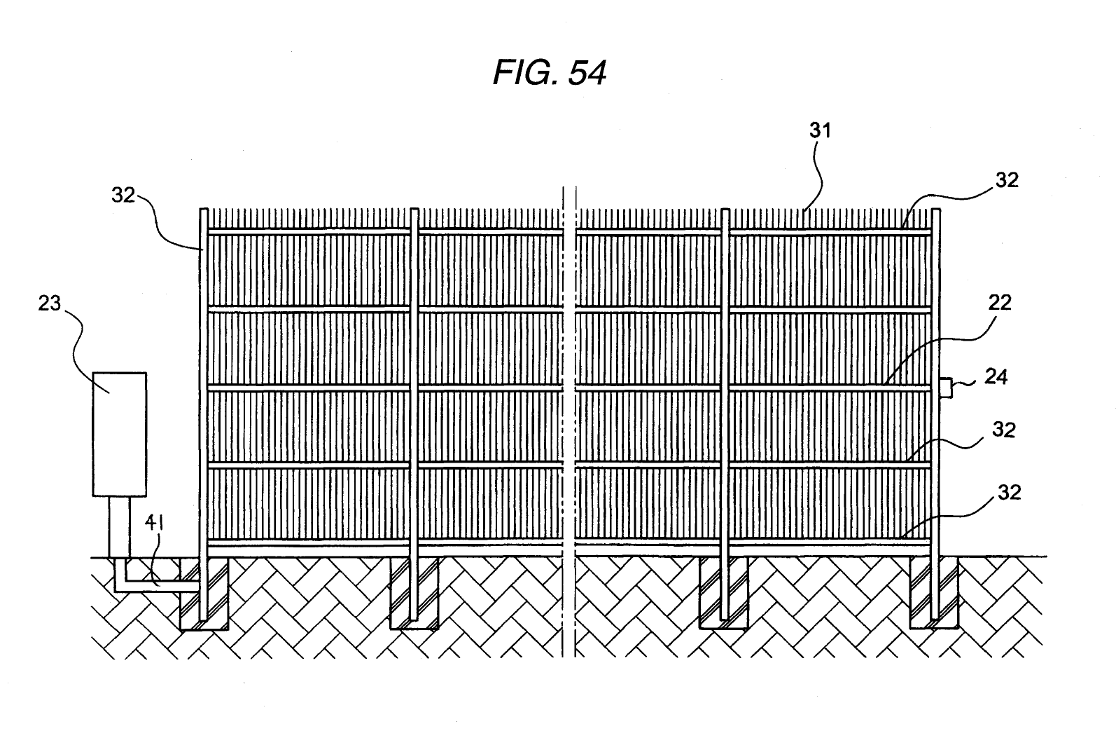

FIG. 51A is a constitutional view of the veranda handrail 5102 having installed a monitoring device according to an embodiment 22 of the invention, in which the pressure sensitive means 5103 is bent and installed along the third elastic support means 5171. In FIG. 51B, the pressure sensitive means 5103 is installed along the handrail cover 5105.

With the above constitution, since the pressure sensitive means 5103 is installed on the upper part and inside of the third elastic support means 5171 by bending the third elastic support means, when the intruder intrudes by getting over the handrail 5102, a pressure is applied on the handrail (cover) so that a bent portion of the pressure sensitive means 5103 contact with the handrail cover is firstly deformed, and more likely to flex, whereby the pressure is more strongly applied to the pressure sensitive means 5103 (third elastic support means 5171). When the pressing means 5103 is disposed along the handrail, the same effect is also obtained.

As described above, in the embodiment 22, since the third elastic support means or the pressure sensitive means is bent and installed, it is not necessary to install the pressing means separately, whereby the installation is facilitated. Further, the sensitivity due to pressure on the veranda cover is improved. By improving the detection sensitivity mechanically, the signal amplification by the amplifier of the detection means is made at the minimum limit, with less influence of electrical noise, whereby the intrusion can be reliably detected without false detection.

The monitoring device of the invention is not limited to the above embodiment, but various changes may be of course made without departing from the spirit or scope of the invention.

While in the embodiment the non-linear flexure part is provided inside the support means, the non-linear flexure part may be not provided inside the support means but may be provided as a separate member from the support means, for example, adjacent to the support means or pressure sensitive means, whereby the same effect is achieved.

Also, while in the above embodiment the pressure applying portion, or the pressing member, is contact with the support means to convey a displacement via the support means to the pressure sensitive means, the invention is not limited thereto, but the pressure sensitive means may be directly contact with the pressure applying portion. That is, the pressure sensitive means is not held within the support means, but the pressure sensitive means may be laid on the upper part of the support means, and the pressure applying portion may contact the upper part of the pressure sensitive means.

Though the present invention has been described above in detail in connection with the specific embodiments, it will be apparent to a person skilled in the art that various changes or modifications may be made without departing from the spirit or scope of the invention.

This application is based on Japanese Patent Application No. 2004-227920 filed on Aug. 4, 2004, Japanese Patent Application No. 2005-005911 filed on Jan. 13, 2005, Japanese Patent Application No. 2005-007375 filed on Jan. 14, 2005, Japanese Patent Application No. 2005-008780 filed on Jan. 17, 2005, Japanese Patent Application No. 2005-163929 filed on Jun. 3, 2005, Japanese Patent Application No. 2005-163930 filed on Jun. 3, 2005, Japanese Patent Application No. 2005-163931 filed on Jun. 3, 2005, and Japanese Patent Application No. 2005-163932 filed on Jun. 3, 2005, the contents of which have been incorporated herein by reference.

### INDUSTRIAL APPLICABILITY

As described above, the intrusion detection device according to the present invention has a high detection precision without false detection by the animal intercepting the infrared beam as conventionally occurs, is better in the work owing to the use of the flexible piezoelectric sensor, has a broad application range owing to the excellent weather resistance, can be installed on the wall-like structure of various shapes laid in the outdoor site such as domicile, factory, railroad or airport, and may be disposed in the drawing of the desk or the back side of the door knob that is a relatively small component indoors, for example, to be applied as a security system for raising the alarm to notify the illegal use or threaten the intruder in attempting to open the drawing or door illegally. Also, the intrusion detection device can be firmly fixed by treating various shapes because the reactive portion and the stroke for reaction can be secured sufficiently.

Also, the intrusion detection device according to the invention can detect the intrusion by detecting the pressure when the intruder puts the hand on the upper part of the wall-like structure to get over the wall-like structure without unnecessary pressure applied upon the motion of the animal or hanging the bedding, whereby there is no false detection as conventionally occurs, the intrusion can be reliably detected, and can be installed on the fence laid in the site such as domicile, factory, railroad or airport, and may be disposed in the drawing of the desk or the back side of the door knob, for example, to be applied as a security system for raising the alarm to notify the illegal use or threaten the intruder in attempting to open the drawing or door illegally.

Also, the intrusion detection device according to the invention comprises the detection means for detecting the intruder based on an output signal of the pressure sensitive means, the pressure sensitive means elastically supported being provided inside the top beam provided on the wall-like structure, has a great-looking layout, and can detect the weight of the person who is the intruder on the upper part of the wall-like structure, whereby it can be applied to a downfall prevention device for making the notification or downfall prevention operation upon detecting the weight of the person by providing a downfall prevention stockade on the wall or fence in the high place such as a balcony or roof stockade of the mansion.

Also, the intrusion detection device according to the invention has a high detection precision without false detection by the animal intercepting the infrared beam as conventionally occurs, is excellent in the work owing to the use of the flexible piezoelectric sensor, has a broad application range owing to the excellent weather resistance, can be installed on the fence of various shapes laid in the outdoor site such as domicile, factory, railway or airport, and may be disposed in the drawing of the desk or the back side of the door knob that is a relatively small component indoors, for example, to be applied as a security system for raising the alarm to notify the illegal use or threaten the intruder in attempting to open the drawing or door illegally.

Also, the monitoring device according to the invention with the intrusion detecting terminal unit disposed on the handrail of veranda or the fence can detect the intruder who intrudes into the dwelling by getting over the handrail of veranda or the fence, and does not need to install the equipment such as a control unit outside to raise the alarm to the intruder or notify the indoor warning terminal, external telephone, security company or the police by sending the detection information to the central processing unit. Since it is not required to install the equipment such as the control device outside though it is installed conventionally, the sensor can be mounted at various places for the security purposes. For example, the sensor is built in the roof of the shed which the intruder is prone to use as foothold, and can be applied as a security system for detecting the intruder who intrudes on the second floor of the house with the roof of the shed as foothold.

Also, the monitoring device according to the invention, which is disposed on the handrail of veranda, can detect the intruder who intrudes into the dwelling by getting over the handrail of veranda, and raise the alarm to the intruder, in which the sensor can be mounted at various places for the security purposes. For example, the sensor is built in the roof of the shed which the intruder is prone to use as foothold, and can be applied as a security system for detecting the intruder who intrudes on the second floor of the house with the roof of the shed as foothold.

While in the above embodiments, the mount part is mounted in the form of covering the upper face and side face of the wall-like structure or handrail, the invention is not limited thereto, but the mount part may be mounted on the upper face of the wall-like structure or handrail. That is, the width of the mount part may be smaller than the width of the wall-like structure or handrail.

1: An intrusion detection device comprising:
pressure sensitive means having a flexible cable-like piezoelectric sensor;
a packet for storing said pressure sensitive means; and
detection means for detecting that said pressure sensitive means functions based on an output signal of said pressure sensitive means,
wherein said packet is mounted on a wall-like structure to deform said pressure sensitive means due to a shape change caused by a pressure.

2: An intrusion detection device as claimed in claim 1,
wherein said packet has a mount part mounted on a wall-like structure, and a movable part for deforming said pressure sensitive means due to a shape change caused by a pressure.

3: An intrusion detection device as claimed in claim 1,
wherein said packet has a movable structure mounted on a wall-like structure and slidable on a face of said wall-like structure.

4: An intrusion detection device as claimed in claim 2,
wherein said movable part is slidable on a face of said mount part.

5: The intrusion detection device according to claim 1, wherein said packet has fixing means for fixing on the wall-like structure, in which said fixing means is fitted with the face of said wall-like structure.

6: The intrusion detection device according to claim 2, wherein the movable part of said packet is movably fitted with the mount part.

7: The intrusion detection device according to claim 1, wherein said packet has fixing means for fixing on the wall-like structure, in which said fixing means fastens said packet.

8: The intrusion detection device according to claim 2, wherein the movable part of said packet is bonded with the wall-like structure.

9: The intrusion detection device according to claim 2, wherein the mount part of said packet has fixing means for fixing on the wall-like structure, in which said fixing means has a screwing structure.

10: The intrusion detection device according to claim 1, wherein said packet is bent inwards on an end face.

11: The intrusion detection device according to claim 1, wherein said packet comprises support means for elastically supporting the pressure sensitive means inside the packet.

12: The intrusion detection device according to claim 1, further comprising a non-linear flexure part inside the packet, in which said non-linear flexure part has a material or structure more deformable than said support means.

13: The intrusion detection device according to claim 1, comprising a pressing portion at a position where a force is applied to the pressure sensitive means.

14: The intrusion detection device according to claim 13, wherein said pressing portion uses a material less deformable than said support means.

15: The intrusion detection device according to claim 13, wherein said pressing portions are provided at any intervals.

16: The intrusion detection device according to claim 13, wherein said pressing portion is contact with said support means or pressure sensitive means via an R plane or at an acute angle or obtuse angle.

17: The intrusion detection device according to claim 1, further comprising threatening means for raising an alarm based on an output signal of detection means.

18: The intrusion detection device according to claim 1, further comprising communication means capable of communicating an output signal of the detection means to an external apparatus.

19: The intrusion detection device according to claim 1, wherein said packet has a variable shape.

20: The intrusion detection device according to claim 19, wherein said packet has an expansion part and can vary the shape.

21: The intrusion detection device according to claim 20, wherein said expansion part has a bellows part.

22: The intrusion detection device according to claim 1, further comprising detection level adjustment means for adjusting a detection level at which the pressure sensitive means functions.
